(19) United States
(12) Patent Application Publication
(10) Pub. No.: US 2011/0276493 A1
(43) Pub. Date: Nov. 10, 2011

(54) METHODS AND APPARATUS FOR A FINANCIAL DOCUMENT CLEARINGHOUSE AND SECURE DELIVERY NETWORK

(75) Inventors: Donald H. GRAHAM, III, Los Angeles, CA (US); Abby HEDENGRAN, Pahrump, NV (US); Hatem K. EL-SEBAALY, Lake Forest, CA (US); Ron E. EDISON, Tujunga, CA (US); David J. DIAZ, Valley Village, CA (US); Matthew L. WRIGHT, Woodland Hills, CA (US)

(73) Assignee: TOBSC INC., Pahrump, NV (US)

(21) Appl. No.: 13/096,858

(22) Filed: Apr. 28, 2011

Related U.S. Application Data
(60) Provisional application No. 61/330,226, filed on Apr. 30, 2010.
(60) Provisional application No. 61/367,574, filed on Jul. 26, 2010.
(60) Provisional application No. 61/367,576, filed on Jul. 26, 2010.
(60) Provisional application No. 61/416,629, filed on Nov. 23, 2010.

(51) Int. Cl. G06F 21/00; G06Q 20/00

(52) U.S. Cl. 705/53

(57) ABSTRACT

An electronic clearinghouse system (ECS) for securely delivering, retrieving, authenticating, storing, generating and distributing messages, such as financial documents and/or records are described. For message providers, the ECS can provide a secure and trusted venue for delivering messages, such as messages including financial data to their clients that reduces their delivery costs. For users of the ECS, the ECS can provide a central location where each user can receive and consolidate their messages, such as financial documents and associated financial data from a number of different financial data providers. To facilitate these functions, the ECS can include an automated system for recording delivery status as well as evidence of delivery of messages, including whether a message has been viewed by a particular user. Further, the ECS can include components for scheduling events, such as monetary transfers and bill payments, and providing reminders for such events. Also, the ECS can provide utilities that allow a user to package and securely deliver messages to other users.

### CROSS REFERENCE TO RELATED APPLICATIONS

This application claims priority under 35 U.S.C. §119(e) from co-pending U.S. Provisional Patent Application No. 61/330,226, filed Apr. 30, 2010, titled “CLEARINGHOUSE SERVER FOR FINANCIAL DATA DELIVERY AND FINANCIAL SERVICES,” and claims priority under 35 U.S.C. §119(e) from co-pending U.S. Provisional Patent Application No. 61/367,574, filed Jul. 26, 2010, titled “METHODS AND SYSTEMS FOR A CLEARINGHOUSE SERVER FOR DELIVERY OF SENSITIVE DATA,” and claims priority under 35 U.S.C. §119(e) from co-pending U.S. Provisional Patent Application 61/367,576, filed Jul. 26, 2010, titled “METHODS AND APPARATUS FOR A FINANCIAL DOCUMENT CLEARINGHOUSE SYSTEM,” and claims priority under 35 U.S.C. §119(e) from co-pending U.S. Provisional Patent Application No. 61/416,629, filed Nov. 23, 201, “METHODS AND APPARATUS FOR SECURE DATA DELIVERY AND USER SCORING IN A FINANCIAL DOCUMENT CLEARINGHOUSE,” each of which is incorporated by reference and for all purposes.

### BACKGROUND

1. Field of the Invention

The present invention generally relates to the field of personal information management. More specifically, the present invention relates to a system and method for electronic retrieval, delivery, consolidation and management of data, such as an individual's financial information.

2. Description of the Related Art

In the interactions between businesses, such as banks, lenders, credit card companies, cell phone companies, utilities, mortgage companies, finance companies, financial institutions, retail companies and their customers or in the interactions between a government and its citizens, financial data is generated. The relationships between a business and its customers can be of a temporary or a more permanent nature. Thus, the financial data can be generated on a one-time or ongoing basis. As an example, a temporary relationship might result from a single purchase of a product or a service from a retail company. A more permanent relationship might result when a service provider, such as a bank or a utility, provides services to customers on an ongoing basis and regularly communicates with its customers.

The vast majority of consumers deal with entities, such as banks, telephone companies, credit card companies or utilities, from which they receive financial data on at least a monthly basis. Typically, the financial data is generated as a paper document that is mailed, via a postal service, to the customer. Depending on the entity, the paper document can be used for various purposes, such as to request a payment, to present an account summary and/or to provide a receipt for one or more transactions. It costs roughly $0.75 or more to print and mail a typical paper statement in the U.S., and hundreds of millions of financial documents are mailed each month in the U.S. alone. Thus, an enormous amount of money is spent by these entities on delivering paper documents.

To save the enormous aggregate cost of mailing, many businesses attempt to get customers to come to their websites to retrieve financial documents and/or records, which is generally called “going paperless.” To encourage their customers to do so, businesses often offer them incentives, such as cash or financial credit, the satisfaction of “going green” or extended online storage of financial documents and/or records. However, for most businesses, the percentage of customers that has “gone paperless” is still relatively low.

There are a number of reasons paperless delivery has not gained a broader acceptance. One reason is that certain customers, such as older customers or less tech savvy customers, find the “electronic” process too different, intimidating or technically challenging. Another reason is that certain customers do not trust the reliability or the security of electronic delivery of financial information. Yet another reason is that certain customers are not convinced that after they receive their financial data in an electronic format they will be able to organize, save and respond to it as needed in a manner that is comfortable for them. For instance, a customer knows and is comfortable with the fact that he or she can place a paper bill in a visible location to provide a tangible reminder to pay the bill and that, after paying the bill, can place the paper bill in a location, such as a file folder in a filing cabinet, for safe storage and possible later retrieval. In comparison, the customer might not be comfortable with an electronic equivalent to these processes, e.g., how he or she will be reminded of the bill payment and how the information can be safely and securely stored and found easily if needed later.

More generally, more and more of an individual's personal information is becoming available in an on-line environment and attempts at implementing paperless delivery are merely one aspect of this trend. While searching for data, exchanging emails, purchasing a gift, making new friends or going paperless, an individual's personal information is being collected. The personal information collected on-line is a commodity that is being sold for great profit by many different companies. Unfortunately, today's online environment is a lot like the “Wild West”—there is little regulation, lots of space and growth, and some amount of lawlessness in regards to the collection and dissemination of personal information.

Online people desire to protect their valuables—but today's valuables are often intangible. Information such as identity, reputation, credit score, bank balance, personal relationships, correspondence, history, behavior, personal habits and preferences are examples of intangible assets that are valuable. These valuables need protection. In the “Wild West,” people wished to protect tangible assets. To meet this need, companies like Wells Fargo and American Express created a secure way to transfer valuables—people, money, purchases, and the like—using protected horse carriage routes. And similarly, banks were formed with vaults and trusted employees who would abide by agreed-upon rules and thereby protect valuables that individuals and businesses couldn't protect on their own. However, on-line, there are not any comprehensive and integrated solutions that allow businesses and individuals to protect their intangible assets in the manner that tangible assets are currently protected. This deficiency prevents initiatives involving moving more personal information on-line, such as going paperless with financial data, from reaching their full potential.

In view of the above, there is a desire for systems and methods that allow individuals and businesses to secure, protect and control the dissemination of their valuable information in a comprehensive and integrated manner. Systems and methods that address these needs are described as follows.

### SUMMARY

Apparatus and method described herein can involve the use of an Electronic Clearinghouse System (ECS). The ECS can be instantiated as one or more servers that communicate with remote devices via a network. The ECS can be configured to provide secure data storage and secure data transfer using encryption methods that are mostly invisible to users of the ECS. In particular, a user of the ECS can be provided with an electronic vault for storing their data in an encrypted format and an account for accessing the encrypted vault.

The ECS can be configured to provide data retrieval services for its users. For instance, a user of the ECS can have relationships with a number of businesses, including an employer of the user, that maintain accounts for the user separate from their account with the ECS. For instance, a bank, a cell phone service provider, a credit card company, a loan company and a power company are few examples of businesses that can maintain accounts for the user. When authorized by the user, the ECS can be configured to automatically retrieve account data, such as account statements or payroll data, from businesses specified by the user. The retrieval process performed by the ECS can involve communicating via a network with a remote device associated with the businesses, receiving the account data and storing it to the user's electronic vault.

In general, a user of the ECS can have relationships with various entities that wish to send messages to the user. Again when authorized by the user, the ECS can be configured to automatically retrieve a message from one of these message providers and store the retrieved message into the user's electronic vault. The messages can include any type of information that can be formatted electronically. The type and format of the information in a message can vary from message to message. For instance, the messages can include textual data, image data, video data, audio data and combinations thereof. In one embodiment, the messages can include electronically formatted documents, such as but not limited account statements, privacy notices, benefit notices, pay stubs and health care records.

The ECS can maintain accounts and associated electronic vaults for a number of users. These users may wish to share data among one another that is stored in their respective vaults. The ECS can be configured to allow secure data sharing among users of the ECS. The data sharing can involve moving data from one user's vault to another user's vault. The moving of the data can involve decrypting and encrypting data using encryption and decryption keys that can vary from vault to vault. In some instances, the data sharing can involve communications between the ECS and a number of remote devices.

With respect to the following paragraphs a number of methods in an ECS are described. These methods can be instantiated in computational devices associated with the ECS. In addition, all or a portion of the methods can be instantiated in user computing devices. In particular, methods are described involving 1) the creation of electronic vaults for securely storing an ECS user's data and sharing the data with other ECS users and entities outside of the ECS, 2) aggregating data, such as account data generated for the user by a number of entities outside of the entity, 3) generating metrics and scores associated with operational events at the ECS, such as a score that represents the likely-hood of an ECS user to possess the identity they are presenting at the ECS, 4) the capability to associate files with one another, store the files in a hierarchical file system and display the relationship between files, 5) the capability to upload data and associate it with data retrieved by the ECS, 6) the aggregation of an ECS user's data and storage in an encrypted form to the user's vaults and 7) the capability of the ECS to deliver information from entities outside of the ECS to their customers with accounts at the ECS.

### Vault Creation

One method in an ECS involving data sharing can be generally characterized as comprising: 1) establishing a first account for a first user including a first electronic vault, 2) establishing a second account for a second user including a second electronic vault; 3) receiving a request from a first remote device associated with the first user to share with the second user, first data placed in the first electronic vault (The first data can be encrypted with an encrypted key that is designated for use with the first electronic vault); 4) decrypting the first data using a first key; 5) encrypting the first data using an encryption key associated with the second vault; 6) storing the first data encrypted with the encryption key to the second vault; and sending a notification message to a second remote device associated with the second user indicating new data has been placed in the second vault.

In a particular embodiment, a user can specify certain devices that they wish to use to communicate with the ECS. Information regarding a specified device can be stored with other information associated with a user's account at the ECS. Toward this end, the method can further comprise storing identification information associated with the first remote device to the first account and identification information associated with the second remote device to the second account.

In various embodiments, a public-private encryption key scheme can be utilized. A public-private encryption key scheme is an example of asymmetric encryption where a first key, which can be made public, is used to encrypt data and a second key, which can be kept private is used to decrypt data encrypted with the first key. A relationship between the public key and the private key is used that makes it difficult to determine what the private key is needed to decrypt a document if one only knows the value of the public key. Public-private key pairs can be utilized in a data sharing schema. For instance, the method can further comprise, 1) prior to receiving the request to share the first data, storing a public key of a public-private key pair associated with the second electronic vault to a public key database maintained at the ECS where the public key can be used as the encryption key for the second electronic vault: 2) after receiving the request to share the first data, retrieving the public key associated with the second electronic vault in the public key database; and 3) using the retrieved public key as the encryption key to encrypt the first data. In one embodiment, the ECS can receive the public key from the second remote device associated with the second user. Further, the ECS can be configured to send a copy of the first data encrypted with the public key to the second remote device. In addition, the ECS can be configured to receive a new public key associated with the second vault and to replace the public key associated with the second vault maintained in the public key database at the ECS with the new public key. The new public key might be utilized the next time the ECS places encrypted data into the second vault.

In other embodiments, the ECS can make a public key of a public-private key pair available to other devices. The other devices can encrypt data with the ECS public key which can be decrypted at the ECS using a related private key. Thus, the method can further comprise 1) receiving the first data from the first remote device wherein the first data is encrypted using a public key owned by the ECS; and 2) decrypting the first data using a private key associated with the public key owned by the ECS. In some instances, the ECS can be configured to generate public-private key pairs on a transaction by transaction basis, such as by generating a new public-private key pair each time data is transferred from a remote device to the ECS. Therefore, the public key owned by the ECS and the associated private key can be generated by the ECS after receiving the request from the first remote device to share the first data.

In some instances, the ECS may not possess a key necessary to decrypt data stored in a particular vault. To decrypt data in the particular vault, it may be necessary to receive the key from a remote device that possesses the key. Therefore, the method can further comprise receiving from the first remote device the first key used to decrypt the first data. To receive the needed key, the ECS may have to determine which remote device possesses a needed decryption key for data in a particular vault and then send a message to the remote device requesting the key for the identified encrypted data.

In other embodiments, the ECS a number of electronic vaults can be associated with a user account. The ECS can be configured to maintain a key management database that maps encryption/decryption keys to each of the files stored in various electronic vaults. The encryption/decryption keys can be generated locally (at the ECS) or remotely (on a remote device). Thus, method can further comprise 1) establishing a plurality of electronic vaults for the first account; 2) receiving from the first remote device a separate encryption key for each of the plurality of electronic vaults; and storing the separate encryption keys to a key management database maintained at the ECS.

In yet other embodiments, a user's vaults at the ECS can be maintained at the ECS and on a remote device. Thus, the ECS and the remote device can execute software that allows the vaults maintained at the ECS and the remote device to be synced with one another. As part of the syncing process, the method can further comprise 1) receiving information from the first remote device indicating contents of an electronic vault maintained on the first remote device; 2) comparing contents of the first electronic vault to the contents of the electronic vault on the first remote device; and 3) determining a) data to send from the first electronic vault at the ECS to the electronic vault on the first remote device or b) data to receive from the electronic vault on the first remote device in the first electronic vault to sync the first electronic vault and the electronic vault on the first remote device.

As described above, the ECS can be configured to maintain multiple vaults for a user. In one embodiment, a new vault can be created in response to a request by the user. Thus, the method can further comprise 1) receiving from the first remote device a request to create a new vault; 2) creating the new vault; and 3) storing information regarding the new vault as account information associated with the first account. In a particular embodiment, a new vault can be created that allows two or more ECS users to share data. Therefore, the method can further comprise i) creating a shared vault with a unique identifier; ii) providing the unique identifier to the first remote device; iii) receiving a request to subscribe to the shared vault including the unique identifier from the second user via the second remote device; and iv) notifying the second user when contents are newly added to the shared vault. In general, the ECS can be configured to allow multiple users to access the shared vault. Thus, the method can further comprise a) receiving a request to subscribe to the shared vault including the unique identifier from a plurality of users with accounts maintained at the ECS and b) notifying each of the plurality of users when contents are newly added to the shared vault.

As described above, the ECS can be configured to retrieve messages from various entities that have a relationship with the user and that wish to send messages to a user with an account at the ECS. A procedure can be provided that allows the user to specify entities from which the ECS can retrieve message for the user. Thus, the method can further comprise 1) registering a first plurality of message providers specified by the first user with the first user account wherein the registering includes receiving access information that allows the ECS to retrieve data for the first user via an outside interface supported by each of the first plurality of message providers; and 2) registering a second plurality of message providers specified by the second user with the second user account wherein the registering includes receiving access information that allows the ECS to retrieve data for the second user via an outside interface supported by each of the second plurality of message providers. After registration, the method can further comprise a) retrieving a first message from a first message provider associated with the first plurality of message providers and storing the first message to the first electronic vault; and b) retrieving a second message from a second message provider associated with the second plurality of message providers and storing the second message to the second electronic vault.

A number of files can be stored in each electronic vault at the ECS. The ECS can maintain a vault key management database that is used to keep track of the decryption key or decryption keys needed to decrypt each of the files (In one embodiment, a file can be encrypted and decrypted using multiple encryption keys.) Thus, the method can further comprise for the for the first user and the second user, maintaining an ECS vault key management database wherein the ECS vault key management database includes decryption keys used to decrypt files stored in the first electronic vault and the second electronic vault. In one embodiment, a single decryption key can be used to decrypt all of the files stored in a particular vault. For instance, the first electronic vault can store a number of different files and a single decryption key stored in the ECS vault key management database can be used to decrypt the different files. In other embodiments, multiple encryption keys can be used to decrypt the files in a particular electronic vault. For instance, the first electronic vault can store a number of different files where two or more decryption keys stored in the ECS vault key management database are used to decrypt the different files.

As described above, a user's vaults at the ECS can be maintained at the ECS and on one or more remote devices. If desired by the user, the ECS can be configured to decrypt the files in the user's vault at the ECS. As an example, the ECS vault key management database can include decryption keys used to decrypt files in an electronic vault maintained on the first remote device controlled by the first user. To enable the ability of the ECS to decrypt files stored in the user's vaults at the ECS, a syncing process can be carried out that involves the exchange of decryption keys between the ECS and a remote device. As an example, the method can further comprise: 1) receiving information from the first remote device indicating contents of a vault key management database maintained on the first remote device wherein the vault key management database includes keys required to decrypt files stored in the electronic vault on the first remote device; 2) comparing contents of the ECS vault key management database to the vault key management database on the first remote device; and 3) determining a) data to send from the ECS to the first remote device or b) data to receive from the first remote device at the ECS to sync a portion of the ECS vault key management with the vault key management database maintained on the first remote device.

Data sharing can involve moving a file from a first remote device to a second remote device via the ECS. The first remote device and the second remote device can be controlled by a first user and a second user of the ECS, respectively. To enable this transaction, the ECS can be configured to broker the communication in different ways. As an example, a method in an electronic clearinghouse system (ECS) can comprise: 1) establishing a first account for a first user including a first electronic vault; 2) establishing a second account for a second including a second electronic vault; 3) receiving a request from a first remote device associated with the first user to share with the second user first data placed in the first electronic vault; 4) determining an encryption key associated with the second electronic vault; 5) sending the encryption key to the first remote device; 6) receiving the first data encrypted with the encryption key from the first remote device; 7) storing the first data encrypted with the encryption key to the second electronic vault; and 8) sending the notification message to a second remote device indicating new data has been placed in the second electronic vault.

In the method above, the first data placed in the second vault is encrypted. A selection of the encryption key to use to encrypt the first data prior to its placement in the second vault can involve a communication between the ECS and the second remote device. Via the communication, the second remote device can specify an encryption key to utilize. Therefore, in a particular embodiment, the determining the encryption key associated with the second electronic vault can include: 1) sending a request to the second remote device for the encryption key associated with the second vault and 2) receiving the encryption key associated with the second vault from the second remote device. The encryption key provided by a remote device, such as the second remote device, can be one of a symmetric encryption key or a public key from a public-private asymmetric encryption key pair. After the ECS receives an encryption key from a remote device, such as the second remote device, the ECS can be configured to store the encryption key associated with the second vault to a key management database maintained at the ECS. The stored encryption key might be used later by the ECS to place additional files in the second vault.

As noted in the preceding paragraph, it may possible that a needed encryption key to use for encrypting a file prior to its storage in a vault is stored in the key management database at the ECS. Thus, in one instance, the method can further comprise prior to sending the request to the second remote device, searching a key management database, maintained at the ECS, for the encryption key associated with the second vault and only sending the request to the second remote device when the encryption key for the second vault is not found in the key management database. The encryption key associated with the second vault can be one of a symmetric encryption key or a public key from a public-private asymmetric encryption key pair.

In particular embodiments, the method can further comprise creating a shared vault shared between the first user and the second user. In one instance, the ECS can be configured to create the shared vault by regularly syncing contents of the first electronic vault with contents of the second electronic vault. Two or more users may not wish to share a vault indefinitely. Thus, the method can further comprise 1) receiving a request from the first user or the second user to stop sharing the shared vault and 2) stopping the regular syncing of the first electronic vault and the second electronic vault. In addition, the creation of a shared vault may require the approval of each user that is to share vault. Thus, the method can further comprise in response to receiving the request from the first remote device associated with the first user to share with the second user first data placed in the first electronic vault, sending a message to the second remote device requesting that the second user to approve the sharing of the first data before the first data is stored to the second electronic vault.

### ECS Aggregation of a User's Account Data

Next, as described above, the ECS can be configured to retrieve data for a user from a number of message providers that maintain accounts for the user. As part of a registration process, the user can specify and provide information that enables the ECS to retrieve data from the specified message providers. The data that is retrieved can include account data, such monthly account statements. The retrieved data can be aggregated into one or more user vaults maintained at the ECS. In one example, the retrieved data can be organized and stored in the one or more user vaults using categorization data supplied by the user.

In one example, a method in the ECS can comprise: 1) generating for a user of the ECS a) a vault for electronically storing data in an encrypted format and b) an ECS user account that allows the user to access to the electronic vault; 2) registering a plurality of message providers with the ECS user account wherein each message provider maintains an account for the user separate from the ECS user account and wherein the registration of each message provider includes i) receiving an authorization to retrieve account data from the account maintained by each message provider for the user, ii) receiving access information for each message provider from the user, the message provider or both, that allows the ECS to retrieve the account data for the first user via an outside interface provided by each message provider; and iii) receiving categorization information for each message provider from the user for organizing the retrieved account data when it is stored in the electronic vault; 3) for each of the plurality of message providers, a) periodically communicating via the outside interface for each message provider to determine whether an account statement or new account data is available for the user from the account maintained by each message provider; b) when the account statement or the new account data is available, retrieving it from the message provider via the outside interface; and c) storing the retrieved account statement or the new account data to the electronic vault according to the categorization data. In one embodiment, the account statement can be a monthly account statement.

In particular embodiments, to enable the ECS to retrieve the account data, the account access information can include a unique account identifier for the account maintained by the registered message provider and a user name and a password each associated with the unique account identifier. In one example, the user name and the password that are provided by the user may allow the ECS to access the account maintained by the registered message provider for the user with access and function performing privileges of the user. In another example, it may not be desirable from the user's standpoint and/or the message providers standpoint to allow the ECS to have the same account privileges as the actually user. Thus, the user name and the password that are provided may allow the ECS to access the account maintained by the registered message provider for the user with access and function performing privileges less than that of the user.

In a particular embodiment, to limit the account access privileges afforded to the ECS, a separate but related account for use by the ECS can be created. Thus, the method can further comprise: in response to receiving the unique account identifier for the account maintained by the registered message provider, the user name and the password associated with the unique account identifier, receiving a new account identifier and a new password for use by the ECS from the message provider wherein via the new account identifier and the new password the ECS can access all or a portion of the account data associated with the account identified by the unique account identifier that are available to the user or can perform all or a portion of functions associated with the account that are available to the user. In particular embodiments, a user may wish to share the account data retrieved by the ECS with another user of the ECS. For instance, account data retrieved by the ECS for an elderly person could also be shared with the person's child or a trustee that helps them with their finances. For instance, to appoint someone as a trustee to an account, the method can further comprise receiving from the user a designation of a trustee for the user account wherein the designation of the trustee permits the ECS under certain circumstances is configured to allow the trustee to access data stored in the user's vault.

Further, to enable data sharing with another user, such as a trustee, the method can further comprise: receiving a request from the user to create a shared vault at the ECS wherein the ECS is configured to allow data placed in the shared vault to be accessed by the user and one or more other users of the ECS and creating the shared vault. In addition, the method can also comprise: 1) receiving a request from the user to place all or a portion of the account data associated with a particular message provider in the shared vault and 2) determining that a newly retrieved account statement or newly retrieved account data is from the particular message provider and determining whether to place the newly retrieved account statement or the newly retrieved account data into the shared vault. The request to place the account data from a particular message provider in the shared vault can also includes a request that the ECS locate and place previously retrieved data associated with the particular message provider in the shared vault.

A user may not wish to continue a shared vault relationship indefinitely. Thus, the method can also comprise: receiving a request to stop placing the all or the portion of the account data associated with the particular message provider in the shared vault and in response, performing one of 1) stopping the future placement of newly retrieved account statements or the newly retrieved account data from the particular message provider into the shared vault, 2) deleting previously retrieved account statements or previously retrieved account data placed in the shared vault from the shared vault or combinations thereof.

When a person obtains a loan, such as a home mortgage, the person can be required to assemble a data package that provides some indication that the person will be able to repay the loan. The data package may include such items as bank statements and pay-stubs. In particular embodiments, the ECS can include features that allow a user to assemble a data package for this purpose as well as to assemble data packages in general and then transfer the data package to another party in a secure manner. Thus, the method can further comprise 1) generating an interface for display on a remote device configured to allow the user to assembly a data package; 2) receiving from the remote device information identifying one or more items of data to be included in the data package; 3) determining whether the identified one or more items are stored at the ECS; 4) retrieving the items determined to be stored at the ECS; and 5) placing the retrieved items in the data package. An entity receiving a data package may wish for some assurances that the data placed in the data package is authentic. Thus, in one embodiment, the method in the ECS can further comprise verifying an authenticity of an item placed in the data package. The verifying can include determining that an account statement or account data placed in the data package is an unaltered copy of the account statement or the account data previously retrieved from a particular message provider by the ECS.

Different methods can be utilized to transfer an assembled data package to an intended recipient, such as a loan provider. In one embodiment, to transfer the assembled data package, the method in the ECS can further comprise: creating a new electronic vault and placing the data package in the new electronic vault. The new electronic vault can be accessible to the intended recipient. After placing the data package in the new electronic vault, the method can further comprise notifying the intended recipient of the data package that the data package can be accessed in the new electronic vault. As alternate method of sending the data package to the intended recipient, the method can further comprise generating a paper copy of the data package or transferring the data package to a portable media device and then sending the paper copy or the portable media device to an intended recipient of the data package. For instance, the paper copy or the portable mail can be sent via a delivery service, such as postal mail or Fedex™.

When a data package is assembled, some but not all of the items in the data package may be currently stored at the ECS. The ECS may attempt to locate each of the specified items. However, if a specified item can't be found, the user may wish to upload one or more items to the ECS to add them to the data package. Thus, in a particular embodiment, the method can involve determining the identified one or more items are not stored at the ECS and generating an interface that is configured to allow the user to upload from a remote device an item to be placed in the data package. To keep track of the items that are to be assembled into the data package, the interface can be configured to 1) allow the user to create a checklist of items to be assembled into the data package and 2) to display a status of each item on the checklist in regards to whether the item has been placed in the data package or not.

When entity outside the ECS manages an account, the outside entity may have a policy of sharing data they have from the account holder with additional third parties. The outside entity may provide a mechanism that allows an account holder to limit or prevent the data sharing. The entity may provide the account holder with some notification that opting out is possible. If the account holder decides to limit the data sharing by the outside entity, the mechanism for opting out may require the user to fill out a particular form, sign it and then send it to a particular address provided by the outside entity. For each outside entity, this process may have to be repeated in a different way, since the mechanism for opting out varies from entity to entity. Thus, when multiple accounts are involved, the opting out of the sharing of account data can be a complicated process for an individual.

In a particular embodiment, the ECS can provide functions that simplify the opting out of the sharing of account data for accounts maintained by outside entities and, in general, the managing the ECS user's data privacy outside of the ECS. For example, the method in the ECS can further comprise maintaining an information sharing database that includes templates associated with different message providers where each template is for generating a message that instructs a particular message provider to not share or limit sharing of the account data for the account maintained by the particular message provider. The templates can be consistent with the mechanism that each message provider has specified for opting out or limiting of data sharing. To help a user manage the data sharing by the user's message providers, the ECS can be configured to receive a request from the first user to restrict the information sharing for the particular message provider and generate the message that instructs the particular message provider to not share or limit sharing of the account data based upon the template for the particular message provider and to send the message to the particular message provider via an appropriate communication channel (e.g., e-mail or postal mail).

In yet other embodiments, an account statement received at the ECS can include an invoice of some type requesting a payment. For instance, a wireless phone statement might include an invoice requesting a payment for the past month's wireless usage. The ECS may include features that help user keep track of and make payments associated with received involves. Thus, the method in the ECS may further comprise one or more of 1) receiving a request from a first remote device transfer funds from a financial institution to make the payment, communicating with the financial institution to transfer funds and sending a notification message to the first remote device when the funds are transferred, 2) sending a message to the first remote device to remind the user of a due date associated with the invoice and 3) generating a user interface including a calendar on a first remote device where the calendar includes an indication of when the payment is due.

In some instances, a third-party receiving data from a user may wish some verification that the data the user is providing is authentic. The ECS can be configured to provide functions that can aid in this process. For instance, in one embodiment, the method in the ECS can further comprise 1) generating an electronic signature for the account statement or the new account data from a message provider, 2) receiving a request from a third-party device to authenticate a copy of the account statement or a copy of the new account data, 3) determining whether the copy of the account statement or the copy of the new account data is authentic; and 4) sending a message to the third-party device indicating whether the copy of the account statement or the copy of the new account data is authentic.

### Metric and Score Generation

Besides provide tools that help a user maintain the privacy of their data, the ECS, as described herein, can provides tools that help a user to manage their business relationships including tools for managing data received during the course of their business relationships. In the process of implementing the tools that help a user to manage their business relationships, the ECS may gain access to information about the users and their business relationship that can be distilled into scores and/or metrics. In one embodiment, a particular score or metric can relate to assessing the likely-hood that a person actually possesses in real-life the identity that they have presented at the ECS. As an example, machine-implemented method related to generating a score associated with this assessment can comprise: 1) establishing a first account for a first user, 2) interacting with a first independent party to confirm that the first user has an established relationship with the first independent party; 3) deriving a user validation score for the first user, where the user validation score indicates a likelihood that the first user's identity is valid, and wherein the user validation score is derived based at least in part upon the fact that the first user has an established relationship with the first independent party; 4) associating the user validation score with the first user; and 5) making the user validation score available to other users of the ECS to enable the other users to determine whether to trust the first user's identity.

The user validation score can be based upon interactions with multiple independent third parties. Thus, the machine implemented method can further comprise 1) interacting with a second independent party to confirm that the first user has an established relationship with the second independent party; and 2) updating the user validation score based at least in part upon the fact that the first user has an established relationship with the second independent party. In particular embodiments, values can be assigned to the established relationships that the first user maintains with independent parties. Thus, the machine implemented method can further comprise: i) determining a first validation score value for the established relationship between the first user and the first independent party where the user validation score is derived based at least in part upon the first validation score value and then, ii) determining a second validation score value for the established relationship between the first user and the second independent party; where the user validation score is updated based at least in part upon the second validation score value.

Validation score values may be determined based on different criteria. For instance, the first validation score value can be determined based at least in part upon how rigorous a verification process is used by the first independent party to verify the first user's identity, and the second validation score value can be determined based at least in part upon how rigorous a verification process is used by the second independent party to verify the first user's identity. In another example, the first validation score value can be determined based at least in part upon how long the first user has had the established relationship with the first independent party, and the second validation score value can be determined based at least in part upon how long the first user has had the established relationship with the second independent party. In addition, weighting factors can be applied to the score values. For instance, the first validation score value can be determined based at least in part upon a first weighting factor associated with the first independent party, and wherein the second validation score value can be determined based at least in part upon a second weighting factor associated with the second independent party.

As noted above, the scores and/or metrics may be obtained in the course of the ECS performing other tasks for the first user, such as retrieving data from an independent party with an established relationship with the user. Thus, the machine implemented method can further comprise: 1) in response to confirming that the first user has an established relationship with the first independent party, establishing a relationship between the first independent party and the first account to allow information from the first independent party to be delivered to the first account at the ECS; and 2) in response to confirming that the first user has an established relationship with the second independent party, establishing a relationship between the second independent party and the first account to allow information from the second independent party to be delivered to the first account at the ECS.

Over time, the relationships that the first user establishes with the independent parties can change. The changing nature of the relationships may affect the user validation score. As a first example, the machine implemented method can further comprise: 1) detecting that the relationship between the first independent party and the first account has been terminated; and 2) updating the user validation score based at least in part upon the fact that the relationship between the first independent party and the first account has been terminated. As another example, the machine implemented method may further comprise i) determining how long the relationship between the first independent party and the first account has remained active; and ii) updating the user validation score based at least in part upon how long the relationship between the first independent party and the first account has remained active. In yet another example, the machine implemented method can further comprise a) determining how much activity has transpired using the relationship between the first independent party and the first account; and b) updating the user validation score based at least in part upon how much activity has transpired using the relationship between the first independent party and the first account.

In general, a score or metric can be constructed based on events that occur at the ECS. These events can be associated only with a particular user or can be associated with a group of users at the ECS. In one embodiment, a method in the ECS can comprise 1) storing to a memory device a plurality of scored events and a value associated with each scored event; 2) registering a user of the ECS with an ECS user account; 3) receiving from a remote device requests to register a plurality of message providers with the ECS for the user; 4) for each registration request, attempting to register the message provider associated with the request wherein a successful registration of the message provider associated with the request instantiates an electronic delivery agreement that authorizes the ECS to retrieve and deliver messages from the successfully registered message provider into the ECS user account; 5) determining one or more of the registration attempts are scored events; 6) for each of the one or more scored events, determining the value associated with the scored event; and 7) generating a score based upon the values associated with the one or more scored events. As described above, the value associated with each scored event can be based upon a process that a message provider performs to verify the identity of the user, the verification process by the message provider can be performed independently of the ECS where the score generated from these values can provide at least a qualitative indication that the user possesses an identity that is consistent with the identification information provided by the user to the ECS.

When a user registers for an account at the ECS, the user may provide identification information to the ECS. Thus, when a user registers a message provider, the identification information provided by the user as part of their account registration process at the ECS can be sent to the message provider. This information may help the message provider to locate and retrieve data from an account that they maintain that is associated with the ECS user. Thus, the method in the ECS may further comprise one or more of 1) receiving user identification information from the user and during the registration request, 2) sending the user identification information to the message provider associated with the registration request, 3) receiving a message from the message provider confirming that the message provider has a business relationship with the user identified via the user identification information sent to the message provider and 4) receiving information characterizing the business relationship between the user and the message provider and determining and/or adjusting a value associated with a scored event based upon the received information characterizing the business relationship. For instance, a first value can be determined based upon the confirmation that the message provider has a business relationship with the ECS user and the first value can be adjusted based upon the information characterizing the business relationship. If no information is received that characterizes the business relationship, then the unadjusted first value can be used.

In particular embodiments, the information characterizing the business relationship can include one or more of a) information regarding a length of time the business relationship between the message provider and the user has been maintained, b) information regarding a status of an account maintained by the message provider for the user (e.g., no payment due, payment due, payment overdue by some amount of time, account in default, active, not active for some time period, etc.), c) information regarding a relative value of the user to the message provider. For instance, the message provider might maintain elite, premier and regular customers or platinum, gold and silver customers, where the terms designate the importance of the customer to the message provider. This information can characterize a relative value of the ECS user to the message provider and can be used to adjust a score.

The score that is generated can change over time. For instance, the score can change due to the changing nature of the relationships that a user maintains with various message providers and the information about these relationships that an ECS user chooses to have shared with the ECS. For instance, a user's score may change from one communication session to another communication session with the ECS. Thus, the method in the ECS can further comprise 1) during a first communication session between the remote device and the ECS, generating a first score based upon the values associated with a one or more first scored events, storing the first score to a memory device and ending the communication session and 2) during a second subsequent communication session between the remote device and the ECS, generating a second score based upon the values associated with one or more second scored events and the values associated with the one or more first scored events and storing the second score to the memory device. As another example, the score might change as a result of user ending a relationship with a message provider and notifying the ECS in some manner, such as via termination of an electronic delivery agreement that has been previously instantiated at the ECS. Thus, the method can further comprise: terminating the electronic delivery agreement between the ECS, a first message provider and the user, and in response to determining that the terminating is a scored event, adjusting the score to reflect the terminating and storing the adjusted score.

In yet other embodiments, the score can be affected by other factors. For instance, the registering of the user of the ECS with an ECS user account can be a scored event. This score generated from registration can be used to set a desired value range for the score. In some example, the score can be raised or lowered depending on the nature of event. For instance, a successful registration attempt and an unsuccessful registration attempt can each scored events with values different from one another where success can improve the score and failure can have an opposite effect on the score. To enable individuals to interpret the scores, the ECS can be configured to display a scale for the score, said scale including a range of values. The scale can includes a number of sub-ranges where each sub-range can be associated with a qualitative characterization of user scores falling within the sub-range.

A score can be based upon interactions between the ECS and third-party devices, such as devices associated with message providers. In one embodiment, a method in an electronic clearinghouse system (ECS) including interaction with third-party devices can comprise: 1) storing to a memory device a plurality of scored events and a value associated with each scored event; 2) registering a user of the ECS with an ECS user account wherein the ECS user account allows the user to access a vault for storing data in an encrypted format; 3) attempting a plurality of transactions involving third-party devices; 4) determining one or more of the transaction attempts are scored events; 5) for each of the one or more scored events, determining the value associated with the scored event; and 6) generating a score based upon the values associated with the one or more scored events. In a particular embodiment, the method can further comprise registering a plurality of message providers associated with the user including instantiating an electronic delivery agreement that authorizes the ECS to retrieve and deliver messages from the successfully registered message provider into the ECS user account for the user where one of the transactions involving the third-party devices can include the retrieval of a message from a message provider and a delivery of the message into the user's vault where the retrieval of the message is a scored event.

In addition, one of the transactions involving the third-party devices can include the retrieval of an account statement data from a message provider for an account maintained by the message provider and a delivery of the account statement data into the user's vault where the retrieval of the account statement data is a scored event. Thus, the method can further comprise retrieving the account statement data a plurality of times over a time period and adjusting the score based upon one or more of 1) a number of times the account statement data has been successfully retrieved, 2) a length of time between when the account statement data was first successfully retrieved and a most recent time that the account statement was successfully retrieved, 3) an amount of time between the last time the account statement data was successfully retrieved and a current time and 4) combinations thereof.

The ECS can be configured to allow a user to make payments. In particular embodiments, the payments made via the ECS can affect a score. Thus, the method can further comprise receiving message including an invoice and delivering the invoice into the user's vault where the one of the transactions involving the third-party devices includes making an electronic payment associated with the invoice and where the making of the electronic payment is a scored event.

### Creating and Viewing Data Associations

Another aspect of the ECS can be related to associating various files with one another. The associations can be made automatically by the ECS and/or can be specified by a user. As an example, a first file can include a number of transactions, such as purchases made by a user and a number of additional files can be associated with it, such as a file including an electronic receipt, a file including warranty information and a file including a user's manual for the item purchased. These files can be stored in a hierarchical file system. A user interface can be provided that displays relationships between the different files and lets the user view the contents of various files. Thus, in a particular embodiment, a method in the ECS can be generally characterized as comprising: 1) generating for a user of the ECS i) a vault for electronically storing data in an encrypted format and ii) an ECS account that allows access to the electronic vault; 2) receiving a first file; 3) receiving a second file; 4) determining contents of the second file are linked to at least a first portion of the contents of the first file; 5) storing the first file to the electronic vault including information indicating the first portion of the contents of the first file is linked to the contents of the second file; 6) storing the second file; 7) generating a user interface for outputting data to a remote device; and 8) displaying via the user interface the first portion of the contents of the first file and one or more indicators, each indicator for indicating that ECS is storing additional data linked to the first portion including a first indicator for indicating the link to the second file.

In particular embodiments, the method can further comprise: receiving a selection of the first indicator and in response displaying all or a portion of the contents of the second file. The interface can be arrange to display the contents of related files alone or simultaneous with one another. Thus, all or the portion of the contents of the second file can be displayed simultaneously with the first portion of the contents of the first file. The second file can be stored in the user's electronic vault in an encrypted format. Thus, the method can further comprise prior to displaying all or the portion of the contents of the second file, determining a decryption key needed for decryption and then decrypting the second file stored in the electronic vault using the determined encryption key.

The ECS can be configured to automatically determine links between files. For instance, if the ECS identifies a transaction in a statement, such as a credit card statement, is associated with the purchase of item, the ECS can be configured to determine that another file contains receipt information or warranty information, such as via scanning the contents of the file, and then save information indicating the relationship between the transaction and the contents of the other file. In some instances, the ECS can be configured to request the ECS user to verify of the validity of the relationship determined by the ECS and then take action depending upon the input provided the user. Thus, the method can further comprise 1) displaying a message requesting the user to confirm the determined link between the contents of the second file and the first portion of the contents of the first file and 2) when the determined link is not confirmed, deleting the information from the electronic vault indicating the first portion of the contents of the first file is linked to the contents of the second file.

The request to delink or link files can also be initiated by the user. Thus, the method can further comprise one or more of 1) receiving a request from the user to delete the information indicating the first portion of the contents of the first file is linked to the contents of the second file and in response to the request, deleting from the electronic vault the information indicating the first portion of the contents of the first file is linked to the contents of the second file, 2) receiving a request from the user to create a link between the first portion of the contents of the first file and contents of a third file wherein the request includes information describing the link.

A single portion of the contents of one file can be linked to multiple files. For instance, the first portion of the contents of the first file can be related to a purchase and the contents of additional files can be related to one or more of a receipt associated with the purchase, a warranty associated with the purchase or a user's manual associated with the purchase. In particular embodiments, the contents of the second file can include an electronic copy of document uploaded to the ECS from a remote user device. For instance, the contents of the second file include image data generated on a mobile device, such as a picture of a paper copy of a receipt.

To allow for multiple associations between files, the method can further comprise one or more of 1) storing the first file including information indicating the first portion of the contents is linked to the contents of the third file to the electronic vault, 2) storing the second file including the contents of the second file are linked to the contents of the third file and 3) storing the third file including information indicating the contents of the third file are linked to the first portion of the contents of the first file and the contents of the second file. In various embodiments, all of the possible links between files do not have to be stored. For instance, links between a first file and a second file and a first file and a third file can be stored but links between the second file and the third file may or may not be stored.

As described above, the ECS can be configured to determine links between files. Thus, the method can further comprise: determining contents of a third file are linked to at least a second portion of the contents of the first file. One method of the determining the contents of different files are related to one another can be based on categorization information about the files received from the user and/or a message provider. Thus, the method can further comprise 1) receiving first categorization data that categorizes the contents of the first file and second categorization data that categorizes the contents of the second file where the determining of the link between the first portion of the contents of the first file and the contents of the second file is based at least partially upon the first categorization data and the second categorization data and 2) storing information regarding the determined one or more links. If a portion of the contents of one file are linked to multiple different files, then these relationships can be conveyed to a user in some manner. As an example, the method can further comprise displaying via the user interface a second indicator for indicating the second portion of the contents of the first file is linked to the contents of the third file.

### Integration of ECS Retrieved and User Uploaded Data

One aspect of the ECS can relate to providing tools that allow seamless storage and location of documents retrieved by the ECS and documents uploaded to the ECS by the user. For instance, when a user first registers for an account at the ECS, the ECS user may possess copies of paper account statements and other documents that they wish to have stored and made available at the ECS along side of documents that are retrieved and delivered into their ECS account by the ECS. Toward this end, in one embodiment, a method in the ECS can comprise 1) generating for a user of the ECS i) a vault for electronically storing data in an encrypted format and ii) an ECS account that allows access to the electronic vault; 2) registering a plurality of message providers with the ECS user account wherein each message provider maintains an account for the user separate from the ECS user account and where the registration of each message provider includes i) receiving an authorization for the ECS to retrieve account data from the account maintained by each message provider for the user and ii) receiving access information for each message provider from the user, the message provider or both, that allows the ECS to retrieve the account data for the first user via an outside interface provided by each message provider where the first file is received from one of the plurality of message providers; 3) for a particular registered message provider, periodically retrieving account data that is formatted as an account statement that reflects account activity for a particular time period; 4) receiving a file including an electronic copy of an account statement from the particular registered message provider wherein the account statement from the particular message provider has been delivered to user without using the ECS and information separate from the file indicating the file includes an electronic copy of the account statement; 5) storing to the electronic vault the file and the information separate from the file indicating the file includes the electronic copy of the account statement; and 6) generating a search interface configured to receive a query that allows the user to search the electronic vault for both the account statements from the particular message provider retrieved via the ECS and the electronic copy of the account statement from the particular message provider delivered to the user without using the ECS.

In a particular embodiment, the account statements from the particular message provider retrieved via the ECS and the electronic copy of the account statement from the particular message provider sent to the user without using the ECS can be stored in a hierarchical file system where names of files and folders in the hierarchical file system include information indicating one or more of a time period, information related to identity of the particular message provider, a nature of contents in the files and folders, information related to a service provided by the particular message provider or combinations thereof. The ECS can be configured to provide tools that allow the relationships in the hierarchical file system to be viewed. Thus, the method can further comprise generating a visual representation of hierarchical file system that can be output to a remote device.

Further, the ECS can be configured to allow a user to specify a desired naming convention. For instance, the user might be able to specify files containing bank statements are to be named as “name_date,” where “name” is a name provided by the user and “date” is the date, such as the month associated with the bank statement. All of the files for a particular bank might be stored in a folder, such as “name_year,” which can be a sub-folder of “name” where all of the files for a particular year are stored in the “name_year” folder and the “name_year” folder is a sub-folder of the “name” folder. To allow for user input of name conventions, the method can further comprise receiving a selection of a naming convention from the user that allows the ECS to determine the names of files and folders newly created by the ECS.

The ECS can be configured to categorize and store files by searching within the file. Thus, the method can further comprise searching contents of the file to determine contents of the file and storing information determined from the search of the file as well as the file itself to the electronic vault. In some instance, the file can be received in a format, such as an image format, where text characters are not specified. Thus, to learn about the textual contents of the file, the method can further comprise, prior to performing the search, processing the file using an optical character recognition program. Image recognition software could also be applied to a file with image data to allow the ECS to learn about the image contents of a particular file and possibly categorize the file.

In other embodiments, the ECS can utilize other tools that help an ECS user have their past data brought into the system. For instance, the ECS may attempt to retrieve copies of past data that was delivered to the user via some other means outside of the ECS. Thus, the method can further comprise after the particular message provider is registered at the ECS, attempting to retrieve account data including account statements that have been delivered to the user without the ECS and when the account data is retrieved, storing the account data to the user's electronic vault. The ECS can be configured to notify the user of what past data it has retrieved. Thus, the method can further comprise sending a notification message to the user describing what account data has been retrieved.

When the ECS retrieves data for a user, such as but not limited to past account data retrieved after the user registers a message provider with the ECS, the retrieved account data that is formatted as the account statement can be formatted as the account statement prior to its retrieval by the ECS. In other instances, the retrieved account data that is retrieved is not formatted as the account statement and the ECS can be configured to format the account data into the account statement after its retrieval from the particular message provider. In particular embodiments, an electronic copy of the account statement can be formatted as image data. For instance, the ECS user can take a picture of their account statement or scan a copy of their account statement and upload it. Thus, the method can further comprise generating an interface that is configured to allow the first user to upload files, such as files including the electronic copy of the account statement, to the ECS.

The interface can also be configured to allow the user specify information about the file. When the file is uploaded, a user may wish to specify information about the file for categorization purposes or to associate the file with another file that is already stored in one of the vaults at the ECS. Thus, the method can further comprise generating an interface that is configured to the first user to upload a file including data associated with one of the plurality of message providers and specify information about the file that indicates the relationship of the file to the one of the plurality of message providers.

Information Aggregation into Electronic Vaults

Another aspect of the ECS can relate to data aggregation from the perspective of the user. The data aggregation can involve a user registering a number of entities outside of the ECS that provide information to the user, such as information about external accounts maintained by the entities. Using the provided information, the ECS can retrieve the information from the outside entities and store it to the user's ECS account, such as in one or more electronic vaults, according to personal preferences selected by the user. The retrieved information can be formatted as electronic documents. As example, in one embodiment, a method can comprise 1) creating one or more user vaults for a user of the ECS; 2) establishing a first relationship between the ECS and a first information provider with which the user has a first external account, the first relationship enabling the ECS to obtain from the first information provider information pertaining to the first external account; 3) establishing a second relationship between the ECS and a second information provider with which the user has a second external account, the second relationship enabling the ECS to obtain from the second information provider information pertaining to the second external account; 4) automatically obtaining a first set of information pertaining to the first external account from the first information provider using the first relationship and a second set of information pertaining to the second external account from the second information provider using the second relationship; 5) encrypting at least the first set of information to derive a first encrypted document, and encrypting at least the second set of information to derive a second encrypted document; and 6) storing the first and second encrypted documents in the one or more user vaults. Many different types of information can be obtained. For instance, in particular in one embodiment, the first set of information comprises payroll/benefits information for the user. In the first set of information comprises healthcare information for the user.

The ECS user may prefer that the ECS doesn't access their accounts in the same way that they can. Thus, in the method above, the first relationship can be separate from a first direct relationship that the user has with the first information provider where the first relationship grants the ECS limited privileges to obtain information from the first information provider pertaining to the first external account but does not grant the ECS full privileges to perform all acts in the first external account that the user can perform using the first direct relationship. For instance, when the external account is a bank account, the user may be able to authorize the transfer of funds to an outside entity but the ECS may not be able to perform this function unless authorized to do so by the user on a transaction by transaction basis. The privileges that are assigned to the ECS can vary from information provider to information provider. Thus, in the method, the second relationship can be separate from a second direct relationship that the user has with the second information provider where the second relationship grants the ECS limited privileges to obtain information from the second information provider pertaining to the second external account but does not grant the ECS full privileges to perform all acts in the second external account that the user can perform using the second direct relationship.

In the method above, the information obtained from the information providers can be encrypted with different encryption keys and stored to do different vaults. For instance, the first set of information can be encrypted using a first encryption key and the second set of information can be encrypted using a second and different encryption key. Further, the first encrypted document can be stored in a first user vault and the second encrypted document can be stored in a second and different user vault, and wherein both the first and second user vaults are associated with the user.

In particular embodiments, information received from an information provider can be shared among users. For instance, the first set of information can be included in a first document, wherein the first encrypted document is derived by encrypting the first document using a first encryption key, and where the method further comprises: 1) receiving input indicating that the user wishes to send the first document to another user; 2) in response to the input, decrypting the first encrypted document to derive the first document; 3) encrypting the first document using a second and different encryption key to derive a newly encrypted document; and 4) storing the newly encrypted document in a user vault associated with the other user. As another example, the method can further comprise: i) receiving input from the user indicating a grant of permission to another user to access the first encrypted document; ii) sending a notification to the other user regarding the grant of permission; iii) detecting that the other user is attempting to access the first encrypted document; and iv) in response to detecting that the other user is attempting to access the first encrypted document, decrypting the first encrypted document. To help the other user gain access to the document, the notification can include a link to the first encrypted document where in response to a selection of the link, the ECS can attempt to open the document.

As noted above, the ECS can allow users and information providers to establish relationships with one another via the ECS. In a particular embodiment, the establishing of the first relationship can comprise: 1) receiving a request from the first information provider to establish the first relationship; and 2) in response to the request, establishing the first relationship between the ECS and the first information provider. In another embodiment, the establishing of the first relationship can comprise: i) sending a request to the first information provider to establish the first relationship, the request causing the first information provider to verify with the user, via a mechanism external to the ECS, that the ECS should be given permission to obtain information pertaining to the first external account; ii) receiving from the first information provider an indication that the ECS has been given permission by the user to obtain information pertaining to the first external account; and iii) in response to the indication, establishing the first relationship between the ECS and the first information provider.

In various embodiments, it may desirable to provide, one or more of the parties participating in an information transfer, notification regarding a status of the information transfer, such as whether the information has been delivered and/or viewed by one of the parties. Thus, in one example, the method can further comprise providing notification to the first information provider that the first set of information has been delivered to the user. In another example, the method can further comprise determining that the user has viewed the first set of information and providing notification to the first information provider that the user has viewed the first set of information.

As part of the encryption process in the method above, the ECS can be configured to create a formatted document. For instance, the encrypting at least the first set of information can comprise: 1) generating, based at least in part upon the first set of information, a first formatted document, wherein the first formatted document is formatted in accordance with a set of parameters specified by the first information provider; and 2) encrypting the first formatted document to derive the first encrypted document. As another example, the encrypting at least the second set of information can comprise: i) generating, based at least in part upon the second set of information, a second formatted document, wherein the second formatted document is formatted in accordance with a set of parameters specified by the second information provider and ii) encrypting the second formatted document to derive the second encrypted document.

In particular embodiments, generating the first formatted document can comprise one or more of 1) adding information specific to the user to the first formatted document so that the first formatted document is customized for the user 2), adding an advertisement to the first formatted document, where the advertisement is selected by the first information provider, the ECS, or both and 3) combinations thereof. The advertisement can be selected specifically for the user based upon one or more characteristics specific to the user. To later authenticate documents, such as at the request of a third-party separate from the user that has received the document, the encrypting of at least the first set of information can further comprise electronically signing the first formatted document with a digital signature associated with the first information provider to provide confirmation that the first formatted document is authentic.

In particular embodiments, the ECS can be configured to mirror a user vault maintained on a device remote to the ECS. Thus, the method can further comprise synchronizing the one or more user vaults maintained by the ECS with one or more user vaults maintained by a user device controlled by the user, where the user device is remote from the ECS. In one embodiment, to sync a vault at the ECS with a vault on a remote device, the ECS and/or the remote device can be configured compare the contents of the synced vault. Thus, the synchronizing can comprise: comparing contents of the one or more user vaults maintained by the ECS with contents of the one or more user vaults maintained by the user device; and copying and transferring information as necessary between the one or more user vaults maintained by the ECS and the one or more user vaults maintained by the user device to make the contents of the one or more user vaults maintained by the ECS and the one or more user vaults maintained by the user device consistent with each other. This process can be repeated as new data is added to each of the vaults on the ECS or user maintained device according to a schedule and/or in response to new data being added to either of the vaults.

As described above, the ECS can include a hierarchical file system. Thus, the storing of the first encrypted document in the one or more user vaults can comprise: storing the first encrypted document in a hierarchical file system associated with the one or more user vaults. Further, the storing the first encrypted document in the one or more user vaults can comprise: 1) determining a category with which to associate the first encrypted document; and 2) storing the first encrypted document in a file system associated with the one or more user vaults based, at least in part, upon the category where the determining a category with which to associate the first encrypted document can comprise: i) accessing a set of categorization parameters specified by the user; and ii) determining the category with which to associate the first encrypted document based, at least in part, upon the set of categorization parameters.

In addition, as described above, the ECS can include capabilities that allow files to be stored and recalled in relation to one another. For example, the first set of information can be included in a first document where the first encrypted document can be derived by encrypting the first document using a first encryption key, and where the method can further comprise: 1) receiving input from the user to associate a particular document in the one or more user vaults with a first portion of the first document; and 2) in response to the input, storing information that indicates a link between the particular document and the first portion of the first document. The storing information can comprise inserting into the first document information that indicates a link between the first portion of the first document and the particular document. This link can be displayed in a user interface that allows the user to view the first document. Thus, the method can further comprise i) receiving further user input indicating that the user is invoking the link in the first document that links the first portion of the first document to the second document; and ii) in response to the further user input, accessing the second document.

### ECS Data Delivery

The ECS can be configured to deliver data for an outside entity to their customers with accounts at the ECS. For instance, an employer might use the ECS to deliver employee information, such as pay stubs to their employees. As another example, a healthcare institution, such as a hospital, might use the ECS to deliver personal and private medical information to ECS users that are patients of the healthcare institution. In yet another example, a bank might have the ECS deliver bank statements to ECS users that are customers of the bank. The outside entities can be referred to as message providers. Thus, in one embodiment, a method in the ECS can generally comprise 1) receiving from a message provider an authorization for the ECS to electronically retrieve and deliver messages to users of the ECS that have a business relationship with the message provider; 2) receiving from the message provider a selection of electronic delivery options that affect how messages associated with the message provider are to be retrieved and delivered by the ECS; 3) generating for each of the users of the ECS a) a vault for electronically storing data in an encrypted format including storing the messages from at least the message provider and b) an account that allows access to the vault; 4) receiving from a remote device a request for retrieval and delivery of the messages from the message provider for a first user of the ECS; 5) generating and storing to a memory device at ECS an electronic delivery agreement between the first user, the message provider and the ECS wherein the electronic delivery agreement includes i) information indicating the first user wishes the ECS to retrieve and deliver the messages from the message provider into the first user's vault at the ECS in accordance with the selection of electronic delivery options and ii) access information that allows the ECS to retrieve and deliver data from the message provider for the first user; and 6) retrieving, delivering and storing a message associated with the first user from the message provider into the vault of the first user.

In particular embodiments, a message provider may desire information regarding a status of the information transfer from the message provider to the user. Thus, the method can further comprise one or more of 1) providing a notification to the message provider that the message has been delivered into the vault of the first user and 2) determining the first user has viewed the message and sending a notification to the message provider indicating the first user has viewed the message.

To obtain information from a message provider, in particular embodiments, an ECS user can provide access information, which is associated with their accounts maintained outside the ECS. The access information can include account information associated with the account maintained by the message provider that allows the ECS to utilize an outside interface provided by the message provider to retrieve data for the first user. In particular embodiments, the outside interface can be configured to receive inputs that allow actions associated with an account for the first user maintained by the message provider to be performed by the ECS and the first user and where the access information includes information that restricts the actions that can be performed by the ECS via the outside interface as compared to the first user.

The ECS can be configured to place retrieved data into a user's vault. In one embodiment, the retrieved data can be account data or account statements. Thus, the method further comprising: 1) retrieving account data for an account maintained by the message provider for the first user, 2) placing the retrieved account data in a file and 3) storing the file in a file system associated with the first user's vault. In instance, the account data can be retrieved as a formatted account statement for the first user. In another instance, the ECS can be configured to retrieve the account data as transactional data and then format it into an account statement. Thus, the method can further comprise: i) retrieving the account data as transactional data and ii) formatting at the transactional data into an electronically viewable and printable account statement.

In particular embodiment, the formatting of the transactional data can be affected by options specified by the message provider. For instance, the selection of the electronic delivery options can include information for how the ECS is to format the account statement. In one example, the ECS can be configured to add advertising or other data to an account statement to customize it. Thus, the formatting can include adding advertising into the account statement wherein the advertising is selected by the message provider, the ECS or combinations thereof.

As files are stored at the ECS, the ECS user may wish to organize it so that it can be later found and utilized more easily. Thus, the method can further comprise one or more of 1) receiving categorization information for the file wherein the ECS is configured to provide searches of the file system based upon the received categorization information, 2) automatically categorizing the file based upon one or more categorization parameters selected by the first user or 3) receiving association information for the file wherein the association information associates the file with one or more other files and wherein the ECS is configured to retrieve each associated file alone or in combination with the other files to which it is associated. In a particular example, the file can include transactional data related to a purchase where one or more other files are associated with the purchase, such as an electronic copy of a receipt associated with the purchase, a warranty associated with the purchase and a user manual associated with the purchase.

The registration of a message provider to a user account at the ECS can start prior to or after the user account is established. Thus, the vault and the account can be generated for the first user prior to receiving the request for retrieval and delivery of messages from the message provider or the vault and the account are generated for the first user in response to the request for retrieval and delivery of messages from the message provider. Not all customers of a message provider may be eligible for data delivery from the message provider via the ECS. Thus, the method can further comprise in response to receiving the request for retrieval and delivery of messages from the message provider, determining based upon the selection of electronic delivery options by the message provider whether the first user is eligible for the retrieval and delivery and messages from the message provider.

The electronic delivery agreements established between a user, the ECS and a message provider can vary from user to user and from message provider to message provider. Thus, in one embodiment, the method can further comprise 1) receiving a request for retrieval and delivery of messages from the message provider for a plurality of different users of the ECS and for each of the different users, 2) generating and 3) storing to a memory device at ECS an electronic delivery agreement between each user, the message provider and the ECS wherein the electronic delivery agreement includes i) information indicating the that each user wishes the ECS to retrieve and deliver messages from the message provider into each user's vault at the ECS in accordance with the selection of electronic delivery options and ii) access information that allows the ECS to retrieve and deliver data from the message provider for each user. Further, in another embodiment, the method can comprise 1) receiving a request for retrieval and delivery of messages from a second message provider for the first user of the ECS; 2) generating and 3) storing to a memory device at ECS an electronic delivery agreement between the first user, the second message provider and the ECS wherein the electronic delivery agreement includes i) information indicating the first user wishes the ECS to retrieve and deliver messages from the second message provider into the first user's vault at the ECS in accordance with a selection of electronic delivery options by the second message provider and ii) access information that allows the ECS to retrieve and deliver data from the second message provider for the first user; and 4) retrieving, delivering and storing a message associated with the first user and the second message provider into the vault of the first user.

In one embodiment, the ECS may not deliver data from a particular message provider to an ECS user until the ECS receives authorization from the message provider. Thus, the method can further comprise receiving from a plurality of different message provider an authorization for the ECS to electronically retrieve and deliver messages to users of the ECS that have business relationships with each of the plurality of different message providers; and receiving from each of the plurality of different message providers a selection of electronic delivery options that affect how messages associated with each of the plurality of different message providers are to be retrieved and delivered by the ECS.

A user's vault can store files in an encrypted format. In one embodiment, files stored in the user's vault can be encrypted with a public key of a public private key pair. Thus, the method can further comprise prior to storing the message retrieved from the message provider into the first user's vault, 1) retrieving a public encryption key for the first user from a database of public encryption keys maintained at the ECS associated with the users of the ECS and 2) encrypting the message with the first user's public encryption key. A private key different from the first user's public encryption key is needed to decrypt the message encrypted with the first user's public key. In one instance, the private key is not stored at the ECS. In another instance the private key is stored at the ECS, but, the ECS is configured to decrypt the message with the private key only after receiving a verifiable authorization from the first user or an authorized representative of the first user.

The ECS can be configured to authenticate data retrieved by the ECS to third-party requestors. Thus, the method can further comprise receiving a request to determine the authenticity of the message retrieved from the message provider and stored into the vault of the first user and determining that the message stored in the first user's vault is comparable to the message retrieved by ECS from the message provider. In other embodiments, as described above, the ECS can be configured to sync the contents of two or more vaults. The two or more vaults can be located on different devices. Thus, the method can comprise syncing the first user's vault maintained by the ECS with a second vault maintained on a remote device controlled. The syncing can comprise receiving contents of the second vault from the remote device, comparing the contents of the first user's vault with the contents of the second vault and transferring data between the first user's vault maintained at the ECS and the second so that the contents of each of the vaults are matched.

To retrieve data from various message providers, in one embodiment, the ECS can be configured to periodically communicate with the message providers. Thus, as an example, the method can further comprise periodically communicating with the message provider to determine whether new messages are available for the first user. The ECS under different circumstances may end the periodic communications with a message provider. For instance, the method can comprise receiving a request from the remote device to terminate the electronic delivery agreement between the first user, the message provider and the ECS and in response to the request terminating the periodically communicating with the message provider to determine whether the new messages are available. In another example, the electronic delivery agreement further includes limit information that can be used to suspend or terminate the electronic delivery agreement and based upon the limit information, determining the electronic delivery agreement is to be suspended or terminated.

In a particular embodiment, the ECS can deliver payroll information from employers to employees with ECS account. A method an electronic payroll clearinghouse system (ECS) can generally comprise: 1) receiving from an employee information provider an authorization for the ECS to electronically retrieve and deliver messages including employee payroll and benefit information to users of the ECS; 2) receiving from the employee information provider a selection of electronic delivery options that affect how messages including the payroll and benefit information are to be retrieved and delivered by the ECS; 3) generating for each of the users of the ECS i) a vault for electronically storing data in an encrypted format including storing the payroll and benefit messages from at least the employee information provider and ii) an account that allows access to the vault; 4) receiving from a remote device a request for retrieval and delivery of the payroll and benefit messages from the employee information provider for a first user of the ECS; 5) generating and storing to a memory device at ECS an electronic delivery agreement between the first user, the employee information provider and the ECS wherein the electronic delivery agreement includes a) information indicating the first user wishes the ECS to retrieve and deliver the payroll and benefit messages from the employee information provider into the first user's vault at the ECS in accordance with the selection of electronic delivery options and b) access information that allows the ECS to retrieve and deliver data from the employee information provider for the first user; and 6) retrieving, delivering and storing a payroll and benefit message associated with the first user from the employee information provider into the vault of the first user. The payroll and benefit messages can include a W-2 form or a W-4 form associated with employment of the first user with an employee.

In another embodiment, the ECS can deliver healthcare related information from healthcare providers to their customers with ECS accounts. A method in an electronic health care data clearinghouse system (ECS) can be generally characterize as comprising: 1) receiving from a health care information provider an authorization for the ECS to electronically retrieve and deliver messages including health care information to users of the ECS; 2) receiving from the health care provider a selection of electronic delivery options that affect how messages including the health care data are to be retrieved and delivered by the ECS; 3) generating for each of the users of the ECS i) a vault for electronically storing data in an encrypted format including storing the healthcare information messages from at least the health care information provider and ii) an account that allows access to the vault; 4) receiving from a remote device a request for retrieval and delivery of the health care information messages from the employee information provider for a first user of the ECS; 5) generating and storing to a memory device at ECS an electronic delivery agreement between the first user, the health care information provider and the ECS wherein the electronic delivery agreement includes a) information indicating the first user wishes the ECS to retrieve and deliver healthcare information messages from the healthcare information provider into the first user's vault at the ECS in accordance with the selection of electronic delivery options and b) access information that allows the ECS to retrieve and deliver data from the health care information provider for the first user; and 6) retrieving, delivering and storing a health care information message associated with the first user from the employee information provider into the vault of the first user. The health care information message can include medical history information associated with the first user.

Another method in the ECS involving retrieving data for multiple users can be generally characterized as comprising: 1) establishing a first relationship between a first user and an information provider to allow information from the information provider to be delivered to a first vault associated with the first user; 2) establishing a second relationship between a second user and the information provider to allow information from the information provider to be delivered to a second vault associated with the second user; 3) receiving a plurality of sets of information from the information provider; 4) determining that a first set of information is intended for the first user and a second set of information is intended for the second user; 5) encrypting the first set of information with a first encryption key to derive a first set of encrypted information and storing the first set of encrypted information in the first vault; and 6) encrypting the second set of information with a second and different encryption key to derive a second set of encrypted information and storing the second set of encrypted information in the second vault.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a block diagram of a user receiving messages from a number of different message providers.

FIG. 2 shows a block diagram of an electronic clearinghouse system in accordance with the described embodiments

FIG. 3 shows a block diagram of functions associated with an electronic clearinghouse system in accordance with the described embodiments.

FIG. 4 is a block diagram showing an electronic clearinghouse system in communication with a number of devices in accordance with the described embodiments.

FIG. 5A is a block diagram showing a communication and information distribution channels associated with an electronic clearinghouse system in accordance with the described embodiments.

FIGS. 5B and 5C are block diagrams showing user vaults associated with an electronic clearinghouse system in accordance with the described embodiments.

FIG. 6 is a block diagram showing secure delivery of data from a message provider to a user computing device via an electronic clearinghouse system in accordance with the described embodiments.

FIG. 7 is a block diagram showing direct communications between a message provider and a user computing device via an application associated with the financial document clearinghouse and a secure delivery network in accordance with the described embodiments.

FIG. 8 is a block diagram showing communications involving financial transactions generated via an electronic clearinghouse system in accordance with the described embodiments.

FIG. 9 is a block diagram showing data transfer between two devices via an electronic clearinghouse system in accordance with the described embodiments.

FIG. 10 is an interaction diagram between a user computing device, a message provider, an electronic clearinghouse system including initial registration with the system in accordance with the described embodiments.

FIG. 11 is an interaction diagram between a user computing device, a message provider, an electronic clearinghouse system including account registration in accordance with the described embodiments.

FIG. 12 is a block diagram of a method in the electronic clearinghouse system involving removing a message provider from a user's account in accordance with the described embodiments.

FIG. 13 is an interaction diagram between a user computing device, a message provider, an electronic clearinghouse system including data retrieval from the message provider in accordance with the described embodiments.

FIG. 14 is an interaction diagram between a user computing device, a recipient device, a financial institution server, an electronic clearinghouse system including a financial transaction in accordance with the described embodiments.

FIG. 15 is an interaction diagram between a user computing device, a message provider, a recipient device, an electronic clearinghouse system including assembling a data package for delivery to the recipient device in accordance with the described embodiments.

FIG. 16 is a block diagram showing examples of communications involving electronic clearinghouse system and a bank in accordance with the described embodiments.

FIG. 17 is a block diagram showing user devices accessing a secure and structured message data store at the electronic clearinghouse system in accordance with the described embodiments.

FIG. 18 is a block diagram of a method of determining a user validation score in accordance with the described embodiments.

FIG. 19 is a block diagram of a method of generating a user validation score in accordance with the described embodiments.

FIG. 20 is a block diagram of a server and user computer in accordance with the described embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

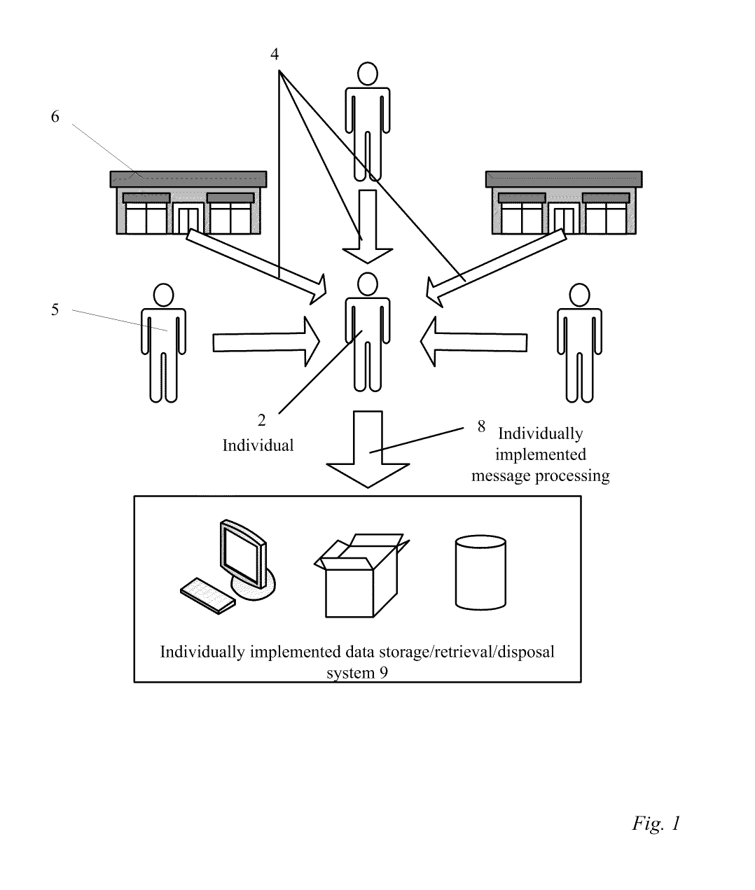

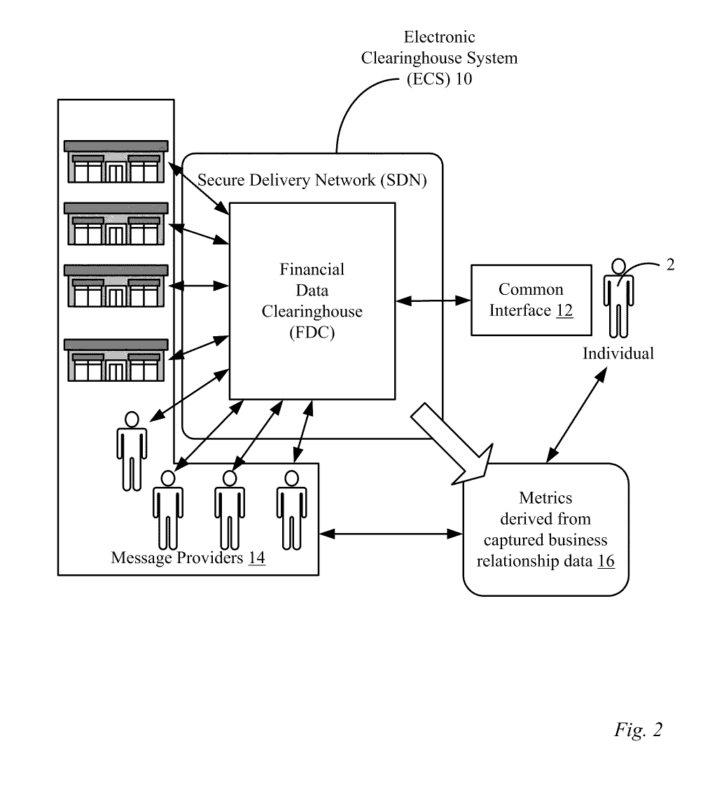

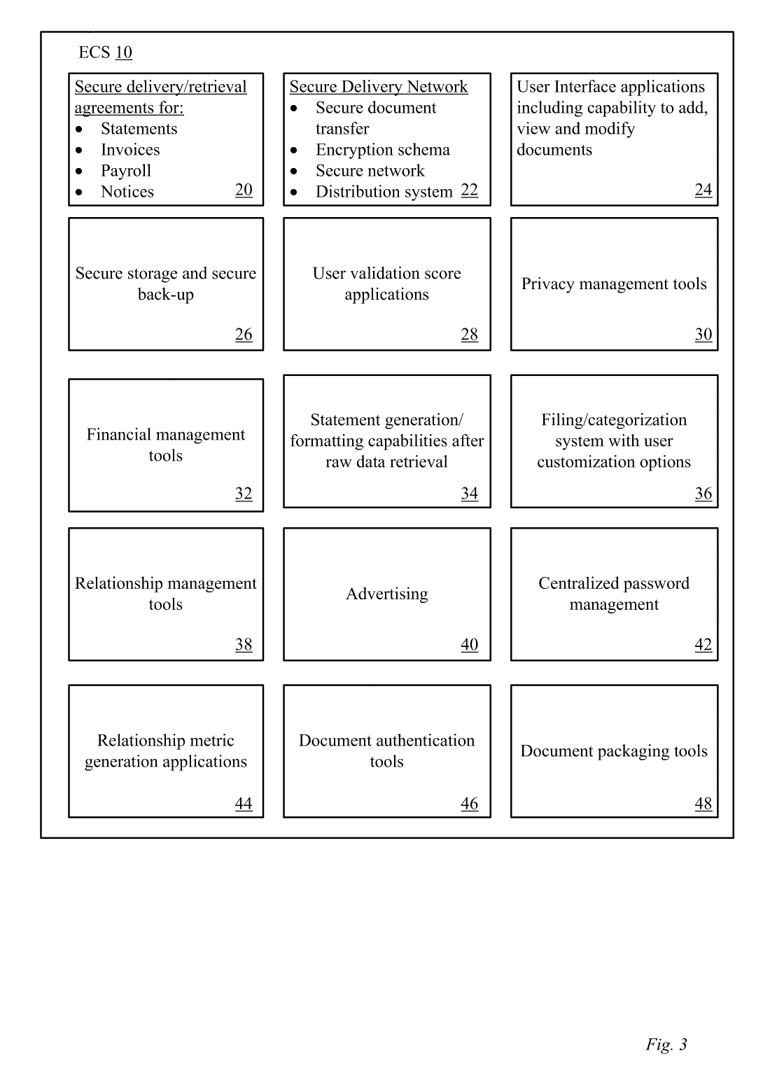

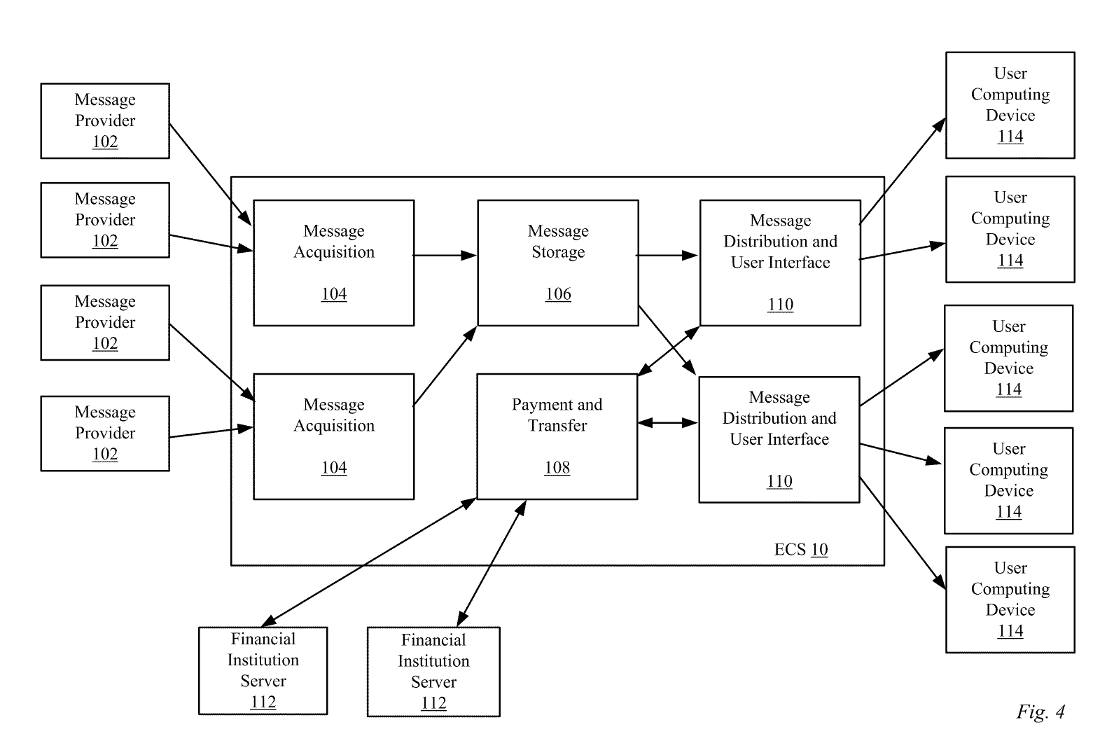

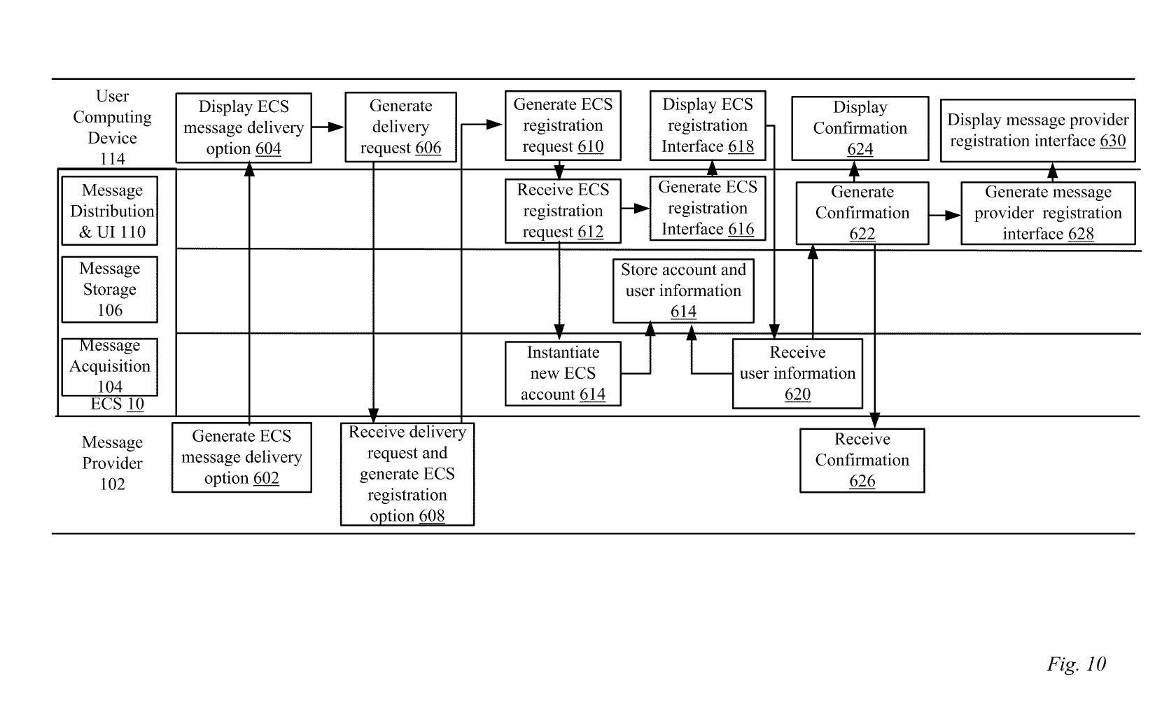

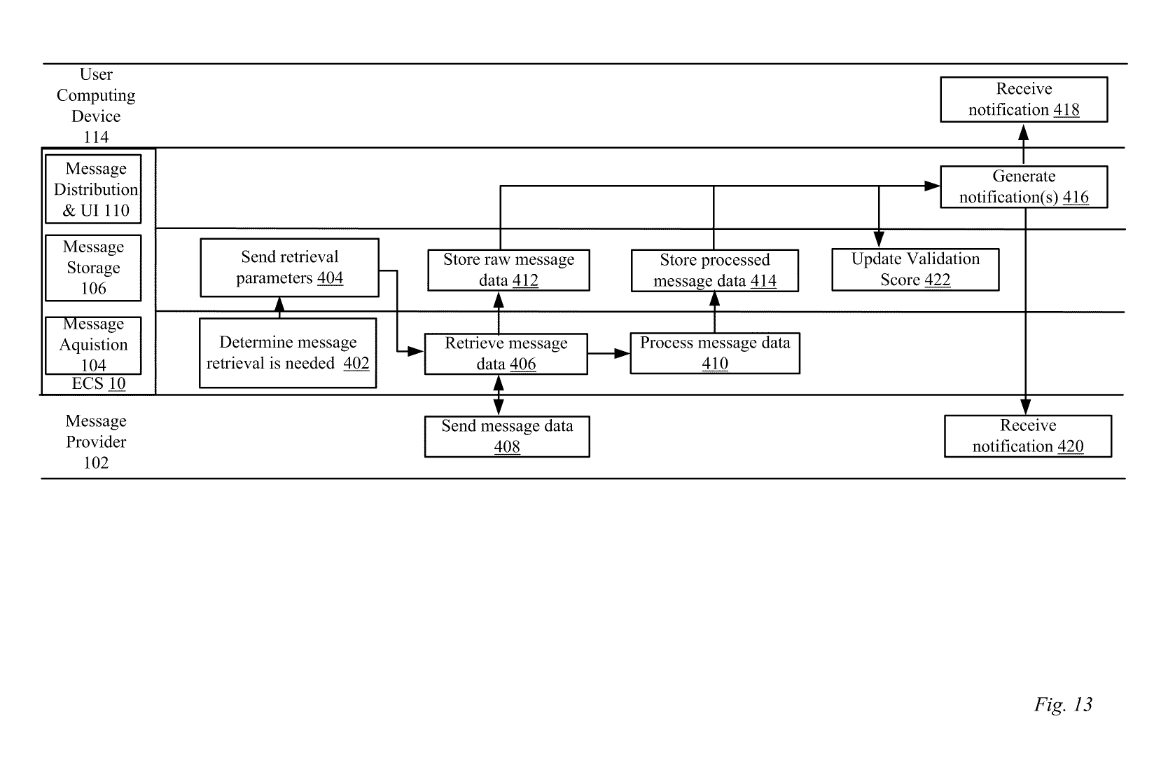

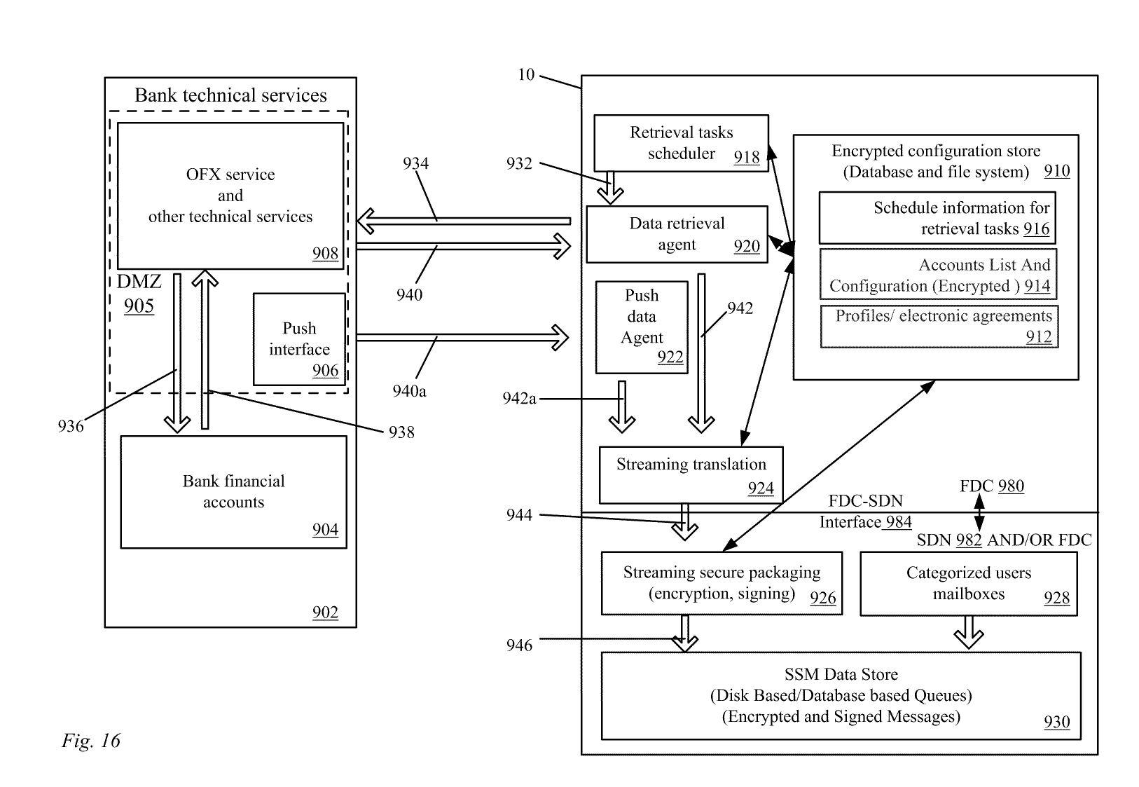

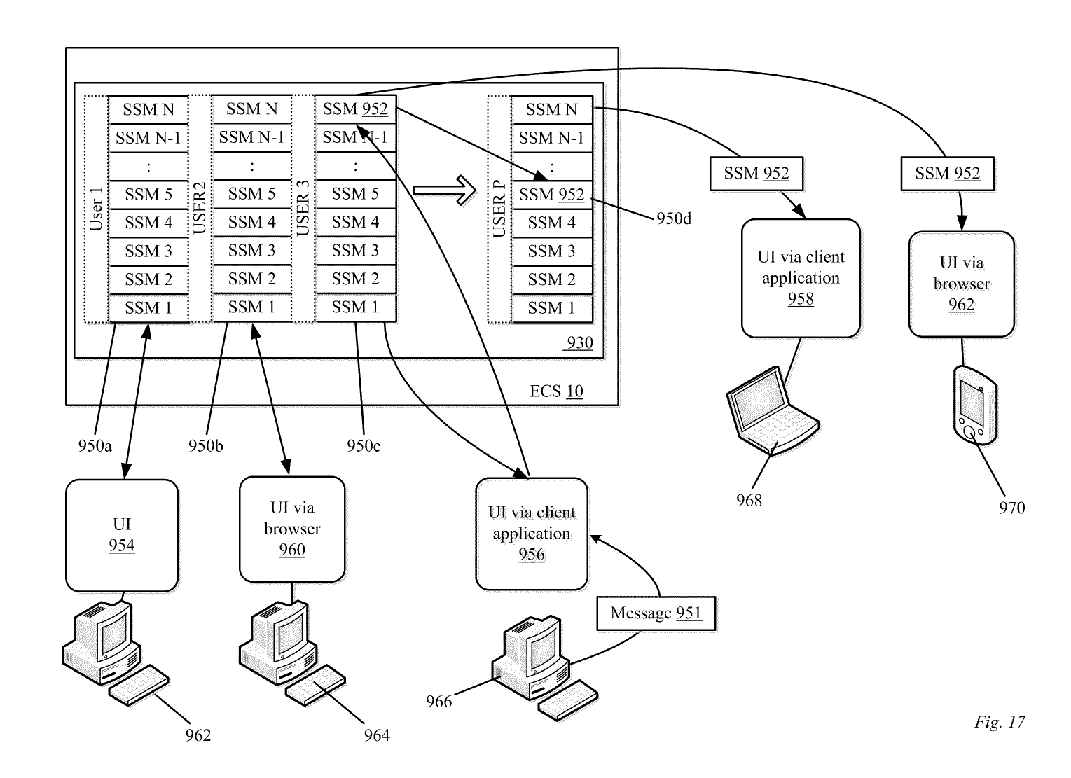

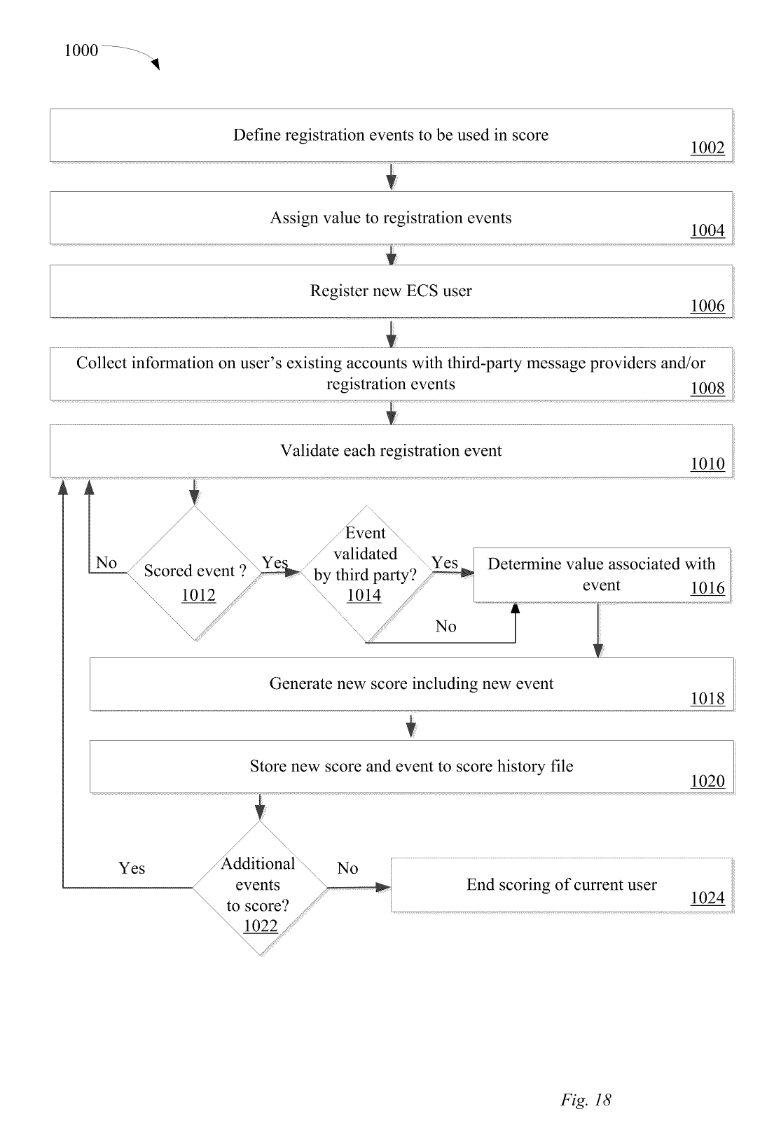

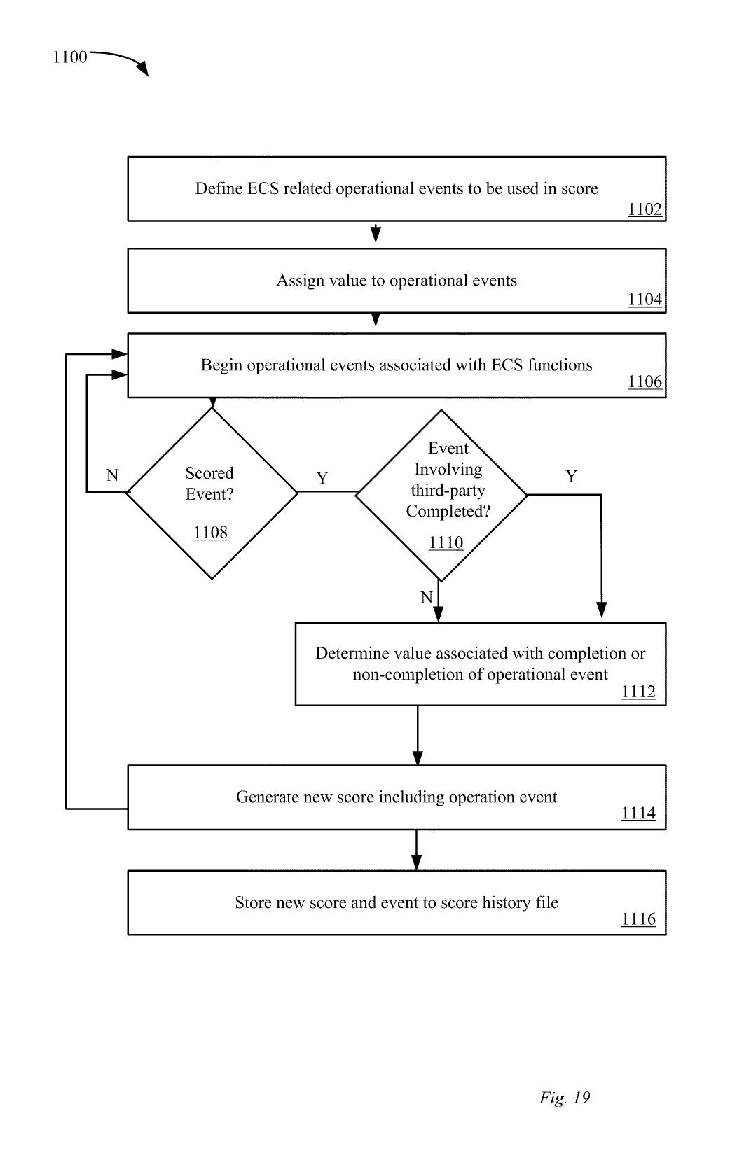

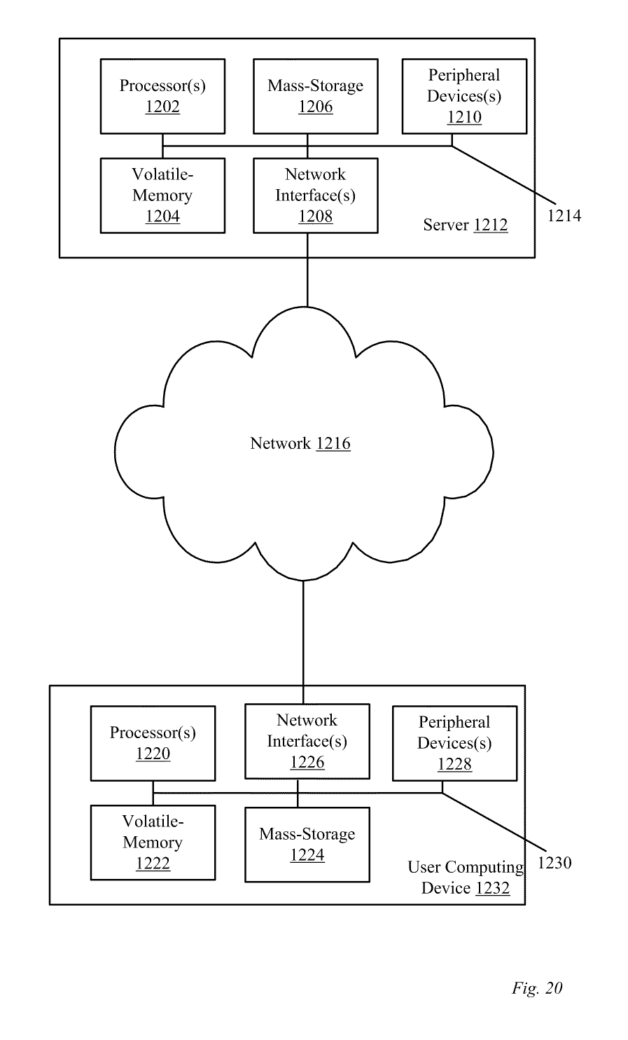

With respect to FIGS. 1-20, an electronic clearinghouse system (ECS) is described. In particular embodiments, the ECS can include a financial document clearinghouse and secure delivery network for securely delivering, retrieving, authenticating, storing, generating and distributing messages, such as financial documents and/or records are described. In particular, with respect to FIGS. 1 and 2, the current status of data management and some potential advantages afforded by an ECS are described. Overviews of some of the functions that can be performed by the ECS are described with respect to FIG. 3. With respect to FIGS. 4-9 block diagrams of devices associated with the ECS 10 and external devices including some internal components of the devices are discussed. Further, some potential interactions between the ECS and the external devices are illustrated. With respect to FIGS. 10-12, interaction diagrams involving registration processes at the ECS are described. Processes involving message retrieval, payments and assembling data packages are discussed in the context of interactions diagrams shown in FIGS. 13-15. In the section, “Data Delivery and Retrieval from a Bank,” further details of the message delivery process implanted at the ECS are described with respect to FIGS. 16-17. In the section, “Business Relationship Derived Metrics,” metrics that can be derived from business relationship data collected at the ECS are described. In particular, the generation of a user validation score is discussed in more detail with respect to FIGS. 18 and 19. Finally, with respect to FIG. 20, block diagrams of a server and a user computing device that can be used are discussed. Next, with respect to FIG. 1, an example of data delivery and data filing for a user not associated with the ECS is described.

FIG. 1 shows a block diagram of a user receiving messages from a number of different message providers. During their adult life an individual 2 can form, maintain and change numerous business relationships. The business relationships can be formed with various message providers where a message provider can consist of a single individual, such as 5, or a business including many individuals, such as 6. In the course of their business relationships, the individual can receives messages from each of the message providers. The messages from each message provider can include information, such as but not limited to invoices, receipts, warranties, privacy statements and account information.

The messages can be delivered to individuals by many different modes of communication 4. For instance, a message can be delivered in person, such as a receipt handed to an individual at a point of sales terminal, via traditional mail, in a text message, in an e-mail or as a message left on a recording device associated with a phone. Further, the messages can be received in many different formats. The format used to deliver a message can vary depending upon the location where it is delivered, the mode of communication used to deliver the message and the information contained in the message. Typically, the individual has little or no input in regards to the format in which the message will be delivered or the mode of communication that is used for the delivery.

Typically, the individual desires to maintain and consolidate the information and messages associated with their various business relationships. Towards this end, the individual 2 may perform some form of message processing 8. The message processing 8 can involve sorting the messages, placing the messages they wish to save in some place for storage for later retrieval and disposing of messages that they do not wish keep. The storage, retrieval and disposal of the messages can involve some individually implemented system. For instance, system 9 includes a computer, a box and a trash can. Using system 9, the individual can store and delete electronic messages on their computer, save paper messages to the box and throw away unwanted paper messages to the trash.

### Electronic Clearinghouse System

The heterogeneous manner and form in which messages associated with business relationships can be delivered and formatted can make processing, storing and retrieving of the messages difficult and time consuming for an individual. In some instance, these messages can include electronic documents. FIG. 2 shows a block diagram of an Electronic Clearinghouse System (ECS) 10 that can be configured to simplify the processing, storing and retrieving of the messages for the individual. The ECS 10 can provide a focal point where an individual can maintain, store, consolidate, view and manipulate the messages resulting from the various business relationships. Further, the ECS can provide a common interface with tools for working with their information included in their message, such as financial data. The common interface can be designed to be intuitive and simple to use for the individual.

In particular embodiments, the ECS 10 can provide tools for automatically retrieving information associated with an individual's business relationships. The information associated with an individual's business relationships can be generated by a “message provider” with whom the individual has such a relationship. Typically, the message provider can be an independent third party which can verify and can maintain business relationship information, separately and independently from the ECS 10. However, each message provider may cooperate with the ECS 10 in its information retrieval processes.

The information the ECS 10 receives/retrieves from a message provider, such as from one or more of the message providers 14, can be transformed in some manner by the ECS 10 and then delivered into an individual's account at the ECS 10 as a Secure and Structured Message (SSM). As described in more detail below, one or more electronic vaults can be associated with each account at ECS. In an electronic vault, files can be stored in an encrypted format using some type of encryption schema. The encryption schema that is employed can vary from file to file and from vault to vault. Each SSM that is delivered into an ECS account can be stored in the one or more electronic vaults associated with the ECS account.

The SSMs can be delivered in an electronic format and can include financial data or other data associated with the business relationship. Typically, the message providers 14 will not provide information in the final format of an SSM. Thus, one aspect of the ECS 10, which is described in more detail below, is to generate SSMs from information received from the message providers.

For the individual 2, a value proposition of the ECS 10 is that it provides an infrastructure and tools that greatly simplifies the process of obtaining, consolidating, maintaining and manipulating the information associated with their business relationships. For message providers 14, a value proposition is that the automatic retrieval and delivery of messages into an individual's account provided by the ECS 10 greatly reduces the costs and logistics, while increasing security with getting information associated with the business relationship to the individual with greater certainty. For instance, electronic retrieval and delivery of a message can be much less than the cost of mailing a paper statement.

The financial services industry (e.g., banks, credit card companies, lenders, insurance companies, securities firms, etc.) and other businesses which provide regular statements to their customers (e.g., cellular, telecommunication, utility companies) are one class of message providers 14 that may utilize and benefit from the functions provided by the ECS 10. For instance, the financial services industry may utilize the ECS 10 functions to have statements delivered to their customers. Employers are another class of message providers 14 that may utilize and benefit from the functions provided by the ECS 10 to manage their employee relations. For instance, employers may utilize the ECS 10 to deliver payroll records, W-2's notices, and forms, benefit information, etc. to their employees. Healthcare providers are another class of message providers that may utilize and benefit from the functions provided by the ECS 10. Health care providers may utilize the ECS to deliver healthcare information including individual medical histories as well as personalized educational medical information that can be of benefit to the individual 2.

One function of the ECS 10 is to provide the infrastructure for secure retrieval and delivery of secure and structured messages, i.e., SSMs, into the ECS 10 for each of the business relationships specified by the individual. The ECS 10 can use both private and existing public network infrastructure with the addition of enhanced security features to provide secure message delivery and maintain data privacy. The common interface 12 provided with the ECS 10 is designed to make using the enhanced security features as transparent as possible to user's of the ECS.

Architecture for the ECS 10 is described below where the ECS 10 can include a clearinghouse function, such an FDC (Financial Document Clearinghouse), and a secure data transfer function, such as a SDN (Secure Delivery Network). The functions attributed to the FDC and SDN are provided as an abstraction of ECS 10 for the purposes of illustrations only. Thus, in different embodiments, the functions described and their distribution between the FDC and SDN can differ. Further, ECS 10 can be abstracted with different combinations of functions.

Another function of the ECS 10 is the capture of data characterizing the business relationships maintained at the ECS 10. These data characterizations can be leveraged to organize the individual data in a way that is easy to search and navigate. The ECS 10 can generate portals and conduits that allow information associated with business relationships to flow into and out of the ECS 10. The information flowing through the portals and conduits can be monitored and captured. The captured information can used to derive metrics 16 that are valuable to individuals and message providers alike. More details of the possible functions of the ECS 10 for different embodiments are discussed with respect with to FIG. 3 as follows.

### Sample ECS Functions

FIG. 3 shows a block diagram of functions that can be associated with an electronic clearinghouse system 10 in accordance with the described embodiments. Users of the ECS 10 can be provided with accounts at the ECS. The ECS account can be separate from accounts maintained for the user by outside entities, such as a bank. At a minimum, a user account is accessible via a username and password configuration. Although additional levels of verification for account access, such as biometric verification, can be used.

In particular embodiments, an account can be associated with one or more persons. Further, an account can be associated with a legal entity, such as an incorporated business. Users that are also organizations (such as businesses) can have a set of login accounts, one for each desired member of the organization. Each login account can have a set of access privileges granting or restricting access to the various financial accounts the organization has set up the service to manage. In another example, a user account can be shared by two or more associated individuals, such as a husband and wife. This account can also have separate login identities and access privileges granting or restricting access to various financial accounts. In yet another example, an account manager might be provided with an account from which multiple user accounts associated with different individuals can be managed. For instance, a financial manager might manage multiple accounts for their clients.

Further message providers that use the ECS 10 to deliver their messages can also be provided with accounts. Via their accounts and associated interfaces, the system can be configured with capabilities that allow the message providers to change the way their delivery service to their clients is implemented. Further, the message providers may be able to generate custom reports of recipient user activity for a particular message recipient or group of message recipients during a specified period of time, showing when the recipient(s) downloaded and/or received and or viewed their messages.

In 20, the ECS 10 can be configured to store to a memory a pre-delivery agreement defining one or more delivery options for delivering messages from a message provider to one or more users of the ECS 10. For instance, the messages delivered by the ECS 10 can include different information, such as statements, invoices, payroll data and notices. Different message providers can enter into unique pre-delivery agreements with the ECS to deliver their messages. The pre-delivery agreements may comprise a description of parameters related to (1) what messages including message contents that are to be delivered, (2) which clients of the message provider are eligible for delivery, (3) whether notification of delivery is to be sent back to the message provider after delivery or upon viewing of a message, (4) how much is to be charged for delivery of each message, (5) whether advertising is to be included with the messages, (6) a message format, (7) whether an electronic document is to be automatically generated or not with the message, (8) whether the client of the message provider is to be charged for each delivery of a message or the message provider is to be charged and combinations thereof. The pre-delivery agreement can be generated when message provider signs up to use the ECS 10.

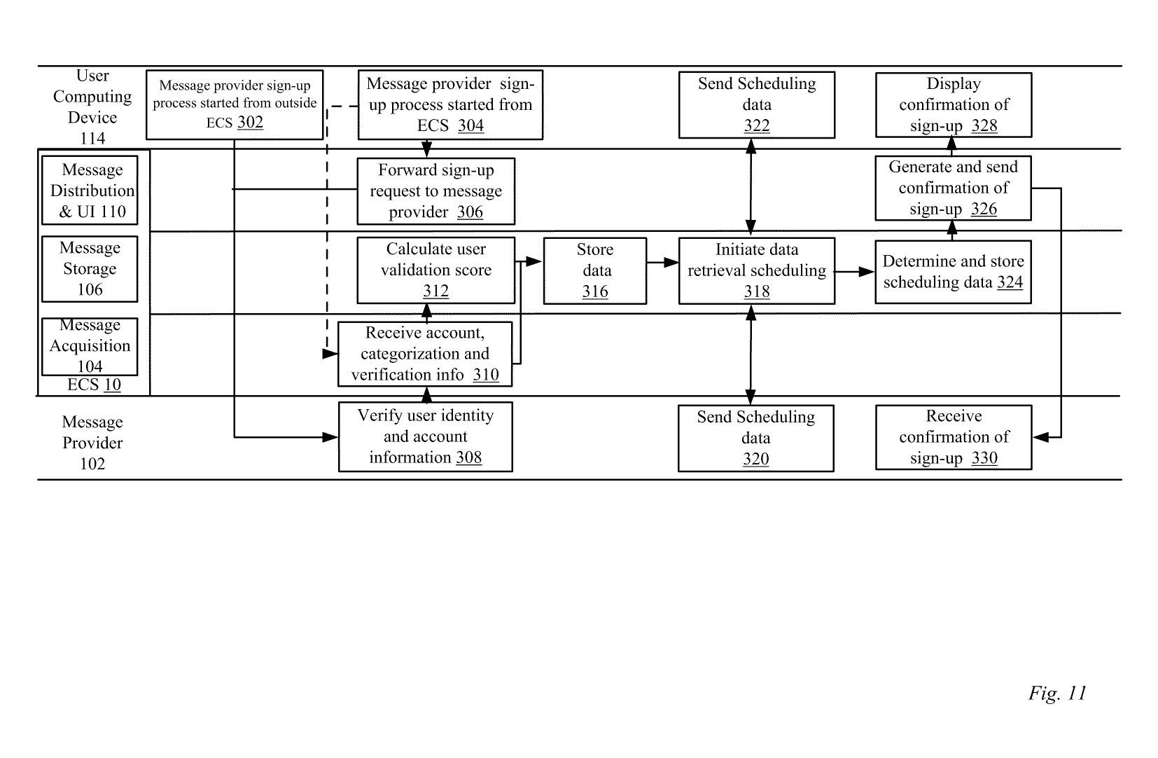

As is described in more detail below (e.g., see FIG. 11), a user with an account in the ECS 10 can add different message providers to their account. When a message provider is added to their account, a delivery agreement can be established between the ECS 10, the user and the message provider that allows messages from the message provider to be delivered into the user's account at the ECS 10. The delivery can involve the ECS retrieving the message from the message provider. The delivery agreement can be based upon parameters described in the pre-delivery agreement between the ECS 10 and the message provider and delivery options selected by the user that owns the account. Because users selecting delivery from the same message provider can select individual delivery options, the delivery agreement between a first user, the message provider and the ECS 10 can be different or the same as the delivery agreement between a second user, the message provider and the ECS 10.

In 22, a secure delivery network can be configured to securely transfer and distribute messages. For security purposes, the messages can be both stored and transferred between various devices using strong authentication and encryption. For instance, the SDN may allow secure transfer of messages between the devices controlled by various message providers, devices controlled by users of the ECS 10 including home computers and mobile devices and devices controlled by the ECS 10. The SDN may provide the users the capability to send confidential documents to other users in a secure manner. Further, the SDN may include built-in, public key encryption technology that can be applied to messages on the fly when users send messages to other users. In one embodiment, when a file is in transit via the SDN or when a file is stored to electronic vault after delivery via the SDN, the file can be kept in an encrypted format. Further, system configuration information that enables the delivery and the storage of the file as wells as a subsequent decryption of the file can be stored in encrypted databases and/or encrypted configuration files.

Further, the SDN may include a secure, closed-loop environment for the sharing of information and documents within various social networks. The social networks may exist outside of the ECS. However, the ECS can provide tools that allow social networks to be established within the ECS. The social networks within the ECS may be created by ECS users and subscribed to and/or joined by other users. In one embodiment, the ECS can be used to create a shared electronic vault that can be subscribed to by other users of the ECS.

In another embodiment, the system can be configured to allow ECS users to send invitations to one or more other users, such as an invitation to send data to one another in a secure manner. The invitation may specify parameters that enable the data transfer including 1) information about the inviter, such as profile information and a user validation score, and a specified level of security expected by the inviter for the transaction. If the invitee accepts the invitation, then the agreement between the ECS users can be stored. Then, data transfers can occur between the ECS users according to the parameters in the established agreement.

In 24, a user interface can be provided. Via the interface, users can retrieve and organize all their messages, financial documents and/or records. In particular, the interface may be configured to allow searching for particular documents. Additionally, the system can be configured to notify the user when new messages are available so the user need not check repeatedly to determine whether such is the case. In addition, the system can be configured to establish the receipt of electronically delivered financial documents of interest in a verifiable fashion. In one embodiment, the notification can occur via an e-mail, text message, voice message or other useful method of notification. If the user has hard copies of documents, such as financial documents and/or records for which there is no electronic copy, the system via the user interface can be configured to allow the user to scan and import these financial documents and/or records for storage in an electronic format. In particular embodiments, the system can be compatible with an external scanning feature or the system can provide a scanning feature.

In particular embodiments, files stored to an ECS user's electronic vault can be named, categorized and stored in a private hierarchical file system. In one embodiment, the private hierarchical file system may be contained within the non-private hierarchical file system of user's computing device or within the non-private file hierarchical system associated with the ECS 10 that stores data for users (non-private in the sense administrators can navigate through the non-private hierarchical file system of the ECS 10). However, the structure of the user's private hierarchical file system including file name and file associations may be encrypted such that it is not visible within the non-private file systems. For instance, in one embodiment, the structure of the user's private hierarchical file system may not even be visible to administrators of ECS 10. After the ECS user provides authentication information and is properly authenticated, then via the user interface, the user may be able to view and modify their private hierarchical file system. After modification, the configuration information associated with the user's private hierarchical file system can be securely stored in an encrypted format.

In 26, for safety of the user's data, a reliable, off-site backup system can be provided. This backup system can be configured to maintain redundant copies of user messages, such as messages including financial document and/or record data stored within the primary system. In one embodiment, the primary system includes several segregated, redundant servers with redundant means of connectivity, to ensure the user's data is always available. For instance, system databases can redundantly backed-up at one or more data centers.

In particular embodiment, a user's data can be stored only at the ECS 10 or via a client application can be stored on a user controlled device, such as a home computer. For instance, via the client application, a user can maintain one or more electronic vaults for storing data on a device of their choosing. When one or more electronic vaults are maintained on user controlled device, the ECS in conjunction with the client application executed on the user controlled device can maintain a back-up copy of the one or more electronic vaults on the user-controlled device. In one embodiment, the ECS 10 can be configured to sync one or more electronic vaults on the user controlled device with one or more vaults maintained at the ECS 10. Further, as described in the previous paragraph, the ECS 10 can be configured to maintain multiple redundant copies of the one or more synced electronic synced vaults with the ECS 10.

In particular embodiments, the client application can be compatible with third-party applications. For instance, a client application might be able to retrieve a secure message from a user's vault and then provide it to another application, such as Microsoft Outlook™. The secure message provided to outlook might be in an encrypted format. The third-party application, such as, Outlook™ may be configurable to communicate with the client application to allow the message to be decrypted and displayed to the user in Outlook™. The client application may include a well-defined Application Program Interface that enables such interactions with third-party applications.

In another embodiment, third-party applications can configured with a “button,” that allows data or files to be directly imported into the ECS system. For instance, next to the print and save icons in any application programs, such as web-browsers, document viewers (e.g., Adobe Reader™), word processors (e.g., Microsoft Word™), e-mail programs (Microsoft Outlook™ and Google Gmail™), etc., a “vault” button can be provided. The vault icon might include an image of a vault. When the vault button is selected, the document can be imported into ECS users electronic vault. For instance, a web-page showing an Internet purchase, a personal e-mail or a Word document can be imported into an electronic vault.

When the vault button is selected, an interface can be displayed that allows the user to select an electronic vault for the captured information or the selected file, such as a “personal” vault or “family” vault, enter categorization information for the captured information, such as “purchase receipt,” specify a file name, etc. The selected categorization information can affect how the file or captured information is placed in the ECS user's private hierarchical file system. In one embodiment, the captured information or selected file can be processed as if it were being output via a print driver where the print is to an encrypted file compatible with the ECS 10. In another embodiment, the native format of the selected file can be preserved like a “save as” including a password. Thus, for instance, a Microsoft word file can be saved in its native format but encrypted and stored within the ECS 10. To later work with the word file, an ECS user would decrypt the file via an ECS provided application and then invoke the Microsoft Word program to further process the program. Then, the ECS user could again save the file using the “vault” button. An advantage of this approach is that the user would not have to learn the intricacies of every third-party application that they utilize to store files in a secure manner.

In 28, the ECS 10 can provide applications related to generation of metrics, such as a user validation score. Based on data collected at the ECS 10, metrics about an individual can be derived from captured information characterizing an individual's business relationships. One type of metric can be referred to as a User Validation Score (UVS). When an individual maintains a business relationship with a message provider, such as a bank or utility, certain parameters, such as a user's identity, length of the relationship, number of transactions associated with the relationship can be captured as transactions are carried out using the ECS 10. The captured information for a number of transactions can be used to measure and quantify the user's relationship with the message provider and thereby derive a metric of that characterizes the relationship. In one embodiment, the ECS 10 can present the metric as a score. For instance, a user with more established business relationships maintained over a longer period of time may be given a higher score than a user with less established business relationships maintained over a shorter period of time.

One type of score for a user can be related to the actual verification of a preexisting relationship between that user and a message provider. As an example, a user might provide identification information, such as a user name or account number and an associated password, for an account maintained outside of the ECS by the message provider. The ECS can then send this information to the message provider for verification purposes. For instance, the message provider can determine that the account number/user name and password are valid. Further, as part of the verification process, the message provider can request additional confirmation from the user that their intention is to sign up for the ECS services. The confirmation request can be sent via a communication channel previously established between the user and the message provider, such as via a phone message or an e-mail. The response to the confirmation might include answers to security questions previously provided to the message provider by the user. In one embodiment, the message provider can send to the ECS 10 the additional information needed to perform this confirmation, such as answers to security questions or information regarding the communication channels previously established between the user and the message provider and the ECS can generate, send and respond to confirmation messages sent from the ECS to the user.

The verification of such a relationship can be valuable as the message provider can be an independent third-party who is verifying its ongoing business relationship with the user and then reporting information characterizing the ongoing business relations to the ECS 10. The fact that the information is verified by a third-party message provider can be used to assign a significant weight or value to the validation of that message provider-user relationship. As an example, when a number of message providers confirm the identity of a particular user, a score can be generated that may provide an indication to another party, such as another at the ECS 10, that the user is the person that they claim to be. A scale including a range can be provided with the score to help interpret the score. For instance, score ranges can be identified on a scale where a user with a score in one of the ranges is more likely to posses their claimed identity than a user with a score in the one of the other ranges.

In 30, the ECS 10 can provide privacy management tools. In one embodiment, the privacy management tools can include a centralized privacy notification and settings management service to allow users to easily determine their preferred privacy settings for the message providers with which they do business, rather than deal with this function manually or take no action and remain with the provider's default privacy settings. This service can be configured to: (1) educate users in a friendly, simple fashion on basic privacy options for different businesses including web-sites, such as Facebook™ and Linked-in™, (2) allow each user to establish his or her privacy preferences, and (3) then automatically prepare responses, electronically or on paper, to each provider with the customer's desired selections. For instance, the ECS 10 can be configured to prompt a user for answers to a series of questions related to privacy management where the answers to the questions can be used to establish the specific privacy preferences for the user.

Further, the privacy management tools at the ECS can be configured to allow a user to select from privacy policies with different levels of privacy and apply settings for the selected privacy policy across their message providers. In one embodiment, the service can compare the user's established privacy policy settings to list of popular web-sites that the user may visit and then notify the user as to suggested privacy settings available on such web-sites that the user could then make in order to bring his/her use of those web-sites into compliance with the user's current privacy policy. In another embodiment, the tools can be configured to check a user's current privacy settings on web-sites that the user visits, compare the users privacy settings to a selected privacy policy, notify the user when a web-site is not in compliance with their current privacy policy and make suggestions if available for setting changes that can bring the web-site into compliance with their current privacy policy.

In 32, the ECS 10 can provide various financial management tools that may be accessible via the user interface. For instance, for purposes of scheduling, the system can be configured to provide a calendar system. The calendar system can be configured to allow a user to see and schedule relevant events, such as but not limited to the availability date of financial documents and/or records, bill due dates, intended payment dates, actual payment dates and account totals after particular events occur. For some embodiments, when a message received at the ECS 10 includes financial data that is associated with a time period, such as a bill due date, the system can be configured to automatically populate the calendar system and create a notification schedule for the user associated with the financial data. For instance, the notification schedule can involve an initial notification and one or more subsequent notifications.

In yet another embodiment, the system can provide an interface and one or more utilities that enable users to easily organize their past financial documents and/or records according to time, source, type, subject, etc. Further, the system can be configured to allow users to select or create a naming convention for files associated with their financial data and to sort, filter and search their past financial documents and/or records according to a set of arbitrary criteria, such as keywords, categories, dates and amounts as well as parameters associated with the naming convention. Further, the system can be configured with user selectable parameters for generating custom reports from past financial documents and/or records. To generate the customized reports, the system can be configured to filter, extract and aggregate data from various financial data sources, such as financial data associated with number of different financial documents. If desired after the user generates a custom report, since the document is only produced electronically, it can be simple to dispose of the document in a fully secure fashion without the difficulties attendant upon disposal of paper documents. On the other hand, if the custom report is of interest, it can also be saved and later printed if desired.

Further, in 32, for convenience of paying bills, the system can be configured with a mechanism for electronic payment, both specifically user-initiated and automatic, at the choice of the user. This bill payment system can integrate with the user's monetary accounts with various institutions, and draw directly upon accounts designated by the user to make payments on specified invoices or bills. The system can capture, retrieve from a third party and/or store evidence of payment, and associate it with the bill being paid for later reference. For instance, a document containing an acknowledgement that the payment has been received from an outside source can be linked to a document including the invoice for which the payment was made. Further, when a bill, such as a credit card allows for a variable payment, the system can include a specially designed algorithm to suggest optimum payments to the user, based on the user's income, assets, expenses, amounts due, interest rates, other preferences, etc.

In addition, the system can be configured to initiate and track transfers of money between accounts, whether owned by the user or not—that is, the user can transfer money from any of the user's accounts to any other account. These transfers can be tracked to the degree that the user has information regarding the state of the originating and receiving accounts, and the account debit and credit are recorded as events within the system, along with their dates, for later reference.

In 34, for message providers that utilize the ECS 10, the system can be configured to generate documents and/or records in standardized, templated formats using structured or raw data received from the message provider. For instance, after the ECS 10 receives transaction data associated with a bank account for a user via an outside interface provided by the bank, the ECS 10 can be configured to generate a bank statement. In some embodiments, a message provider may specify a particular format in which its data is to be displayed. For instance, a message provider may be legally obligated to display certain types of data to its clients. In other embodiments, some flexibility may be available. For instance, users may be able to select the format in which they wish to see the data, which may or may not include the legally obligated data as long as the legally obligated data is available for viewing if desired by the user.

In 36, for the purposes of data organization, the ECS 10 can be configured to store messages and their associated content, such as files including financial documents and/or records in both their original form (e.g., as PDF or another electronic duplication format) and as structured, parseable data. In addition, the system can be configured to associate metadata with the financial documents and structured data. The metadata can be used to organize the messages and their associated content, such as when the data is viewed in the user interface. In one embodiment, the metadata can be used for categorization purposes. For verification/authentication purposes, electronic signatures can be generated for messages. The metadata can associated with a file can affect an electronic signature that is generated for message.

In another embodiment, the metadata can be used to create links between various messages and documents. For instance, a credit card statement can be linked to a receipt stored in the ECS 10 via the meta data. In one embodiment, the structured data can be linked directly to the associated original financial documents and/or records (in PDF or other format), and/or portions thereof, so the original entries can be found quickly and subsequently manipulated. In addition, the system can be configured to import other documents, such as receipts, warranties, etc, where metadata is associated with these documents as well. In one embodiment, a document, such as receipt or warranty, can be included with another document as part of its metadata. A first document attached as metadata to a second document may or may not be stored as a separate document with its own metadata.

Via the metadata or some other method, the imported documents can be linked with specific portions of financial documents and/or records (e.g., particular entries). For instance, a receipt can be linked to a particular debit transaction associated with a bank statement or a particular transaction associated with a credit card statement. These links may allow a user, via a provided interface, to select a transaction displayed on the financial document, such as a credit card statement and in response, have a receipt associated with the transaction displayed. As another example, the user can select a document, such as a document containing a receipt for a product that was purchased, and in response have displayed a financial document showing a transaction associated with the receipt and/or warranty information associated with the purchase. In general, a document or a location within a document can be linked to one or more other documents or locations within the documents.

In 38, relationship management tools can be provided that allow a user to form relationships with other users and message providers at the ECS 10. The relationship management tools may allow a user to generate a profile that is visible to other users and message providers at the ECS 10. Further, the relationship management tools may allow a user to enter into a relationship with one or more other users or message providers at the ECS 10. The relationship may allow the participants in the relationship to access certain types of data. For instance, an established relationship between two users may allow both users to see their full profile at the ECS 10. As another example, an established relationship may allow two or more users to share certain types of data or documents. For instance, files can be placed in a location associated with a family relationship between two or more users that allows all the users in the family to place documents in the shared location and view documents in the shared location. Via the relationship management tools, a user may be able to add and to terminate relationships. Further, the tools may allow temporary relationships to be formed, i.e., ones that expire after a certain time period. A temporary relationship might be useful if a user wished to share information with another entity for a limited time period.

In 40, the system 10 can be configured to allow targeted advertisements to be delivered within messages received at the ECS 10, within documents created at the ECS 10 and within the interfaces provided by the ECS 10. In one embodiment, the advertising can be targeted according to information associated with the business relationships the user maintains via the ECS 10. In one embodiment, if a message provider pays for the delivery of its messages, then the message provider can be allowed to solely control what advertisements appear with its messages and the documents created from its data. In another embodiment, messages from a message provider can be delivered for free or at a reduced cost. In this case, the message provider may have some say in the type of advertisements that are allowed to appear when its messages are displayed but actual selection of the advertisements may be performed by the ECS 10. In various embodiments, individual advertisements to display on a user computing device can be selected based on a set of criteria defined by the message provider, the ECS 10, the user or combinations thereof.

In one embodiment, the system can be configured to allow message providers to deliver “coupons” to ECS users. These coupons can be transfer to handheld devices and used at points of sale. The ECS 10 can be configured to validate the coupon when it is presented for use at a point of sale.

In 42, for added security, an encrypted and centralized password storage system, accessible only to the user, can be provided. When authorized, the system can access one or more of the user's accounts with message providers via the user's stored password data. For instance, the stored password data may be presented to a message provider to verify that the ECS 10 is allowed to access a particular user's information via an external interface provided by the message provider. In one embodiment, the encrypted password store can be transferrable to other devices, such as laptops, smart phones and other mobile devices.

In one embodiment, the password storage service is configured to assist the user in generating a secure and memorable password for access to the system. Further, the password management service can be configured to select highly secure passwords for all of the user's accounts, thus increasing resistance to compromise and/or attack. This relieves the user of the burden of remembering or securely storing the myriad usernames and passwords associated with the user's accounts, as all are stored within the centralized password management service and the user has a reduced need to directly access his or her other accounts on a regular basis. Instead, the user need only remember a single username and password—those for the ECS 10. When a user does need direct access to a particular outside account at a message provider, the system can be queried and a needed password that is stored can be retrieved. In one embodiment, the passwords can be stored to an electronic vault maintained on the user's computing device and/or at the ECS 10. In particular embodiments, access to change or see passwords stored in the vault might require multi-factor authentication, such as requiring the user to answer multiple security questions as well as providing the correct single user name and password. Further, the user's accounts refer to accounts maintained outside of the ECS by third-parties, such as but not limited to the message providers previously described.

In 44, applications that allow business relationship metrics to be derived can be provided. Information about business relationships maintained at the ECS 10 can be derived from the message provider data provided by each user. A delivery agreement between the message provider, the user and the ECS 10 is an indication of a business relationship between the user and the message provider. The ECS 10 may regularly contact the outside interfaces associated with different message providers. This process can indicate that a relationship is on-going and provide some indication of the strength of the relationship, such as how long the relationship has been maintained. Termination of a message provider relationship may be indication of dissatisfaction with the message provider.

The message provider information can be used to derive metrics. For instance, message providers in a particular category, such as a banking category, can be ranked according to the number of users at the ECS 10 that use each message provider. This ranking metric can be categorized in different ways. For instance, the ranking metric can be performed on different sub-groups of users at the ECS 10, such as users within a particular geographic region, users within some age range or users with a particular business relationship, such as users of the bank that also have an American Express™ account. The ECS 10 can provide tools that allow different metrics to be constructed based upon the data collected at the ECS 10. In one embodiment, these tools may be available to only operators of the ECS 10. In another embodiment, a message provider may be provided with limited access to the data collected at the ECS 10. For instance, a message provider may be allowed to access data only for users that have registered the message provider as part of their account but not access data for users that have not registered the message provider with their account.

In 46, the ECS 10 can be configured to create authenticated electronic copies of the user's documents, such as copies of actual financial documents and/or records. Authentication methods can be used that allow the financial documents to be verified as true and correct copies, such that they are acceptable for record-keeping, tax and audit purposes. In one embodiment, an electronic signature that is difficult to forge can be embedded and/or appended to each financial document for authentication purposes.

In 48, the ECS 10 can provide document packaging tools. The document packaging tools may allow a user to gather a number of documents for delivery to another party. For instance, the document packaging tools may allow a user to assemble all of the information needed for a loan application and send it out to the lender. The assembled package can be saved at the ECS 10 and then later updated if the user applies for a loan in the future.

ECS Communications with Other Devices

FIG. 4 is a block diagram showing an electronic clearinghouse system 10 in communication with a number of devices. As shown in FIG. 4, the ECS 10 can include one or more instantiations each of applications related to message acquisition component 104, a message storage component 106, payment and transfer component 108 and a message distribution and user interface component 110. In various embodiments, the functions described including multiple instantiations of particular components can be combined on a single device or distributed between different devices. The one or more message acquisition components 104 can be configured to retrieve messages, such as but not limited to financial documents and/or records for the ECS users from one or more message provider devices 102. The devices, such as 102, can provide access to information, such as account information and/or records associated with various services via a communication network. The financial institution servers 108 can be used in a transaction, such as payment of a bill initiated from the ECS 10 using the payment and transfer component 112 as well as provide access to account information associated with the financial institution. Further, the ECS 10 can be configured to retrieve messages from the financial institution servers, such as messages including pre-formatted financial documents or messages including financial data that can be converted into a processed financial document at the ECS 10.

Via the communication network, the message providers 102 can transmit data, formatted documents and/or records, such as account statements and billing data, to the ECS via the one or more message acquisition devices 104 for processing and storage. The transmission can involve a “push” operation where the transmission is initiated at the message provider 102 and data is pushed to the ECS 10 or a “pull” operation where the transmission is initiated at the ECS 10 and data is pulled from the server 102 to the ECS 10. Additional details of these operations are described with respect to FIG. 16. From an ECS 10 user perspective, the data retrieved from the various message providers can be consolidated, securely stored and accessed via a common interface at the ECS 10.

The storage component 106 can be configured to perform functions, such as parsing, categorizing and storing messages received in an efficient, cross-referenced fashion for later access. The messages can be stored as a secure and structured message (SSM). Typically, the SSM can be stored in an encrypted format using encryption parameters that are associated with the user account to which it is delivered. The encryption parameters can also be specific to the particular message. For instance, two users of the ECS 10 can agree upon an encryption protocol using encryption parameters that allow a message with a particular set of data to be shared only among them. The encryption protocol and the encryption parameters that are employed may be unique to that message. The encryption protocol and the encryption parameters can be specified in an electronic delivery agreement established between the two users. Prior to viewing, the agreed upon encryption protocol and encryption parameters can be applied to allow the information contained in the message to be decoded for either of the users. The ECS 10 can be configured to store and keep track of the encryption parameters utilized.

Messages can be stored in an encrypted fashion for security purposes, using strong encryption that is infeasible to break. In one embodiment of the system, the user's data can be stored on one or more centralized servers, in an encrypted and isolated fashion. In one embodiment, only the server where the data is stored has direct access to the message store 106, and only authorized computers (e.g., another server or a computer used by the user) have indirect access to the data contained within the message store 106. In another embodiment, the user's data can be kept in an opaque, encrypted store on the computing device being used by the user, such as 114, which store can only be decrypted by the software application that created it. When the user eventually wishes to dispose of any portion of the stored data, the software application can be configured to provide a facility for the secure destruction of the data from all data stores, including backups if so desired, using methods of irretrievable data destruction.

In particular embodiments, the user may be able to identify specific entities that are allowed to hold decryption keys for the user. The holding may involve sending copies of needed decryption keys to the specified entities. As an example, the ECS 10 or an independent third-party can be sent needed encryption keys for all or a portion of the user's data. In another example, another user at the ECS 10 can be sent copies of the decryption keys needed to access all or a portion of the user's data.

The messages that are received, which can include financial data, can be delivered into electronic vaults associated with one or more specific user accounts maintained by the ECS 10. A user can use a Web browser or other software application, such as a custom software application designed specifically to interface with the system executing on the user's computing device 114, to access their SSMs stored in the user's account. Examples of user computing devices include but are not limited to a desktop computer, a laptop computer smart phone, PDA, cell phone, tablet computer or other portable computing device. As described with respect to FIG. 20, the various devices at the ECS 10, the message providers 102, the user computing devices and the servers 112 can each include processors, volatile memory, non-volatile storage and network interfaces for executing applications that perform their specified functions and allow the devices to communicate with one another.

If their SSMs are stored remotely, such as at the ECS 10, via an available network, users can access the SSMs and associated data in their user account to perform various functions such as organizing, listing, searching and displaying the stored messages and data. Account access typically may require at least username/password protocol. In addition, multi-factor authentication methods can be used. In some embodiments, multiple users may be provided access to a common account, such as a business account shared by a number of users. The users can each have separate usernames and passwords. The system can be configured to provide users of a shared account with different data access privileges. The data access privileges may allow the users to access all or a portion of the SSMs associated with an account. The privileges can be associated with different usernames and passwords.

When a user requests to access an SSM, the user can be first authenticated. This authentication can be performed using one or more of a number of methods, including, but not limited to, simple username and password entry; two-factor authentication, wherein the user provides something known to the user (such as a password) and something possessed by the user (such as a security token); biometric authentication, as using a fingerprint reader; and Trusted Platform Modules. An authenticated user can be provided with a particular access level for stored data—i.e., the user can be allowed access to certain segments of data with a certain level of security, but also has access to data of a lower security level for that user. Thus, users can access their own data, but not system data or the data of other users.

Similar access can be provided to message providers 102. For instance, an account can be provided at the ECS 10 that allows a financial data provider to access some information about their clients that have accounts with the ECS 10. Their access can be limited to only their clients and not the clients of other message providers. In other embodiments, a particular message provider can be provided with access to a limited set of information related to non-clients that have accounts at the ECS 10.

The user's request for an SSM may be fulfilled only if the user successfully authenticates and is requesting access to data within his or her access level. In one embodiment of the system, the SSM can be transferred in an encrypted fashion to the computer being used by the user, such as 114, where it is decrypted and displayed to the user. At the user's computer device, the message data can be simply read by the software application in an encrypted fashion, decrypted and displayed to the user.

To track activity of recipients of messages, message providers 102 can enroll to receive confirmation when their SSMs are delivered to and/or viewed by their recipients, such as the recipients at the various user computing devices 114. When the recipient downloads and views a particular SSM, information regarding this event can be reported to the ECS 10 and a message provider either directly or via the ECS 10. The message provider 102 can view/receive information regarding delivery of their message to their targeted recipients using any of a number of methods, including, but not limited to, in a Web interface, email or inclusion in custom reports.

The moment when a recipient has viewed a message can be established by any of a number of methods, including, but not limited to, recording when the recipient opens the message (a less reliable method because the recipient has not necessarily viewed the document), recording the recipient's act of scrolling through the message, and asking the recipient to confirm or certify that the recipient has viewed the message in full. The ECS 10 can be configured to provide message providers, such as message providers with delivery agreements with the ECS 10 custom reports of recipient user activity for a particular recipient or group of recipients during a specified period of time. For instance, the reports can indicate when the recipient(s) downloaded and viewed their financial documents and/or records, and if and when payment was sent via the clearinghouse for any bills delivered.

In particular embodiments, SSMs, which can include documents containing financial data, can be retrieved from a number of different types of accounts supported by different types of message providers 102. The message providers can support accounts such as but not limited to bank accounts; credit accounts, such as credit cards and other loans; stock accounts; bond accounts; retirement accounts; utilities accounts; phone service accounts; accounts with financial institutions; mortgage accounts; accounts with finance companies; retail accounts; accounts with petroleum companies; health care accounts, and accounts associated with employer benefits and employee information. In one embodiment, the messages associated with each account that are retrieved can include preformatted financial documents, such as account statements, invoices, bills and other demands for payment, receipts, payment confirmations, insurance statements, online transaction records, and pay stubs.

In other embodiments, messages can be include raw electronic transaction data. The ECS 10 can be configured to process the raw electronic data. For instance, after receiving the raw electronic data, the ECS 10 can be configured to format the raw electronic transaction data into a document, such as a statement summarizing the account activity associated with the transactional data as well as a listing of the transactions. As an example, bank transaction data that is retrieved can be formatted into a bank statement similar to what is usually printed out and mailed to the account holder.

Other examples of transactions that can be tracked, stored and formatted into documents include, but are not limited to, account debits; account credits; withdrawals, automatic or executed by the user; deposits, automatic or executed by the user, such as direct payroll, benefit, unemployment, social security, disability and retirement deposits; purchases; payments, such as credit card, utilities, phone service, insurance, mortgage and car payments; loans; disbursements; transfers; and checks written and/or cleared. In one embodiment, transaction data from multiple sources, such as a number of different service providers, can be consolidated into a single document by the ECS 10. For instance, transactions associated with a user's home services, such as utility, phone, garbage and water can be consolidated into a single statement document. The formatted documents that are generated can be viewed by the user, categorized and filed at the ECS 10 using the encryption protocols and parameters associated with the user account and/or printed out by the user if desired.

In one embodiment, message providers may be able to specify advertisements to be delivered to their clients in the SSMs that are generated and delivered at the ECS 10. The advertisements can be in addition to other message data included in the SSM, such as statement data. When the messages are opened, the advertisements can be displayed in the client application's user interface or inline within financial documents and/or records generated by the system. The advertisements can be selected based on general data about the recipient as well as specific data found within the financial documents and/or records being delivered to the client.

In one embodiment, free system accounts can be provided to message providers, such as 102, that allow for SSM delivery from the message provider 102 to their clients. These accounts, however, may be subject to advertising that is controlled by the ECS 10 as opposed to the message providers. In yet other embodiments, the ECS 10 and message provider 102 may each specify a portion of the advertising. For instance, the message provider 102 may be able to specify a portion of the advertising in one portion of the SSM while the ECS 10 may be to specify a portion of the advertising in another portion of the SSM. In some embodiments, for paid accounts, the advertising may be removed and/or solely controlled by the holder of the paid account as an incentive to purchase a paid account. Thus, a holder of the paid account may be provided with the ability to control the advertising that is displayed or eliminate it at their discretion. In yet other embodiments, the ECS 10 may provide an option that lets message recipients opt out of receiving advertising in their SSMs.

The ECS 10 can be configured to retrieve messages and message data from a message provider, such as 102, in a number of different manners. For instance, the message data can be extracted from a message provider account web-site that allows an individual to see information about their message provider account and possibly view and/or download account data. In this embodiment, the ECS 10 using the user's account access can emulate the user logging into the account to retrieve data. In other embodiments, a message provider 102 can provide a less interactive interface that allows a user to pull raw data from a device. The ECS 10 can be configured to utilize this type of interface to retrieve messages for user. In yet another embodiment, a specialized or custom interface can be provided that allows the ECS 10 to pull data from the message provider 102.

In one embodiment, the ECS 10 can be configured to enable monetary transactions involving a transfer of funds. For instance, in one embodiment, to pay a bill or transfer money, the user can use their computing device 114 to request the payment or transfer via the payment and transfer component 108. The ECS 10 can authenticate the request and forward it to a payment and transfer component, such as 108. The payment and transfer component 108 can in turn request that the financial institution server 112 make the requested payment to the specified party or transfer the requested sum to the specified account. If a user has an account associated with a financial institution, the financial institution server does not have to necessarily be associated with the financial institution that provides the user's account. For instance, the financial institution server can be associated with a third-party that performs debit processing independently of the financial institution that maintains the account.

The financial institution server can execute the payment or transfer, and the payment and transfer component 108 or another component at the ECS 10 can then capture any resulting evidence that the transfer was executed. In one embodiment, the ECS 10 can be configured to enable transactions at a point of sale. For instance, transaction at a point of sale can be enabled via a mobile computing device in communication with ECS 10.

If the user initiates a financial transaction, such as a payment, the ECS 10 and/or software executing on the users device, such as 114, can be configured to verify that it has not been initiated by an unauthorized party posing as the user. In one embodiment, verification can include but not is limited to, sending a code to the user via SMS, email or phone call, and requiring the user to enter it before proceeding; requiring the user to enter a code from a security token before proceeding or other such advanced security measures as may come into use. In addition, the user can be required to answer challenge questions or provide biometric identification that allows their identity to be authentically established.

Any attempt at security by authentication and other methods is potentially defeated by such agents as malware, which includes, but is not limited to, such software as computer viruses, Trojan horses, worms, rootkits, crimeware, scamware, spyware and malicious adware; poorly configured or non-existent network defenses, such as a firewall; and unpatched software bugs or design problems resulting in vulnerabilities. To counteract this, the software applications that are executed at the ECS 10 or on the user computing device 114 can include algorithms for detection of vulnerability to attack or compromise from any of such sources, by methods including, but not limited to, detection of the presence or absence of antivirus or anti-malware software, a properly configured firewall and unpatched or vulnerable software running on the computer or server. If any potential vulnerability is detected, the software application warns the user and suggests a remedy, such as installing the correct software or patches, or correctly configuring security settings, and may even deny access to the service until such potential vulnerabilities are effectively corrected.

In a particular embodiment, a scheduling and payment system for bills that integrates with a main scheduling system can be provided. This system can allow the user to schedule payments to go out from a specified account on a one-time or recurring basis for any bill belonging to the user. Any bills stored by the application can be automatically added to the schedule as to due date, and the system automatically calculates the maximum length of time the payment would take to be delivered to the recipient and informs the user of this potential delay so the user can schedule payments appropriately. The ECS 10 may be able to automatically add a required payment into the scheduling system based upon data parsed from a retrieved message. For instance, when a message including a payment due date is retrieved from one of the message providers 102, this information can be added to a scheduling system as the message is being processed for storage and distribution to the user.

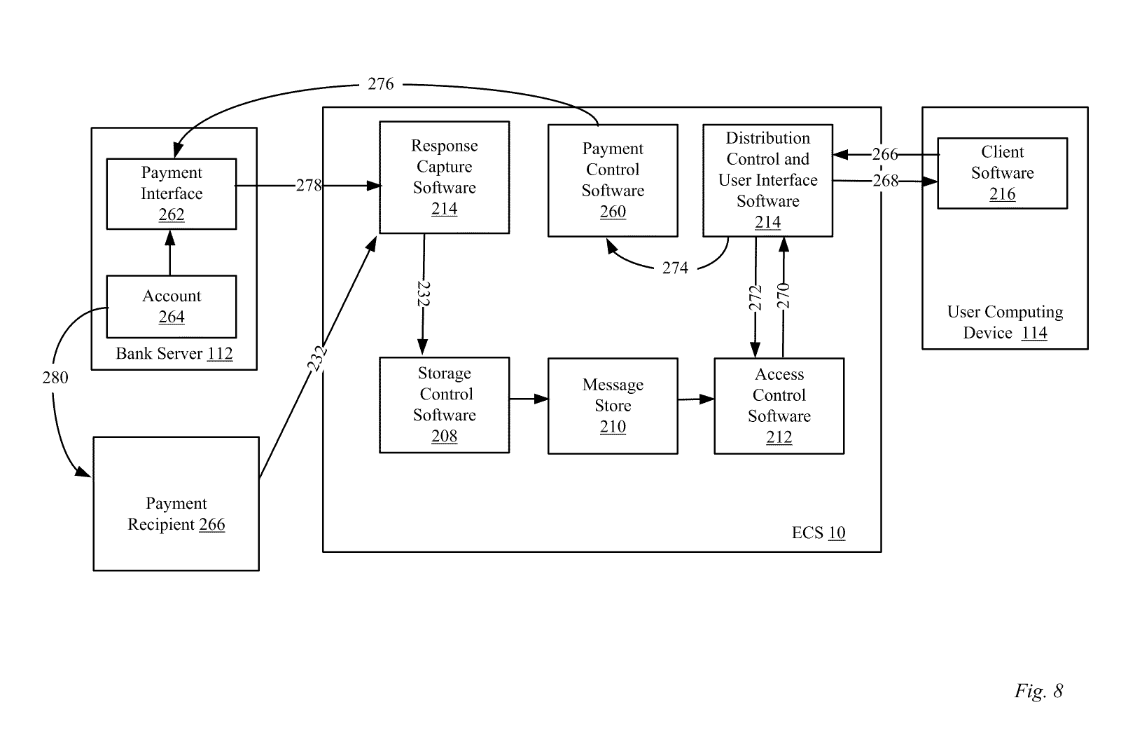

Additionally, the ECS 10 can be configured to provide reminders and alerts to the user regarding upcoming bill due dates. The reminders can be generated via any of a number of methods, including, but not limited to, display in the application user interface, email, SMS message and automated phone call. These reminders and alerts can give the user a simple payment option that simply requires the user to select a source account for the funds and approve the payment. To maximize the impact of the user's payments, the application can be configured to calculate the optimum payments to make on all bills and credit accounts, taking into account factors including, but not limited to, the user's income, funds available, outstanding balances, minimum payments due, expenses, other payments due and interest rates. Further details of interactions between the ECS 10 and other devices involving payment and transfer are described with respect to FIGS. 8 and 13.

In particular embodiments, the ECS 10 can be configured to allow message providers or users with accounts at the ECS 10 to deliver messages to other non-users (no account at the ECS 10) and user's alike (account at the ECS 10). A non-user receiving a message delivered via the ECS 10 can be given the option to sign up for the service to facilitate receipt and distribution of messages. Further, message providers that send messages to their clients via the ECS 10 can advertise their participation in the service, such as via a badge on their websites, and thus invite non-users to join the ECS 10 and enjoy the benefits it offers.

Different methods can be provided to allow a new user to sign up for an account at the ECS 10. As an example, in one embodiment, a new user can sign up for an account via a web-site associated with the ECS 10. In another example, the new user can sign-up via a referral from a message provider's website, such as a link to the ECS 10 at the message provider's website. If the new user signs up via the message provider's website, the website can provide any available account information directly to the ECS 10 for the enrolling user, such as an account number and details that allow messages to be retrieved from the message provider. For the ECS 10 account, the user can select a username and password, along with entering other security and personal information, to finish the sign-up process and begin having SSMs delivered for the message provider. If the message provider's website does not provide the user's account information directly to the ECS 10 (not all message providers may support this type of interface with the ECS 10), the new user may enter it manually after selecting a username and password and entering other security and personal information.

Once the user is signed up at the ECS 10, the clearinghouse can be configured to invite the user to add additional message providers to their account at the ECS 10. For instance, the user may initially register at the ECS 10 via their bank to have their bank statements delivered electronically but then may add their cell phone provider account to the ECS 10 to have their cell phone statement delivered via the ECS 10. Once the user's login account is fully set up, the system 10 can begin retrieving messages from the message providers as they become available. Further, in the instant where account statements are provided by the ECS 10, the user can be given the option of downloading all or a portion of available past account statements that previously were delivered via a method such as postal mail prior to the user signing up with the ECS 10. If a user wishes to add other accounts to the system or delete current accounts after the initial sign-up process, the user interface can be configured with this utility. In one embodiment, a direct link can be provided to the ECS 10 from a message provider that automatically integrates a client account of the financial data provider into the ECS 10. This feature may allow a user authenticated on message provider's website to click a link that provides the enrolling user's account information in an encrypted fashion to the ECS 10 so that the ECS 10 can begin retrieving messages associated with the message provider. Further details of an account registration process are described with respect to FIGS. 10-12.

In particular embodiments, businesses can sign up for accounts at the ECS 10 that allow messages related to the business to be delivered from various parties, such as vendors associated with the business. At the ECS 10 businesses can create multiple login accounts for various portions of the organization. Each login account may have a set of access privileges, allowing anyone using that account to view a particular set of financial documents and/or records—defined by any of a number of factors, including, but not limited to, source, date and content—and to initiate payments for specific purposes from specific financial accounts. Further, requests for authorization of a specified payment on a specified date from a specified account to a specified party for a specified purpose can be submitted to authorized login accounts for approval, and can then be executed automatically or at the submitter's discretion once approved. Such an organizational system with multiple system accounts allows organizations to engage in financial planning using the scheduling and approval systems.

Message providers intending to provide data that can be delivered as SSMs into user accounts at the ECS 10, such as messages including authenticated financial documents and/or records may be asked for verification of identity and trustworthiness. Such verification could include providing public record or other documents proving the identity and accountability of the user. Unverified users can be prominently indicated as such to prevent the false placement of trust by other users. Similarly, financial data providers can be verified by any of a number of methods, including, but not limited to, an encrypted authentication hash and verification of source IP address.

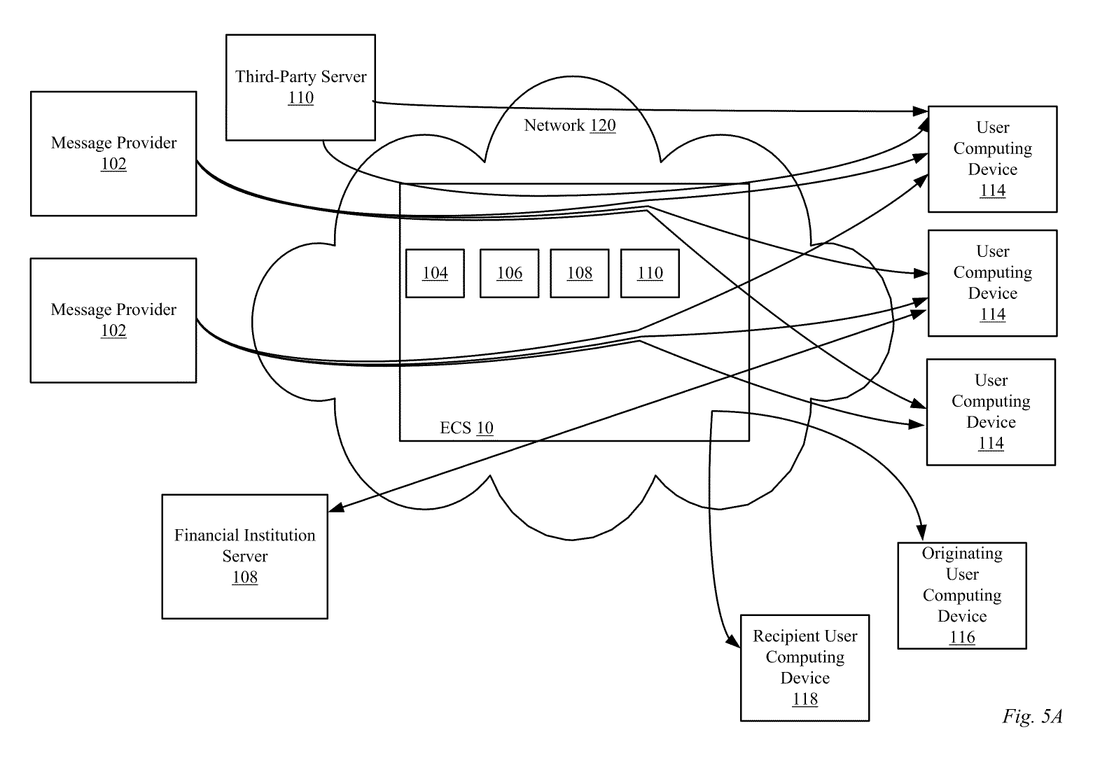

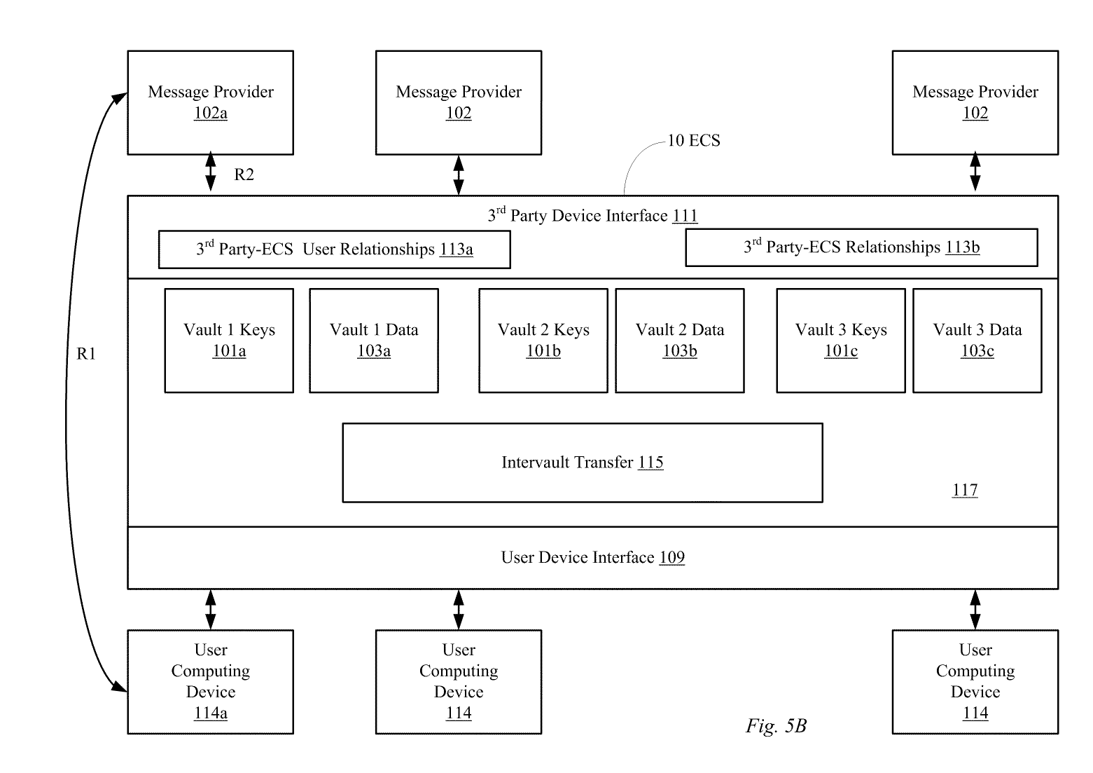

In one embodiment, recipients of messages from message providers may be allowed to provide feedback in regards to the trustworthiness of message provider. This information may be used to establish a trustworthiness ranking for the message provider. This information can be used internally at the ECS 10, possibly made public and possibly provided to other entities but not necessarily made public. Other methods of establishing trust between message providers and users of the ECS 10 are described below in more detail with respect to the section “Business Derived Relationship Metrics.” Next, further details of the communications available at the ECS 10 and the infrastructure that allows secure communications to be sent and viewed are described with respect to FIG. 5A.

### ECS Information Transfer

FIG. 5A is a block diagram showing communication and information distribution channels associated with ECS 10 residing on network 120. An application executing on a user-controlled device, such as 114, can communicate via a communication network 120 with one or more message providers 114 via the secure communication channels provided by the ECS 10. Further, the message providers 102 can communicate with the user computing devices 114 via the ECS 10. Many of the communication channels can be created and controlled by the ECS such that information related to the communications is routed through the ECS 10. Creating the communication channels can involve selecting specific communication and encryption protocols and associated parameters (e.g., encryption keys) that are supported by both parties in the communication and determining encryption parameters, such as encryption keys, that can be unique to the communication channel. Routing the communications through the ECS 10 can allow information associated with the communications among the devices to be captured and/or stored at the ECS 10. As will be described in more detail with respect to FIGS. 5B and 5C, the captured information can be stored in an electronic vaults in an encrypted format that reside at the ECS 10 and/or on the user computing devices 114.

As examples, communications between the message provider devices 102 and the user computing devices 114, between a third-party server 110 and the user computing devices 114, between the user computing devices 114 and the financial institution server 108, between two different user computing devices, such as between 116 and 118, can all be routed through ECS 10 for security and capture purposes. In one embodiment, a first communication between two devices, such as the third-party server 110 can be routed through the ECS 10. However, the devices can be configured to carry out subsequent communications that are not routed the ECS 10 as is shown in the FIG. 5A, which can prevent the ECS from capturing information associated with the communication. For instance, a communication between the third-party server 110 and the user computing device 114 is shown not being routed through the ECS 10. However, although the communication is not being routed through the ECS 10, the ECS 10 may have helped to broker a secure communication between the parties. The secure communication brokering can involve establishing the communication and encryption protocols and associated parameters that are to be used in the subsequent communications.

In particular embodiments, as described above, the ECS 10 can be configured to automatically and securely download messages from the message providers, such as 102. For instance, the ECS 10 can be configured to retrieve messages including the user's financial documents and/or records and store them at ECS 10 and/or on the user's computing devices, such as 114, 116 and 118. As shown in FIG. 5A, the ECS 10 can retrieve messages from a single message provider for multiple users. In FIG. 5A, the ECS 102 retrieves messages from each message provider 102 that are delivered to each of the user computing devices 114.

After messages are delivered, an application providing a user interface (UI) on their device can be used to access the messages and any associated data, The UI can be configured to provide functions that allow a user to organize, generate action items, list, search, display and manipulate the messages. To pay a bill or transfer money, the UI on the user's computing device can be configured to send a payment or transfer request via the communication network 120 and/or the ECS 10 to a financial institution server, such as 108, which can then execute the payment or transfer. Evidence that the payment or transfer was executed can be captured at the ECS 10, the financial institution server 108 and/or the user computing devices, such as 114.

In particular embodiments, a user computing device can be configured to perform some of the functions of the ECS 10 allowing the ECS 10 to be by-passed. For instance, by executing a software application that emulates some of the functions of the ECS 10, it may be possible for a user computing device to establish a direct and secure communication link with the message provider 102. If the ECS 10 is bypassed, i.e., the communication is not routed through the ECS 10, certain features may not implemented. For instance, because of security concerns, a user-controlled computing device may be given less access to information associated with an account at a message provider, such as 102, than a dedicated server controlled by the ECS 10. In other embodiments, hybrid arrangements can be utilized wherein the application running on the user's computing device can be configured to perform some tasks associated with the ECS 10 or conversely an application running on the ECS 10 can be configured to perform some tasks associated with the user computing devices 114.

As described above, an application can be provided that allows users to view and manipulate data, such as financial data stored in one of the vaults at the ECS 10 and/or one or more of their devices. In one embodiment, the ECS 10 can be configured to gather messages, which can include financial data, from the various message providers 102 and then maintain a user's messages at the ECS 10. In other embodiments, the ECS 10 can be configured to provide synchronization capability that allows the data stored in the user's vaults associated with their account at the ECS 10 to be mirrored on one or more devices controlled by the user, such as 114. The communications between the ECS 10 and the user controlled devices can be carried out using the secure communication channels generated by the ECS 10. Then, the provided application can be used to manipulate and view the data locally stored on the device controlled by the user. This capability may be useful if the ECS 10 is unavailable, if the bandwidth between the ECS 10 and the user computing device 114 is not so high or if the user simply prefers to have a copy of their secure data stored locally.

The synchronization capability can involve comparing messages and other data stored at the ECS 10 and one or more user's devices and then transferring message and/or data to the user's device such that the data on the user's device mirrors the data stored at the ECS 10 or vice versa. For instance, while shopping users may have received receipt data or generated a mobile purchase data on their mobile device that is uploaded to the ECS 10 and another user computing device, such as their home computer. For instance, the terminal at the merchant site can be configured to transmit receipt data to the user's device or the user via their device may simply take a picture of the receipt data, such as data on a printed receipt. In other embodiments, the user can manually provide or the user's device can be configured to provide ECS account information that allows a merchant to directly send receipt data to the user's ECS account. The synchronization capability can also involve pushing data from the ECS 10 to the one or more user's device, such as when new data arrives at the ECS 10 or vice versa.

In one embodiment, the ECS 10 in conjunction with a provided application that executes on a user's device can be configured to allow users to temporarily download a portion of their message data, to a user-controlled device, such as 114. As will be described in more detail with respect to FIGS. 5B and 5C, the message data can be stored in an electronic vault on their user-controlled device. However, if the user does not maintain an electronic vault on their user-controlled device, then the data can be temporarily stored on their device. Via the provided application, various operations can be performed on the local data. After working with the data, such as when a communication session between the user device and the ECS 10 ends, for security purposes, the application may provide users with the option of removing the data stored locally and uploading back to the server any work product that was generated locally on the user's device for secure storage. In addition, any data retained locally can also be stored in encrypted format. The work product can be stored as an SSM on the ECS 10 in an electronic vault.

To ensure continuity of service and data access, the ECS 10 can be configured with a combination of redundancy and backups. In one embodiment, multiple synchronized servers in different locations with different communication links can be used to ensure that the failure of one server does not make the service inaccessible. Further, each server can use a secure, isolated and encrypted backup system to keep redundant copies of its data stores in case of failure of its storage mechanisms. In another embodiment, where some of the users SSMs are stored on a user-controlled device, though it may not be possible to ensure the user will maintain redundant systems for continuity of access, it may be possible for the user to do so by simply copying the encrypted data store to a designated location on a separate computer or virtual machine. The software application does, however, ensure automatic backups are made at regular intervals if the user so desires, in a location of the user's choosing (ideally a mass storage device dedicated to the purpose of backing up the user's SSMs). In particular embodiments, as is described in more detail with respect to FIGS. 5B and 5C, users can be provided with one or more “vaults” for securely storing their data, such as SSMs.

### Data Storage and Sharing Via Electronic Vaults

FIGS. 5B and 5C are block diagrams showing an electronic clearinghouse system (ECS) 10 in accordance with the described embodiments. The ECS 10 can include a data storage area 117 where the documents are stored in electronic vaults in an encrypted format, such as 103a, 103b and 103c. Each of the electronic vaults can be accessed by one or more users with accounts at the ECS 10. Each document stored in a vault can be encrypted with one or more encryption keys. The one or more decryption keys needed to decrypt the documents can be stored in 101a, 101b and 101c, respectively.

Documents stored in the vaults can be originated from third-parties, such as the message providers, 102 and 102a. The documents can be pushed from the message providers to the ECS 10 or pulled from the message providers by the ECS 10. The pushing and/or pulling of documents can be managed by the 3^{rd} party device interface 111.

The 3^{rd} party device interface 111 can be configured to establish relationships between the message providers and the ECS 10 that allow documents to be obtained and then stored to appropriate electronic vaults in the data storage area 117. The relationships that are established can include information about a direct relationship between 3^{rd} parties and the ECS users 113a and a secondary relationship between the 3^{rd} Parties and the ECS 10. The relationships can also be between ECS users, such as agreements created from accepted invitations to share data. The direct relationships between the 3^{rd} parties and the ECS users can be verified by the 3^{rd} parties. As is described in more detail with respect to FIGS. 18 and 19, the verification of a direct relationship between an ECS user and a 3^{rd} party by the 3^{rd} party can be used to calculate a user validation score that at least qualitatively provides some indication that ECS user possesses the identity that they promulgate via the ECS 10.

In one embodiment, a user can have a direct relationship, shown as R1 in FIG. 5B, and a 3^{rd} party message provider 102a. The direct relationship may allow the ECS user to access information about an account maintained by the message provider for the ECS user. For instance, message provider 102a can be a bank that maintains a bank account for the ECS user which is accessible via a web-based interface from the user computing device 114a. The ECS user may provide to the ECS 10 information that allows the direct relationship, R1, between the ECS user and the 3^{rd} party message provider to be confirmed by the 3^{rd} party.

A request for confirmation of the relationship can be sent from the ECS 10 to a 3^{rd} party message provider, such as 102 or 102a. When the 3^{rd} party confirms to the ECS 10 the relationship between the 3^{rd} party and the ECS user, a secondary relationship, “R2,” can be formed between the ECS 10 and the 3^{rd} party message provider, such as 102a. The secondary relationship may allow the ECS 10 to retrieve data, such as documents, from the 3^{rd} party for the ECS user that has a direct relationship with 3^{rd} party and store the documents into an electronic vault at the ECS 10.

The direct and secondary relationships can differ in the privileges associated to each relationship. In one embodiment, the privileges can be associated with access to account data and performing actions associated with the account maintained by the 3^{rd} party for the ECS user with the direct relationship with the 3^{rd} party. For instance, if the 3^{rd} party, 102a, is a bank that maintains a bank account for the ECS user, then via the direct relationship, the ECS user may be able to see account data and perform transactions, such as monetary transfers from the bank account. However, via the secondary relationship, the ECS 10 may be able to retrieve account data for the ECS user from the bank. However, the ECS 10 may not be allowed to perform certain actions associated with the account, such as monetary transfers, that can be performed via the direct relationship. In an alternate embodiment, the privileges associated with the primary and secondary relationships can be the same.

Documents may be deposited into the vaults by user. For example, via user computing device, such as 114 or 114a, an ECS user can use a client application, such as but not limited to a browser, to import and upload documents that are deposited into electronic vaults. In one embodiment, the document deposits from user computing devices can be performed via user device interface 109. In particular embodiments, described in more detail with respect to FIG. 5C as follows, an electronic vault maintained on a user computing device can by synced with an electronic vault maintained at the ECS 10. The user device interface 109 can be configured to extract data from the electronic vaults in the data storage 117 and send the data to the user devices or receive data from the user device and deposit it into one or more electronic vaults in the data storage 117.

Once data is in the data storage area it can be moved from vault to vault. The inter-vault transfer area 115 can be used to transfer data securely between vaults. In various embodiments, as is described in more detail below, inter-vault transfers can be used to allow ECS users to send data with one another and share sets of data in common in a secure manner.

The files in each vault can be stored in an encrypted format. Each file including data in a vault can be encrypted with one or more encryption keys. For instance, a file can be encrypted with a single encryption key or a first portion of the file can be encrypted with a first key and a second portion of the file can be encrypted with a second key. In one embodiment, files stored in a vault can be encrypted with a common encryption key. In another embodiment, a master decryption key can be utilized that can decrypt all of the files in all or a portion of the vaults.

Providing access to a file in a vault may involve determining a decryption key needed to decrypt a selected file and then decrypting the file with the determined decryption key. The encryption and decryption keys can be stored for each file in a vault. As an example, in FIG. 5B, the encryption and decryption keys for vaults 103a, 103b and 103c are stored as vault 1 keys 101a, vault 2 keys 101b and vault 3 keys 101c. In one embodiment, the vault keys 101a, 101b and 101c can be stored as part of a key management database.

Users with accounts at the ECS 10 can be provided with one or more vaults for securing their data, such as 103a, 103b and 103c. In particular embodiments, vaults 103a, 103b and 103c can be associated with a single user or multiple users where only a user associated with a vault is able to access the files in the vault. As an example, vault 103a can be associated with a first user, vault 103b can be associated with a second user and vault 103c can be associated with a third user where the first is only allowed to access files in vault 103a, the second user is only allowed to access files in vault 103b and the third user is only allowed to access files in vault 103c. As another example, vaults 103a, 103b, 103c can be associated with the first user where the first user is allowed to access the files stored in each of vaults 103a, 103b and 103c, respectively.

In other embodiments, vaults can be shared. For instance, vault 103a can be associated with a first user, vault 103b can be associated with a second user and vaults 103c can be associated with the first and second user. Thus, the first user may be allowed to access files in vaults 103a and 103c and the second user may be allowed to access files in vaults 103b and 103c.

As described above with respect to FIG. 5B, the files in each vault, as shown in FIG. 5C, can be encrypted and decrypted with particular encryption and decryption keys. The keys can be tracked using key management software. The key management software, such as 156, 166, 176 and 180, can reside at the ECS 10 and/or on a user's computing device, may be used to 1) keep track of one or more decryption keys that are needed to decrypt each file, 2) keep track of public keys associated with public-private key pairs used to encrypt files that can be decrypted by the holder of the related private key, 3) generate new encryption keys and 4) determine encryption keys to be utilized to encrypt particular files.

The key management software can be configured so that it is mostly or entirely transparent to the user. For example, in one embodiment, a particular encryption key can be associated with a first vault. When a user places a file in the first vault, such as via dragging a file into the first vault in a graphical manner via a User Interface (UI) on the user's computing device or other file manipulation methods such as copying and pasting, the key management software can be configured to determine which encryption key or keys to use, encrypt the file with the determined encryption key or keys, store the encrypted file in the vault and keep a record of which key or keys are needed to later open the file without input from the user. When the file is later selected for viewing, such as in a graphical manner via the UI, then the key management software can determine which key is needed to decrypt the file for viewing using its previously stored records, again without input from the user. However, the ECS 10 can be configured to optional provide opportunities for the user to view, modify and/or manipulate the current key management protocol including changing the keys and the encryption schema associated with one or more files.

Later, a user can decide to create a second vault that utilizes a new encryption key via a function provided on the UI. The user may move a file from the first vault to the second vault, such as via dragging the file in a graphical manner. In response to the user actions, the key management software can create a new vault and a new encryption key, decrypt the file in the first vault using the encryption key associated with the first vault, encrypt the file with the encryption key associated with the second vault and update the record associated with the file to indicate what key or keys are needed to later decrypt the file without input from the user. Thus, to the user, it may appear that they are merely opening files for viewing, moving files from one location to another location for storage or creating a new storage location while the key management and encryption/decryption functions are performed automatically in the background for the user.

The key management software can be configured to handle different types of encryption algorithms using different encryption schemes. As an example, the key management software can be configured to handle both symmetric and asymmetric encryption schemes and combinations thereof. In a symmetric encryption scheme, approximately the same encryption key is used to decrypt a file as is used to encrypt a file. In an asymmetric encryption scheme, a first key is used to encrypt the file while a second key is used to decrypt the file. The first key can be mathematically related to the second key such that it is difficult to determine given the first key used to encrypt the file the value of the second key needed to decrypt the file.

One example of asymmetric encryption that can be utilized herein is public-private key encryption. In public-private key encryption, a public key can be created for encrypting a file that is mathematically related to a private key needed to decrypt the file. The public key can be made publically available while the private key may be kept secret. Thus, a file encrypted with a public key can be sent to a particular user of the ECS 10. Then, the user can provide their private key, such as via their key management software, to decrypt and view the contents of the file.

An advantage of symmetric encryption schemes is that they typically require less computational resources to decrypt/encrypt the files than asymmetric encryption schemes, such as a public-private encryption scheme. A disadvantage of symmetric encryption is that a mechanism is needed to securely exchange the symmetric encryption key so that a first party that has received a file encrypted with the symmetric encryption key by another party can decrypt the file. With public-private key encryption, a secure key exchange may not be needed to decrypt a file because the file can be encrypted with the recipient's public key where the recipient already possesses the private key needed to decrypt the file.

The ECS 10 can be configured to facilitate secure symmetric key exchange between two users of the ECS 10. In a particular embodiment, the ECS 10 can use a methodology that combines both symmetric and asymmetric encryption schemes for this purpose. For example, a symmetric encryption key can be exchanged between two parties using a public-private key pair where a first user encrypts a symmetric encryption key using the public key of a second user and then sends the encrypted symmetric key to the second user who can decrypt using their private key. Then, the first user can encrypt a file using the symmetric encryption key and send it to the second user. The second user can decrypt the file using the symmetric encryption key that they previously received from the first user. These communications can be routed through the ECS 10.

The ECS 10 can be configured to keep track of public keys for users and message providers with accounts at the ECS 10. In addition, the ECS 10 can be configured to create a public-private key pair when a user registers for an account at the ECS 10. In one embodiment, the user's private key may not be stored at the ECS 10. Thus, the ECS 10 will not be able to decrypt files encrypted using the user's public key. For instance, when a user associated with device 114 registers at the ECS 10, the ECS 10 can create the public-private key pair, securely send the private key via some mechanism to the user (e.g., via postal mail, e-mail, SMS, or a Virtual Private Network (VPN) facilitated by the ECS 10, etc.) destroy the copy of the private key at the ECS 10 and save the public key at the ECS 10. In another example, when a user registers at the ECS 10, the key management software, such as 156, 166 or 176, can be provided and installed on the user's computing device, such as 114, 116 or 118. Then, the key management software can create a public-private key pair and send a copy of at least the public key to the ECS 10.

In other embodiments, the ECS 10 can be configured to store a copy of the user's private key or any other type of key needed to decrypt a file as a back-up for the user. In this example, the ECS 10 can be configured to only unlock the files using the back-up keys at the authorization of the user or to comply with an outside order, such as a court order. In yet another embodiment, the ECS can be configured to send a back-up copy of a key needed to decrypt a file to a trusted third-party designated by the user. In the instance where a user loses a needed key, the ECS 10 can be configured to retrieve the needed key or keys from the third-party, such as when authorized by the user to do so.

In one embodiment, if a first user of the ECS 10 wishes to send a message to another user, the key management software at the ECS 10 can look up the public key of the intended message recipient and encrypt one or more portions of the message content with the recipients public key so that it can be decrypted by the recipient's private key. In another embodiment, the encryption can also be performed at the user's device, such as 114, 116 and 118. For instance, a file can be stored on user computing device 114 controlled by a first user that the first user wishes to send to a second user where both users have accounts at the ECS 10. When the second user is specified, the user computing device 114 can send a request to the ECS 10 to obtain the second user's public key.

After receiving the second user's public key, the device 114 can encrypt one or more files with the public key and then send a message with the one or more encrypted files to the ECS 10. The ECS 10 upon receiving the message with the encrypted files can route the message to the second user. For instance, if the second user is associated with user computing device 116, then the ECS 10 can send a message to the user computing device 116 to notify the user that they have a new message at the ECS 10. Then, the new message may be uploaded to the second user's computing device where it can be decrypted using the private key known to the second user.

When public-private key encryption is employed by an individual on their own (i.e., outside of the ECS 10), a disadvantage is that if the individual loses their private key, then they need to create a new public-private key pair, notify all parties that have their old public key that the key is no longer valid and thus, to start using their new public key. Once a public key is made public, its distribution may be out of control of the individual, thus the individual may not even know all the parties that possess their public key. Thus, it may be difficult for the individual to notify others to stop using the old public key.

An advantage of using the ECS 10 is that a centralized public key database can be maintained that makes it simpler for a user of the ECS 10 to switch to a new public-private key pair. Each time one user wants to send a message to another user of the ECS 10, the ECS 10 can look up the public key of the intended recipient. For instance, key management software 180 at the ECS 10 can look up a public key of an intended message recipient at the request of key management software 176 on device 116 and send it to the user computing device 116. The key management software on user devices, such as 156 and 176, can be configured so that it does not maintain a local public key database but contacts the ECS 10 each time a public key is needed. Thus, if a message recipient needs a new public-private key, the new public key can be added to the public key database maintained at the ECS 10. The potential message senders do not need to be notified of the new public key because the next time they wish to send a message to the recipient with the new public key the ECS 10 can locate in its public key database the public key that is currently valid for the intended message recipient.

In particular embodiment, the ECS can maintain back-up copies of user vaults maintained on their own computing device. For instance, vaults 150a, 152a and 154a maintained at the ECS 10 can be a copy of vaults 150b, 152b and 154b maintained on user computing device 114. In another example, vaults 170a, 172a and 174a maintained at the ECS 10 can be a back-up of vaults 170b, 172b and 174b maintained on user computing device 116. The ECS 10 and the user computing devices with their own vaults, such as 114 and 116, can regularly communicate vault information to synchronize the vaults on the ECS 10 and the user computing devices. The synchronization can involve comparing what is stored at each of the user computing devices at the ECS 10 and the user computing devices. When differences between the ECS 10 a user computing device are found, then the ECS 10 can send data to the user computing device and the user computing device can send data to the ECS 10 until each of the devices are synced with one another. In one embodiment, the vault management application 182 can be configured for this purpose. Further, software executed on the user computing device can also be used for this purpose.

In one embodiment, a user's files may be stored solely at the ECS 10 but a key management function may be maintained on the user device. For instance, device 118 may not maintain one or more user vaults. Instead, the one or more user vaults can be maintained as vaults 160a, 162a and 164a at the ECS 10. A UI executing on the user's computing device can display the vaults as virtual vaults 166, such as 160b, 162b and 164b. The virtual vaults may minor the contents stored at the ECS 10 as if the contents were stored locally on device 118. However, when a user wishes to access one of the files in a vault, the ECS 10 can be configured to send a copy of the desired file so that the user can open it up on device 118 after the key management 166 provides the proper key. In another example, the key management software can send the key needed to decrypt the file to the ECS 10, which can then decrypt the file. If desired, the decrypted contents can be viewed on the user computing device 118 via some interface supported by the ECS 10 on 118.

After receiving the key from a remote device, such as a key needed to decrypt a file, in one embodiment, the ECS 10 can be configured to destroy the key after it is used to decrypt the file. Thus, the ECS may not maintain the ability to decrypt the file. In other embodiments, the ECS 10 can be configured to store the decryption key in a secure manner for a limited time. For instance, the ECS 10 may store the key long enough to ensure an intended recipient has received and been able to decrypt the file. If an error occurs, then the ECS 10 can use the stored key to again decrypt the file and send another copy to the intended recipient. After some time period, the ECS 10 can then destroy the needed decryption key. Finally, the ECS 10 can be configured to store the decryption key on a more permanent basis. For instance, the ECS 10 can be configured to store the decryption key for the file as long as file is stored at the ECS 10. If the file is deleted then its associated decryption key can also be deleted.

The user computing device 118 can be configured to maintain a last image of the user's vaults stored on the ECS 10. When the device is not in contact with the ECS 10, the user can load a new file to their computing device 118. For instance, the user can receive an electronic receipt or take an image of the receipt on device 118 and then add it to one of their virtual vaults, such as 160a, 160b and 160c. The file can be encrypted using an encryption key provided by the key management 166. When the user computing device 118 next communicates with the ECS 10, the virtual vault contents on device 118 can be compared to the actual vault contents at the ECS 10. The items added to the user's vault on device 118 can be sent to the ECS 10 to sync the vaults. Then, when the sync and file transfer is verified, the file added to device 118 and transferred to the ECS 10 can be removed from device 118. If new files have been received at the ECS 10 and added into the user's vaults, the virtual vaults 166 maintained on device 118 can be updated so that it accurately reflects the contents of the vaults at the ECS 10.

In yet another embodiment, the key management and the storage for the vaults can be performed solely at the ECS 10. In this embodiment, via a computing device, a user can access the ECS 10. After the user is sufficiently authenticated, such as via passwords and/or biometric identification, the user may be allowed to access the contents of their vaults. For instance, a user can select a file in their vault and then have all or a portion of the contents of the file displayed to a remote device from which they are accessing the ECS 10.

In particular embodiments, the vaults can be used for the purposes of file sharing. Two or more users via the ECS 10 can agree to share a vault where the contents of the vault are visible to both users. As an example, the ECS 10 can be configured so that contents of vault 150b on device 114 and vault 170b on device 116 are synced with one another. Thus, if a file is placed in 150b, it can be synced with 170a and 150a at the ECS 10. Then, vault 170a can be synced with vault 170b on device 116 allowing the user of device 116 to see the newly added file.

In one embodiment, vault sharing can be enabled via key sharing. For instance, files placed in shared vaults 150b and 170b can use shared encryption keys. The key management software 156 and 176 can be configured to exchange encryption key or keys, such as a shared symmetric encryption key or shared public-private key so that both devices can access the contents of the shared vault. In another embodiment, the devices, 114 and 116, can separately manage their keys. For instance, when a file is placed in vault 150b, it can be stored with a vault key known to the key management software 156. The vault key can be used to decrypt the file and then allow it to be encrypted with an encryption key associated with another vault, such a public key for a vault associated with another user. Thus, since the vault is shared, the user computing device 114, after requesting a public key associated with device 116, can encrypt the file using the public key and send it to the ECS 10 for delivery into vault 170b. Then, the file can be decrypted using the private key associated with the public key of device 116.

In an alternate approach, after a new file is placed in vault 150b and after vault 150b and 150a are synced, the user device 114 can send the key needed to decrypt the file in vault 150a to the ECS 10. The ECS 10 can decrypt the file using the key provided by device 114. Next, the ECS 10 can encrypt the file using a key provided by device 116 and place the encrypted file in vault 170a. Then, vault 170a and 170b can be synced and the shared file in 170b can be opened using a key the same as or related to the key provided to the ECS 10 by device 116.

In another embodiment, file sharing can be set-up so that two or more users each have to provide a key to open a file. In a particular embodiment, this feature can be implemented by the ECS 10 such that the two users have to be logged onto to the ECS 10 and each provide a manual input that allows the needed keys to be obtained so that the file can be decrypted and viewed by at least one of the users. For instance, a first user could send a file encrypted with a first key known only to the first user to a second user of the ECS 10. Then, the file can be encrypted with a second key known only to the second user. When the second user wishes to view the file, it can be partially decrypted using the key available to the second user. Then, the second user can send a message to the first user, such as via the ECS 10 but also via an alternate communicate means such as via the phone that they are ready to look at the file. Then, in response, the key necessary to view the file can be sent to the second user from the first user and the decryption of the file can be completed. Finally, the first user and the second user may be able to view the decrypted file with the knowledge that both parties are currently looking at the file.

In one embodiment, one or both the users may be able to send a command that revokes viewing of the shared file. This function can be implemented at an interface level. For instance, an interface that works in conjunction with the key management database can receive a command to close and/or delete the file. In another example, the key management database can be instructed to provide the key to open the file once or a limited number of times. After the limit is exceeded, the key management database can refuse to supply key and/or may destroy the key. As an example, in the paragraph described above, the ECS 10 may be configured to allow the first user to send a command that ends viewing of the file by the second user via an interface used to view the contents of the file. If the connection between the users is broke, then the viewing of the file by the second user can also be terminated automatically by the interface. In another embodiment, after the first and the second user view the file together, then the file can be stored with a key that allows the file to be opened up without input from the first user so that the second user can later view the file at their leisure.

An embodiment such as the one described above might be useful in a doctor-patient relationship. A doctor may wish to send test results to a patient but not have the patient see the test results for the first time unless the doctor and patient have an active communication session established. With the method described above, the doctor can send an encrypted file including a test result to the user and then release the file for viewing once the doctor and the patient are actively communicating.

In the embodiments described above, one or both of the users that are communicating can be message providers. For instance, a user can set-up a vault that allows documents to be shared with a message provider, such as a mortgage provider. In another example, two message providers, such as two businesses can have accounts at the ECS 10. The message providers can agree to a shared vault that allows files placed in the shared vault to be viewed by each message provider.

In yet another embodiment, a shared vault can be created and then subscribed to by a number of users at the ECS 10. For instance, a vault may be created that has a unique ID. The unique ID may not be made publically available. However, the unique ID can be given to particular users of the ECS 10. With the ID, a user may be able to sign-up to receive contents placed in the vault. In one embodiment, the access privileges to the vault may be limited. For instance, more users may be allowed to receive contents from the vault than are able to add contents to the vault. In other embodiments, each user subscribed to the vault may be able to add to and receive contents from the vault.

In one embodiment, the contents of the shared vault can be accessed using a shared decryption key. In another embodiment, a file placed in a shared vault can be encrypted using an encryption key that allows for multiple decryption keys where different decryption keys can be used by different users of the shared vault. The shared vault might be used in a purchasing situation. For instance, a buyer, seller, loan originator, real estate agents might be able access loan documents, such as a purchase contract in a shared vault.

In another example of filing sharing, a file can be stored in a vault associated with a first user of the ECS. The first user can tell the ECS 10, that they wish to allow a second user of the ECS to see the file in the vault. The ECS 10 can update its records to indicate the second user is allowed to access the file in the vault. The ECS 10 can then notify and/or invite the second user to view the file in the vault. When the second user attempts to access the file, the ECS 10 can check the access privileges allowed for the file, confirm the second user is allowed to view the contents of the file, decrypt the file using a decryption key owned by the first user and then provide an interface that allows the second user to view the contents of the file.

Data Delivery from a Provider to a User Device Via the ECS

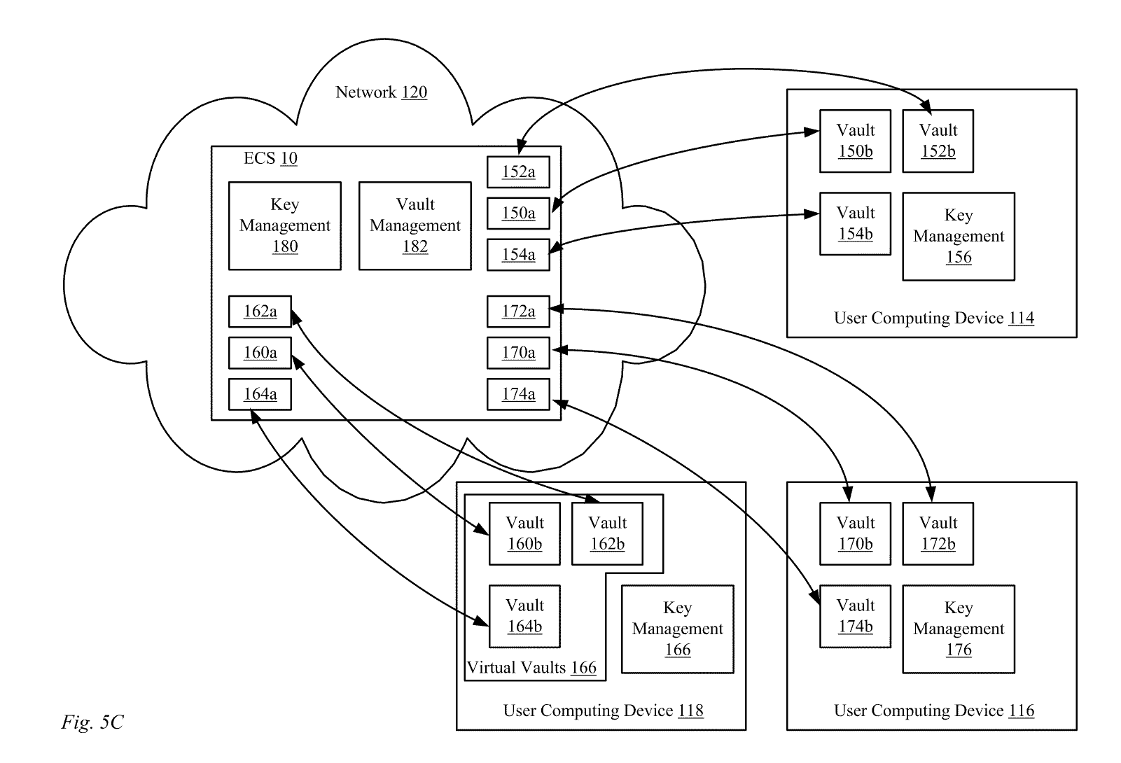

FIG. 6 is a block diagram showing secure delivery of data from a message provider 102 to a user computing device 114 via the ECS 10 in more detail. For the purposes of illustration, the ECS 10 functions can be instantiated as a number of different component applications. In particular, the ECS 10 can include but is not limited to acquisition control component 206, storage control component 208, a message store 210, access control component 212 and distribution control and user interface component 214. The different functions can interact to retrieve a message from the message provider 102 and deliver it to the user computing device 114 in a secure manner. Aspects of the delivery process for one embodiment can be generally described as proceeding as follows.

In 224, a storage control component 208 can request that the acquisition control component 206 retrieve one or more SSMs, which can include financial documents and/or records, from the message provider 206. The requests can be generated at various intervals, such as daily, in accordance with the electronic delivery agreements stored at the ECS 10. The electronic delivery agreement can include parameters that affect aspects of the delivery, such as but not limited to the communication and encryption protocols to be used to retrieve and/or store the message, frequency of the retrieval, and a description of post-retrieval processing to be performed on the message. The parameters of the electronic delivery agreement can be selected by the message provider 102 and/or a user that is to receive delivery of the SSM. For instance, the message provider 102 and/or a user can specify parameters that affect a format of document, such as a statement, that is generated from account data retrieved from the message provider 102.

In 218, the acquisition control software 206 can make a data request to the message provider 102 via the external interface 204. In one embodiment, the external interface 204 can be a web-based interface that allows users with an account at the message provider to access their account information. In particular embodiments, the data request can include a request for one or more pre-formatted documents and/or raw data that can be formatted at the ECS 10 into a document. The communications can be carried out using one or more communication protocols supported by the message provider 102 and the ECS 10.

If the requested data is available, the message provider 102 can retrieve the requested data from its data store 202 and in 220, return it to the ECS 10 using the agreed-upon communication protocols. In particular embodiments, the retrieved financial data can include raw data as well as formatted documents that include all or a portion of the raw data. The acquisition control component 206 can receive the message from message provider and in 222, forward it to the storage control component 208, where the storage control component 208 can accept, parse and process the message and its associated data. In one embodiment, the storage control component 208 can convert the message to one or more SSMs. The conversion process can involve encrypting the message in a particular format. Further, the storage control component 208 may generate a formatted document, such as a statement, using information stored in the message. The one or more SSMs can be stored in the message store 210. The message store can incorporate the one or more electronic vaults described above. Further, digital signatures can be generated for the messages to be stored in the message store. The digital signatures can later be used by the ECS to determine the authenticity of a message stored in the message store or a copy of a message stored in the message store that has been provided to another entity.

In one embodiment, the storage control component 208 can notify the distribution control 214 that a new SSM is available for delivery. The information regarding the new SSM can be delivered into a user's account at the ECS 10. When new messages, which can include financial documents and/or records, are available for download and/or viewing, the user can be notified of this fact via any of a number of methods, including, but not limited to, email, SMS, local notifications on the user's computer (such as a pop-up message), phone call and/or a combination of these methods. The UI can be configured to allow users to customize a personal notification protocol that describes how and when the user is to be notified. The notification can be triggered on a message by message basis or the ECS can periodically check a user's account to see if new messages have been delivered and then notify the user. In another embodiment, the user can learn of new messages when they periodically login into the ECS 10.

In one embodiment, a user can learn about the new SSM when, in 230, a client software application 216 running on a user's computing device 114 contacts the ECS 10 and requests and accesses their account via the distribution control and user interface 214. The communication between the ECS 10 and the user's communication device 114 can be via secure communication channel, such as via a VPN. For instance, in response to receiving a notification that a new SSM is available on their computing device 114, the user can attempt to access their account at the ECS 10. The distribution control and user interface component 214 can receive and authenticate the request for account access and then pass on the request to the access control component 212 where the access control component 212 can be configured to control access to the message store. In 226, the access control component 212 can receive and again authenticate the request. When the authentication is successful, the access control can retrieve the requested SSMs from the message store 210, such as an SSM newly delivered into the user's account.

In 228, the access control component 212 can forward the retrieved SSMs to the distribution control and user interface component 214. Then, in 232, the distribution control and UI component can forward the returned SSMs to the client software application 216 running on the user's computing device 114. The client software 216 can support an interface alone or in conjunction with the distribution control and UI component which can allow the SSMs to be viewed and manipulated at the user computing device. For instance, information regarding the SSMs can be output to a display coupled to the user computing device 114.

In one embodiment, the distribution control and user interface component 214 can be configured to generate a user interface, such as a web application or other remote application that is output on the user computing device 114. In another embodiment, the user's computing device 114 may also run a specially designed software application that presents a user interface. The client software 216 can be configured to send requests to and receive responses from the ECS 10 using one or more specified protocols in the client software 216.

In one embodiment, to aid the user in ensuring security and safekeeping of passwords, the UI provided by 214 alone or in conjunction with 114, can include a password manager, which stores usernames, passwords and other login information within the user's encrypted data store. This password manager helps the user to generate randomized and secure, but memorable, passwords for the user's various computer accounts, and stores these for access by the user or the ECS 10, where authorized to access the user's accounts to retrieve account data. In another embodiment, UI can be provided that generates a scheduling facility and calendar interface. The calendar portion of the UI can include a calendar on which selected events are displayed. In particular embodiments, calendar can be automatically populated with events, in response to a message arriving that is date constrained, such as a bill.

The UI can be configured to allow users to choose which events to display on the calendar, including, but not limited to, availability or delivery dates for financial documents and/or records; due dates and intended and actual payment dates for bills; account totals after particular events occur; income; automatic withdrawals; automatic deposits; account totals; cumulative spending or billing totals over a specified period, such as a month; income-outgo differentials; expenses; and arbitrary events defined by the user. In one embodiment, a simple weekly, monthly or other calendar can be displayed to the user, where the user can select ranges or moments of time and add scheduled events including an arbitrary set of descriptive data. Further, the calendar can be populated automatically, in response to user selection, with combination of the above-mentioned types of events, which are then placed at the appropriate locations on the calendar.

### Direction Communications Between a Message Provider and a User Computing Device

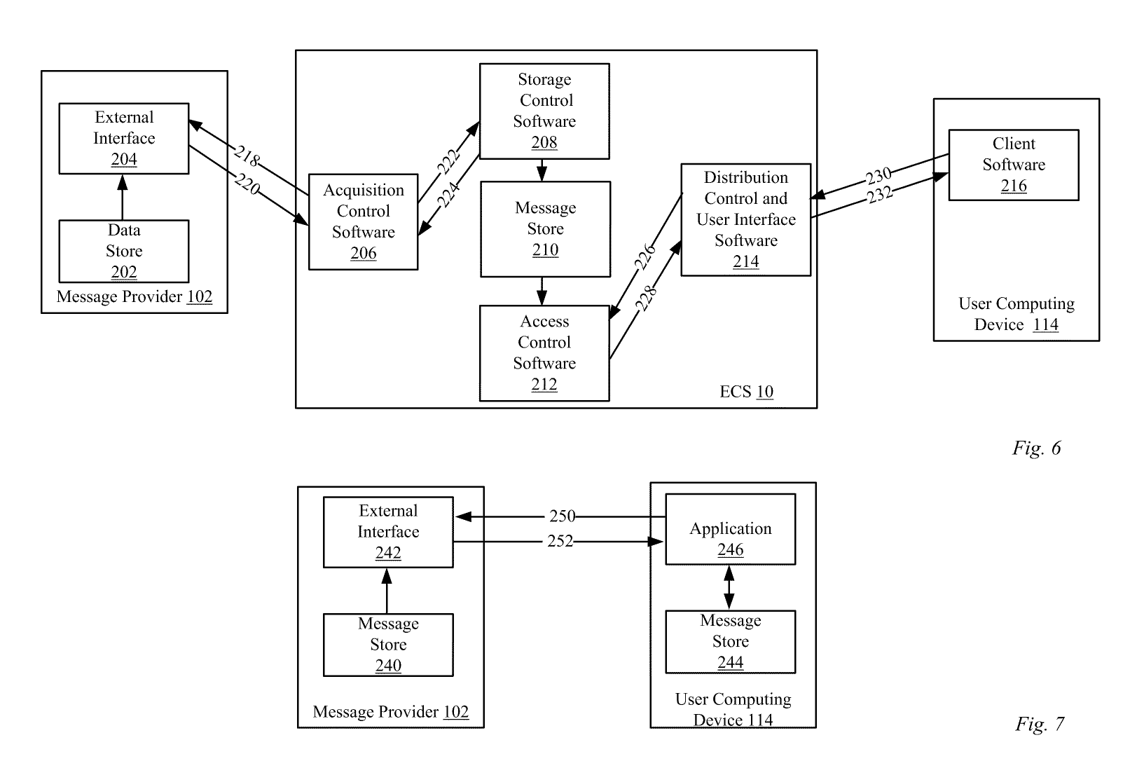

FIG. 7 is a block diagram showing direct communications between a message provider 102 and a user computing device 114 via an application 246 executing on the user computing device that is configured to emulate one or more functions of the ECS 10. The application 246 can be initiated and closed in response to inputs provided from the user and/or the ECS 10. Further, the application 246 can be configured to receive data or program option selections input by the user. In 250, the application 246 executing on the user's computing device 114 can request one or more messages, such as messages including financial documents and/or records, from the message provider 102, via the message provider's external interface 242. The communications can be generated using one or more communication protocols supported by both the message provider 102 and the user computing device 114.

In response to receiving the request, the message provider 102 can retrieve the requested data, such as financial documents and/or records from its data store 240. In 252, the message provider can send the requested data as one or more messages to the user's computing device 114 using one or more of the agreed-upon communication protocols. The application 246 running on the user's computing device can accept, parse, process and store the message in the local message data store 244 on the user's computing device 114.

The messages can be stored in an encrypted format for security purposes according to a security policy previously selected by the user. The ECS 10 can provide the user with different security policy options that utilizes a particular communication and encryption schema. The security policy options can offer trade-offs such as more or less security at the cost of 1) a greater or a lesser storage requirement, 2) a greater or a lesser time to decrypt/encrypt messages and/or 3) a greater or a lesser time to transmit the messages. In one embodiment, the encryption policy selected by a user can be incorporated into an electronic delivery agreement established between two parties, such as between two users of the ECS 10. Based upon the encryption policy selected by the user, the application on the user's computing device can be configured to convert the messages into an SSM for storage in the manner that the ECS 10 converts messages into SSMs based upon a user's selected security policy. In one embodiment, the user computing device after converting the message received from the message provider 102 into an SSM can establish a communication link with the ECS 10 and send a copy of the SSM to the ECS 10.

Next, some additional functions that can occur at the ECS 10 and/or a user computing device 114 as shown in FIGS. 6 and 7 for instance are described. If the SSMs, which can include financial documents and/or records, are stored locally on the user's computing device 114, then a locally executed software application, such as 246, can be configured to simply retrieve them directly, decrypt them and present them to the user via an UI associated with the locally executed application. In a particular embodiment, the software application 246 can also be configured to generate financial documents, such as an account statement, in a specified format in response to receiving a message including a set of data necessary to create the document. If the user has multiple computing devices each including a message store, such as 244, the various instances of the message stores can be kept synchronized.

In one embodiment, one of the user's multiple computing devices can be configured to act as a data store for a number of other devices where the other devices may be able to remotely access the data store. For instance, a user may designate a home computer to act as a data store that can be accessed by a number of mobile devices carried by the user. If desired the user data store can be mirrored on the ECS 10. In this configuration, a syncing operation is not necessary between the different user computing devices to maintain different data stores. However, syncing may be performed to transfer messages received by one of the user's computing devices when it is not connected to the user computing device including user data store.

To retrieve financial documents and/or records from a message provider 102, the application 246 and/or the ECS 10 can be configured to utilize any of a number of retrieval methods, including, but not limited to, web services, download via HTTP or another protocol, email and text. In the case of physical messages that can include documents and/or records, such as physical messages received via postal mail, the messages can be converted to an electronic format using a method such as scanning or manual entry of the related data, and then processed. After converting the message to an electronic format, the message can be converted to an SSM by the ECS 10 and/or the application 246 for storage according to a user's selected security policy.

Prior to a transfer of data between, a message provider 102 and the ECS 10 and/or the user computing device 114, an authentication procedure may be implemented. To authenticate with a message provider 102, the ECS 10 or application 246 can use a method supported by the message provider 102, which can include, but is not limited to, authentication using a username and password, encryption-key-based authentication, authentication by security token, two-factor authentication, biometric authentication and/or use of a third-party standard, such as a Trusted Platform Module (TPM). In computing, TPM can be both the name of a published specification detailing a secure cryptoprocessor that can store cryptographic keys that protect information, as well as the general name of implementations of that specification, often called the “TPM chip” or “TPM Security Device” (as designated in certain Dell BIOS settings). The TPM specification is the work of the Trusted Computing Group. One version of the TPM specification is 1.2 Revision 103, published on Jul. 9, 2007. This specification is also available as the international standard ISO/IEC 11889.

In some embodiments, for messages containing certain types of data and/or for certain message providers 102, the utilization of the ECS 10 may be required. For instance, the message provider 102 may not allow certain messages to be transferred directly to a user computing device 114. In one embodiment, an application, such as 246, running on the user's device can be configured to determine whether a message transfer can be carried via a direct communication between the user's device and the message provider or if involvement of the ECS 10 is necessary, then the communications that need to occur via the ECS 10.

In one embodiment, the ECS 10 can be configured to broker a communication between a user computer device 114 where some portion of the interaction involves direct communications between message provider 102 and the user's computing device. The brokering of the communication can involve setting up a secure communication channel between the message provider 102 and the user computing device 114 and verifying to the message provider 102 that the ECS 10 has authorized the communication between the message provider 102 and the user computing device 114. In other embodiments, the ECS 10 can act as intermediary between the message provider 102 and the user computing device such that all of the communications are routed through the ECS 10 and the user computing device 114 does not directly communicate with the message provider 102 but instead communicates with the message provider 102 via secure communication channel established between the ECS 10 and the message provider 102. As previously described, when a direct communication between the user computing device 114 and the message provider does occur and a message is downloaded directly to the user computing device 114, the application on the user's computing device 114, such 246, can be configured to push downloaded data to the ECS 10 for storage and/or additional processing purposes.

For a direct communication between a user's device, such as 114, and the message provider 102, the access privileges that are provided to the application 246 can depend upon the functionality of the message provider 102. In various embodiments, the access privileges can include full access or limited access to a particular set of data only. Also, for a direct communication between a user's device, such as 114, and the message provider 102, the access privileges provided can also be limited according a user's account settings.

The ECS 10 and/or application 246 can use a protocol agreed upon by the message provider 102 and the ECS 10 to locate and retrieve data. To prevent eavesdropping or tampering, retrieved data can be transferred via a secure, encrypted method, such as SSL, PGP or another encryption protocol. The data can be in any of a number of formats—including, but not limited to, PDF, image formats, XML and raw data—some of which can be parsed and some of which cannot. If the user has only physical copies of financial documents and/or records, the system can capture these via any of a number of methods, including, but not limited to, scanner, camera or another method of electronic reproduction, or by manual input.

After receiving messages including data, which can be in the form of documents or raw data, the ECS and or the application 246 can be configured to parse the downloaded message data and if possible, organize it into a regular, normalized format, and stores it in a database or other storage mechanism, such as 210 or 244. For instance, in one embodiment, if the user has bank accounts with three different banks that provide account statements in three different formats, the ECS 10 and/or the application 246 can be configured to generate a statement for each of the bank accounts in a common format based upon the account data from each of the banks. The ECS 10 and/or the application can also be configured to generate a consolidated statement using data from each of the three bank accounts. If the data cannot be parsed, the ECS 10 and/or the application 246 can be configured to store it as-is and categorize it appropriately. In one embodiment, the ECS 10 and/or the application 246 can also be configured to prompt users for categorization data, which can be associated with a file and stored as metadata with the file. If desired, the application can be configured to allow users to create physical copies of financial documents and/or records using methods such as printing and faxing.

To improve the user's ability to access desired data, the ECS 10 and/or application 246 can provide a number of data organization and access capabilities. Categories, labels and keywords can be applied to particular segments of data—such as to particular transactions, sets of transactions, individual financial documents or records, or dates or sets of dates—to organize data in a hierarchical or non-hierarchical fashion. Categories, labels or keywords might include transaction type, transaction recipient, transaction purpose, account association or payment status. Further, an adaptive algorithm can be applied, based on criteria such as the activity of the user, to automatically assign categories, labels and keywords to incoming data.

In one embodiment, a drag and drop interface can be provided that allows users to manually sort their data into various categories or the interface can be configured to receive a manual input of categorization data for a particular file. In another embodiment, a specific method of categorization can be specified in an electronic delivery agreement with a particular message provider based upon a selected user preference such that messages received from that message provider are categorized in a particular way. In yet another embodiment, the user can specify category information that can be used by the ECS 10 to automatically categorize files for them. In one embodiment, the ECS 10 can allow the user to categorize and later retrieve messages based upon a characteristic sender. For instance, messages can be categorized as being from a friend, family, a professional acquaintance, a particular category of service provider or a member of a user-defined group.

Other types of metadata can also be used for categorization purposes, such as notes on a particular segment of data or payment confirmation codes. Further, any segment of stored data can be linked and associated with any other segment of stored data to indicate a connection, such as matching credits and debits on two separate accounts, or a payment receipt's association with its account transaction. Other related documents can be captured by the user via any of a number of means, including, but not limited to, scanner, camera, email, Web services and download; and these documents can likewise be linked to other stored data and have metadata associated with them. For instance, a user can take a picture of a receipt that is then linked to a transaction in a bank statement or credit card report. When the transaction is displayed in a document, a selectable link may allow the picture of the receipt to be displayed or when the receipt is display a selectable link may allow the transaction to be displayed. A search that locates one of the linked items may also display the other item.

To access particular desired data, the ECS 10 or the software application 246 can be configured to allow users to specify sorting, filtering and search criteria. Sorting could be performed by one or more criteria, such as date, amount, source, recipient or any other metadata fields. Filtering and searching can be performed by specifying specific values or sets of values for any one or more of the same set of criteria used for sorting. The application can also be configured to allow users to retrieve portions of a financial document or a data set. For instance, the user could specify the retrieval of the first three pages of all documents in a particular month. When a desired set of data has been retrieved, the system can be configured to allow a custom report to be generated.

In a particular embodiment, as a typical financial document and/or record in electronic form may not be acceptable as an original record to banks, the U.S. Internal Revenue Service and other organizations, the ECS 10 can include a method of securely verifying electronic documents and data as valid and original. This method could include, but is not limited to, applying a cryptographic hash function to the data and attaching the resulting hash to the financial document or record or other data. Each user issuing financial documents and/or records would be issued a digital signing certificate, encrypted using a private encryption key and verified by a certificate authority. The recipient of a financial document and/or record or other data with such a cryptographic hash attached would use a public encryption key provided by the originating user to verify the validity and originality of the data. In one embodiment, verification can involve storing and formatting financial data in a proprietary format. For example, a verifiable data template can be provided by the ECS 10 that allows any bank's transaction data to be converted in a common format which is authenticatable and accepted as a valid statement.

### Financial Transactions Involving the ECS

FIG. 8 is a block diagram showing communication involving financial transactions generated via ECS 10. In 226, the client software 216 running on the user's computing device 114 can send a request send a message to the distribution control and UI component 214 to initiate a payment from one or more specified accounts to a designated recipient, such as 266. The distribution control and user interface component 214 can authenticate the request and then in 274 passes it to the payment control component 260. The payment control component 260 can then authenticate the request and then in 276 send the request to the appropriate bank server, such as 112, via the bank server's payment interface 262, using a communication protocol supported by the bank server 112. Next, in 280, the bank server 112 can process the request and initiates the payment process from the specified account(s) 264 to the specified payment recipient 266.

In 278, the bank server 112 can return a confirmation of payment process initiation to the ECS 10. The response capture component 214 can receive the confirmation and in 232, can forward it to the storage control component 208 for storage. Upon receiving the confirmation, the storage control software 208 can parse, process and/or store the confirmation in the message store 210. In 272, the distribution control and UI component 214 can request a confirmation of payment from the access control software. In another embodiment, when the confirmation is received it can be automatically forwarded to 214 for distribution. The access control component can authenticate the request and in 270, return the recently captured confirmation of payment initiation to the distribution control and user interface software 214. The distribution control and user interface component 214 can send in 268, the captured confirmation of payment initiation to the user's computing device 514 when the user next accesses the ECS 10. Then, information regarding the confirmation can be displayed on the user computing device 114, such as via the client software 114.

In one embodiment, the payment recipient 266 can return, in 232, a confirmation of payment to the ECS 10 when the payment process completes. The response capture component 214 can accept the confirmation and forward it to the financial the storage control component 208. The storage control component 208 can parse, process and/or store the confirmation to the message store 210. In one embodiment, the distribution control and user interface software 214 can request any confirmation of payment via the access control component 212. The access control component can authenticate the request and returns the recently captured confirmation of payment completion in the message store 210 to the distribution control and user interface component, which can send the captured confirmation of payment completion to the user's computing device 114.

In one embodiment, upon receiving or viewing the payment confirmation(s), the user is given the option of storing the confirmation(s) in any other designated financial management applications, such as Quicken™ or Microsoft Money™, associated with the bill and the account from which the funds were withdrawn. As described above, in addition to paying bills, a scheduling system for monetary transfers between accounts, whether owned by the user or not, including tracking the progress of such transfers can be provided. The user can transfer money from any of the user's accounts to any other account. These transfers can be tracked to the degree that the user has information regarding the state of the originating and receiving accounts, and the account debit and credit are recorded as events within the system, along with their dates.

To complement the scheduling and bill payment system, an integrated method of delivering messages including financial documents and/or records to other users and non-users alike that can then be paid directly via the system can be provided. An advantage of this approach is that it may dramatically reduce bill and payment delivery times. Combined with confirmation of delivery and viewing of messages including financial documents and/or records, this service can allow users to closely track billing and payment. In one embodiment, the ECS 10 can be configured to deliver messages including financial documents and/or records and/or via postal mail. As with bill payments and monetary transfers, users can schedule messages including financial documents and/or records to be distributed to other users or non-users on a one-time or recurring basis. Recipients who are also users of the system can immediately pay directly through the ECS 10. Recipients who are not yet users of the system can be given an invitation and code to sign up for the ECS 10, and should they do so, can then pay directly via the ECS; otherwise, they can pay via mail or another payment service offered by the originating user.

In particular embodiments, the invitation can be a link that is selectable in an electronic form of the message. The code can be a numbers and/or letter sequence that can be entered electronically via an interface provided by the ECS 10. In another embodiment, a service can be provided that allows an entity to generate financial documents and/or records based on defined templates and structured financial data. The entity simply provides the template and data in a format specified by the service, and the service generates the document and/or record, which can then be delivered in one of a number of ways, including, but not limited to, electronically, via the software application, email or any other such method; and/or via postal mail.

### Data Transfer Between Two Devices Via the ECS

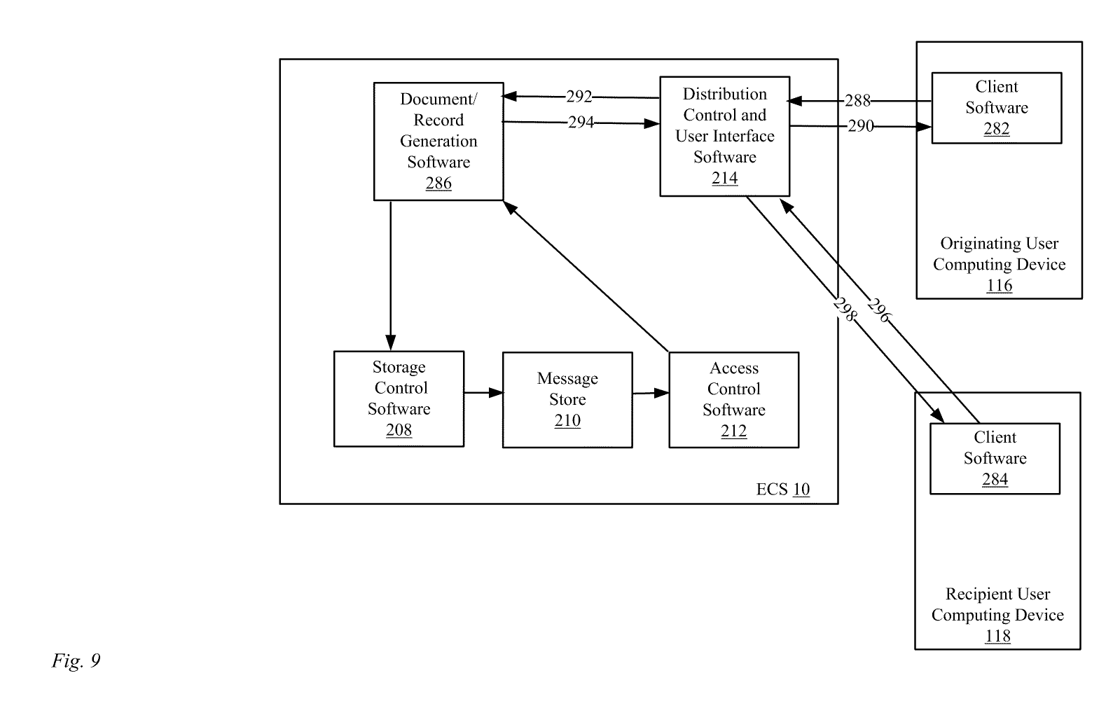

FIG. 9 is a block diagram showing data transfer between two devices, 116 and 118, via the ECS 10 for one embodiment. In particular, a method is described where a message, which can include financial data, is sent from a first user computing device 116 to a second user computing device 118. In this example, the first user sending the data can be considered message provider and the second user may be a client of the first user. In other embodiments, the ECS 10 can provide tools that allow two users that have accounts at the clearinghouse to simply share messages. The method can be generally characterized as proceeding as follows.

In 288, the client software 282 running on the originating user's computing device 116 can send a request to the ECS 10 to send one or more messages, which can include financial documents and/or records, to another user. The request might include the documents and/or records to be sent or the raw or structured data to be formatted into one or more documents and/or records, or might specify data stored at the ECS 10 to be formatted into one or more documents and/or records.

In particular embodiments, to initiate a delivery of a message, an ECS 10 may provide a separate account. This account can be separate from a user account where a user's financial data is stored and utilize different software. In other embodiments, it may be possible to provide a single account that allows users to initiate transfers of messages, such as messages including financial data, as well as to receive deliveries of the messages. However, the delivery capabilities for the single account may only be provided after an account upgrade or on a limited basis unless an account upgrade is received. For instance, unless an upgrade is received, a user may be able only to deliver a message to one user at a time whereas an upgrade may allow a user to perform a bulk delivery to multiple users.

The distribution control and user interface component 214 can receive and authenticate the request and in 292 forward the request to the document/record generation component 286. Based upon the request contents, the document/record generation component 286 can retrieve any necessary data from via an interaction between the storage control component 208, message store component 210 and access control component 212. Then, the document/record generation component 286 can generate a message, which can include financial documents and/or records. The document/record generation component can include documents and/or records in the form received from the message store 210 or can generate a document or record in a new format according to parameters sent in the request in 292.

In one embodiment, the document/record generation component 286 can send the generated message to the storage control component 208 for storage in the message store 210, which stores the message for the recipient, and then in 294 send a message to the distribution control and user interface software that a new message is available to the recipient 118. In other embodiments, multiple recipients can be targeted.

In one embodiment, if the recipient is already a user of the ECS 10, then the distribution control 214 may notify the user that a new message available according to the preferences of the user. In another embodiment, if the recipient is not a user of the ECS 10, then in 298, the distribution and control 214 can send a message, which could be an electronic message, such as an e-mail or text, with an invitation to register at the ECS 10 to receive their message. In yet another embodiment, in 298, the distribution control 214 can send a message to the recipient user device 218 that includes all of the message data associated with the message and possibly an invitation to join the ECS 10.

Where possible, the client software, 284, running on the recipient's computing device 118 can send in 296, a confirmation of a download and/or viewing of the sent message to the ECS 10. The message can also include a link that when selected allows in 296 an acknowledgement of receipt of the message to be sent to the ECS 10. The distribution control and user interface component can deliver any confirmation of download and/or viewing of the financial documents and/or records to the originating user via the client application 282 running on the originating user's computing device 116.

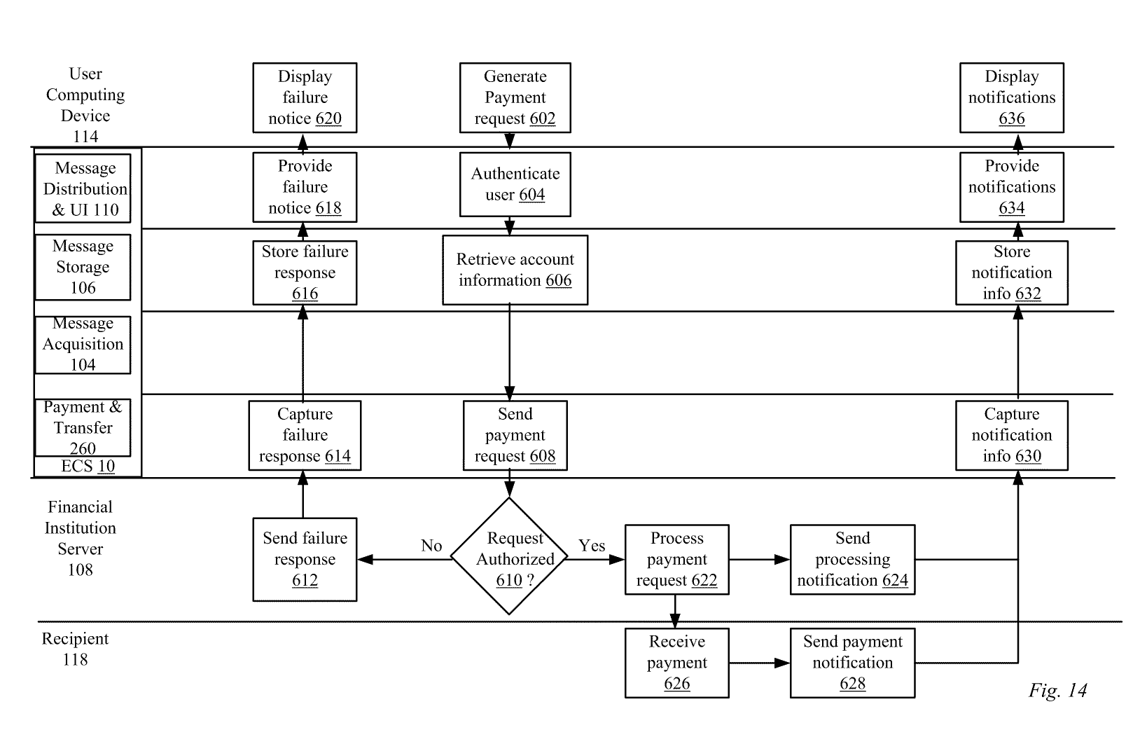

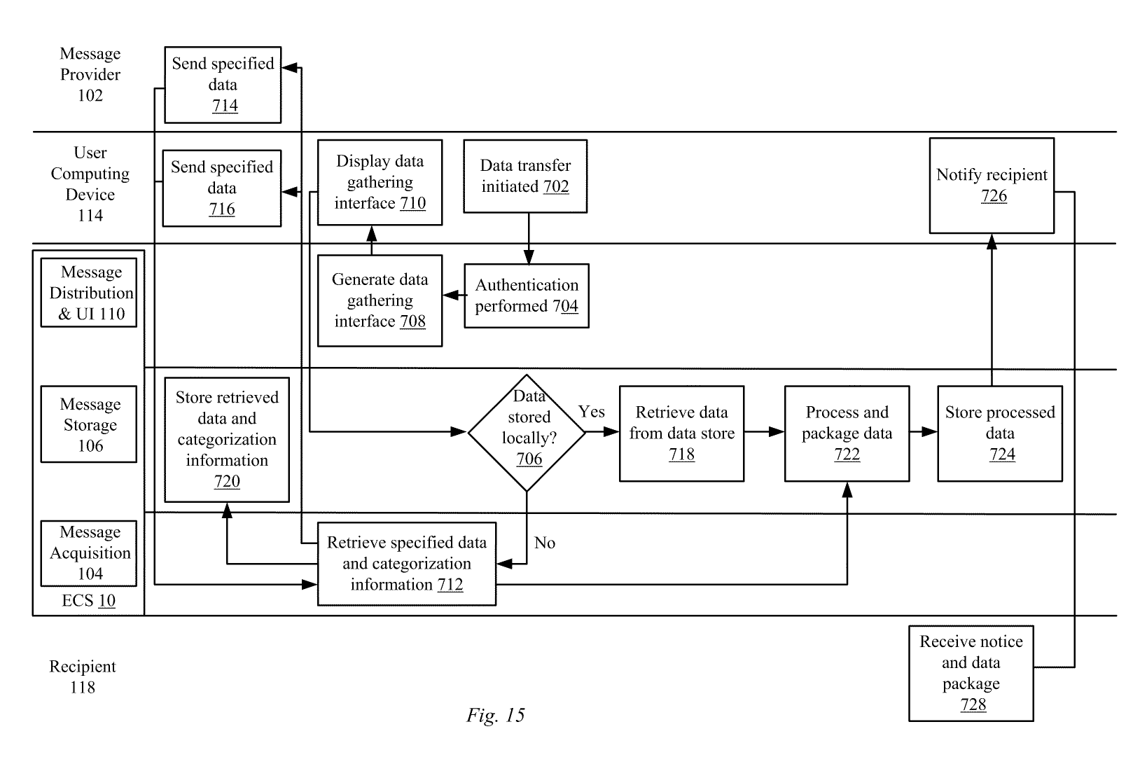

Further details of the interaction between components of the ECS 10 and various external devices are described as follows with respect to FIGS. 10-15. In particular, processes involving registration and the initiation of message delivery via the ECS 10 are described with respect to FIGS. 10-12. With respect to FIG. 13, the interaction between the ECS 10, a user computer device and a message provider during message delivery is described. With respect to FIG. 14, further details of a payment process involving the ECS 10, a user computing device 114, a financial institution server 108 and a recipient 118 are described. Finally, a method of retrieving data and assembling it into a data package for delivery to a recipient that is initiated by a user of the ECS 10 is described with respect to FIG. 15.

### Registering a New Account at the ECS

FIG. 10 is an interaction diagram between a user computing device 114, a message provider 102, and components of the ECS 10 involving registering of a new account at the ECS 10. The registering of the new account at the ECS 10 can include creating one or more electronic vaults for securely storing data. In one embodiment, as described above, a user can register for a new account at the ECS 10 when the user navigates to a web-site provided by the ECS 10 via device 114. In another embodiment, as described in more detail with respect to FIG. 10, the registration process for establishing a new account at the ECS 10 can be initiated when a user, via device 114, navigates to a web-site provided by a message provider 102. In one embodiment, the initial registration process can begin after the user accesses an account maintained by the message provider 102, such as a previously established account requiring at least some type of unique information, such as an account identifier and a password, to access the account. The account maintained by the message provider is separate from the ECS user account. In another embodiment, the registration process can begin prior to a user providing the message provider account information and having this information verified (i.e., verification that the message provider account information is associated with an authentic message provider account).

In 602, the message provider device 102 can generate an option for delivery of messages from the message provider as performed by the ECS 10 that can be output to a display coupled to the user device 114. The messages that can be delivered may vary depending on the nature of the message provider. Typically, the messages can include information related to the relationship between the user and the message provider. For instance, if the message provider is a bank, then the messages can relate to their bank account, such as account statements, privacy notices and any loans with the bank. As another example, if the message provider is associated with an employer, then the information to be delivered can be related to W-2's, 401K's, payroll records and other employee benefits. In yet another example, if the message provider is a health insurance provider, the information can relate to notifications of received benefits associated with their insurance.

In 604, the ECS 10 delivery option can be displayed on device 114. The delivery option may allow a user to select one or more different types of messages to be delivered. For instance, the user may be able to select one or more of messages with account statements, account notifications (e.g., payment due or payment received), privacy notices and general messages (e.g., special offers) to be delivered via the ECS 10. Prior to signing up with the ECS 10, this information may have been delivered by postal mail. If they were available electronically, the user may have had to login into a site provided by the message provider to access and download the information.

In 606, the user can select the delivery of messages via the ECS 10, which may include a selection of types of messages to be delivered via the ECS 10, as well as other selectable options, such as a security policy to use for delivery and message storage, and where the messages are to be stored (e.g., the user device 114, the ECS 10 or a combination thereof). The user selected options can be stored as part of a delivery agreement between the user, the message provider and the ECS 10 where the delivery agreement defines parameters associated with the delivery of messages from the message provider agreeable to both the message provider and the user of the ECS 10. Unique delivery agreements can be established for each relationship between a user and a message provider that the user wishes to have supported by the functions of the ECS 10. The unique delivery agreement that is instantiated can be stored in 614 as part of the account and user information.

In 608, the device 102 can generate an interface that provides the option to initially register with the ECS 10 to establish a new account or to access an account previously established with the ECS 10. In 610, the options to initially register a new account or login to an existing account at the ECS 10 can be displayed on the user device and then the user can select to register a new account with the ECS 10. The selection of the new account option can result in a message being sent from the user device 10 to the ECS 10. In 612, the ECS 10 can receive the registration request for an account. In 612, component 110 can send a message to component 104 to instantiate a new FDC account in 614. In 614, component 104 can create the new FDC account. The account creation may involve generating a unique account identifier, creating a location in a database for storing account information and allocating memory for storing the account data, such as messages delivered into the account. In 614, component 106 can receive and store information associated with the new account.

The registration request received in 612 can include information that allows a secure communication link to be established between the user device 114 and the ECS 10. The parameters of the secure communication link can be related to a security policy selected by the user for the new account. In 616, component 110 can generate a new account FDC registration interface that can be displayed on the user computing device 114. In 618, the FDC registration interface can be displayed on the user device 114 and the user can input information that is to be associated with the account, such as selecting an account name and password, or any other additional information that allows the account at the ECS 10 to be established.

In one embodiment, via the interface on device 114, a user can input account information, such as an account number and an account password associated with message provider 102 that can be verified by the message provider. The account number and the account password can be for an account maintained by the message provider which is independent of the account maintained for the user at the ECS 10. In one embodiment, the account number and an account password may allow the ECS 10 to access an outside interface provided by the message provider 102 that allows a user to access their account information. The account information may also be used to verify whether the user has a relationship with the message provider. If the user had already provided the account information to the message provider and it has been verified by the message provider prior to choosing a delivery option via the ECS 10, then the message provider may have already sent the message provider account information and the fact that the account information has been verified by the message provider to the ECS 10. For instance, the information can be sent from the message provider 102 to the ECS 10 in 608 after the user requests the delivery request in 606. Advantages of this approach are that 1) the user may not have to manually enter their message provider account information and 2) the possibility of the user mistakenly entering their information can be removed. When the user manually enters their relationship information with the message provider, such as an account number and a password, then the ECS 10 may contact the message provider to request that the message provider 102 determine whether the user entered information is representative of a valid relationship between the message provider and the user.

In 620, at the ECS 10, component 104 can receive the account information and send it to component 106 for storage. Next, the ECS 10 can determine that the account registration confirmation has been successfully completed. In 622, component 110 can generate one or more confirmations indicating the new account has been successfully established. The confirmation can include information, such as information associated with the account and functions that are to be performed by the account. For instance, the confirmation can indicate an account name or identifier for the account at the ECS 10 and indicate functions the ECS 10 has been set-up to perform, such as 1) to deliver account statements from the message provider once per month into the user's account at the ECS 10, 2) to deliver account notices associated with the message provider when they become available into the user's account at the ECS and 3) to notify the user of new messages available at the ECS 10 by sending a message via one or more different communication channels, such as an e-mail to an e-mail address provided by the user, a text message to a phone number provided by the user or an automatic voicemail to a phone number provided by the user. In 624, the confirmation message can be displayed on the user computing device. A confirmation message can also be sent to the message provider, which is received in 626.

In 628, the component 110 can generate a message provider registration and management interface. The message provider registration and management interface can be configured to allow a user to add additional message providers to their account at the ECS 10. Additional details of adding new message providers are described as follows with respect to FIG. 11. Further, the interface can allow a user to manage their current message providers at the ECS 10. For instance, the interface may allow a user to change delivery options for a current message provider, delete a current message provider from their account, view a delivery schedule of messages that are be delivered by the ECS 10 (e.g., will deliver account statement on a first date and will deliver W-2 on a second date) and view a delivery history of messages that have been previously delivered by the ECS 10. The message provider registration and management interface can be displayed on the user computing device in 630.

In particular embodiments, after a user is registered, a “profile” can be established for the user. The profile can include a unique identifier, such as the user's system username, a unique number or some other form that can be chosen by the user or generated automatically by the system. The profile can also include other information such as the user's name, contact information and any other relevant data regarding the user and the unique identifier can be constructed from a combination of such information. The unique identifiers may or may not be published for access by other users to maintain privacy. In one embodiment, the user can selectively hide portions of this information from others, and even hide his or her profile completely.

In one embodiment, the ECS 10 can be configured to allow users to give out their unique identifiers so that other parties can send them data and documents. The other parties can be message providers, other users with accounts at the ECS or even entities currently not associated with the ECS 10. When another party wants to send a user some data or document or request data from the user, that party can enter the user's unique identifier into an ECS system interface and then indicate that they want to send or receive data to the user associated with the unique identifier. If the party wishing to send or receive a message is not yet a user of the ECS 10, the system can be configured to ask them to join.

In one embodiment, the system may require him or her to sign up before being allowed to send the message to the target user. Once the party has become a user as necessary and logged into the ECS 10, they can upload the message to be sent, whether it be simple textual data entered directly or one or more files, and it can be securely transmitted to the receiving user's account. The recipient may be notified of the new message when they next log into the ECS 10 or may receive notification via an alternate means. For instance, the recipient can be notified of the availability of the data by email, text message, phone call or another method, depending on the user's selected preferences.

In one embodiment, users can specify the group of users from whom they will accept transmitted messages. For example, they can choose to accept transmissions from (a) all users, (b) verified users only, or (c) selected users only. In addition, as there may be a graduated scale of verification, users can choose only to accept transmissions from users above a certain level of verification. For instance, the users may wish to only accept messages with users with a user validation score that meets a particular threshold value.

In one embodiment, the system can be configured to use one-time unique identifiers, generated by the system. The one-time unique identifiers can be used to enforce access control and allow users to request data without revealing their usernames. In this case, the user of the ECS 10 wishing to receive data can request the system to generate a one-time identifier. Then, the identifier can be given to the provider of the data. The provider can then use the one-time identifier, in the manner laid out above, to send data to the user. Once the transmission has been completed, the one-time identifier becomes invalid and cannot be used again.

In general, a user can request a temporary unique identifier associated with the user's account that is valid for a single transaction, multiple transactions or a limited time period. This approach can be used to enable a user to establish a temporary relationship with a party. If a user wishes to establish a permanent or ongoing relationship with the party, then the party can be added to the user's account as a message provider in the manner described as follows with respect to FIG. 11.

The requested temporary unique identifier can be provided to other parties from which the user wishes to receive data and/or documents on a limited basis. The temporary unique identifier can be associated with a permanent unique identifier for the user's account. The clearinghouse system can be configured to check the validity of the temporary unique identifier each time a document or data, including the temporary unique identifier, is received. If a temporary unique identifier is no longer valid, then the document including the temporary unique identifier may not be loaded to a user's account. In some embodiments, a user can be shown documents received that include expired temporary unique identifiers. The sender of a document with an expired identifier may or may not be notified. Next, with respect to FIG. 11, a method of adding a message provider to user's account is described.

### Adding Message Providers to an ECS Account

FIG. 11 is an interaction diagram between a user computing device 114, a message provider 102 and components of the ECS involving adding a message provider to a user's ECS account. As described above, a message provider registration and management interface can be generated on the user device 114 for this purpose. The registration of a message provider to a user's ECS account may allow messages from a particular message provider to be delivered into the user's account at the ECS 10. In particular embodiments, the message provider account registration process can be initiated from the user device 114 after a communication session is first established between the user computing device 114 and the ECS 10 or after a communication session is first established between a user computer device 114 and a message provider device 102. For instance, as described above with respect to FIG. 10, a user with an existing ECS account may navigate to a message provider site that offers an ECS delivery option and then, after the delivery option is selected, the registration of the message provider at the message provider site can begin.

In one embodiment, in 302, at the user device 114, a user may navigate to a site associated with a message provider outside of the ECS 10. Then, the user can initiate a process to register the message provider with the ECS 10. The registration may be allowed because ECS 10 and the message provider 102 may have entered into an agreement that allows ECS 10 to provide message delivery services for them. In another embodiment, in 304, the user may navigate to the ECS 10 site and then request to initiate a registration of the message provider with the ECS 10 to allow delivery of messages from the message provider 102 into the user's ECS account. In 306, when a user initiates a request to register a message provider, a message can be sent to the message provider indicating that this process has been initiated.

At some point, while registering the message provider, the user may be asked to provide information that allows their relationship to the message provider to be authenticated. For example, in one embodiment, the user may have navigated to the message provider site and entered an identifier associated with an account at the message provider and provided verification information that allows their association with the account to be verified by the message provider as shown in 308. Afterwards, the user can attempt to register the message provider with the ECS 10. Since the user's association with the account has been verified, the message provider 102 can send information to the ECS 10 indicating that the account information is associated with a valid account and provide the account information so that the user doesn't have to reenter. In 310, the ECS 10 may receive account and account verification information from the message provider 102. This information may confirm that the account is a valid account and may be sufficient to allow the ECS 10 later access the account.

In another embodiment, the user can attempt to first register the message provider at the ECS 10, i.e., via the ECS 10 site as opposed to first going to the message provider site, and then the user can provide, in 310, account information and account authentication information, such as a password and/or answers to challenge questions, that allow the relationship between the user and the message provider to be verified as well as information associated with the relationship, such as message containing account information, to be obtained by the ECS 10. In one embodiment, after receiving the account information and the authentication information, the ECS 10 may attempt to contact the message provider to determine whether the account and the account authentication information are valid.

When message provider information is received, the user may also provide categorization information about the message provider. The categorization information may allow the user to organize their message providers at the ECS 10. For instance, via the interface to the ECS 10 a user may be able to sort, search and view information, such as SSMs, based on the message provider categorization. As an example, categorization information may include information about the user's relationship to the message provider, such as a family member, a friend, a professional acquaintance or a service provider (e.g., bank, utility, cell phone, etc.).

In 312, after the registration attempt, a user validation score can be generated. In one embodiment, the user validation score may provide some indication of that identity that a user presents at the ECS 10 is their identity. Details of calculating the user validation score are described in more detail below with respect to FIGS. 18 and 19. In 316, information associated with the user validation score and information associated with the newly registered message provider can be stored. In 318, if data is to be regularly retrieved from the message provider, then an initial retrieval schedule can be generated. For instance, the initial schedule might indicate the ECS is to retrieve account data daily and then account data used to generate an account statement once a month. In 320 and 322, in one embodiment, the ECS 10 can send a message regarding the initial data retrieval schedule one or more both of the message provider and the user device, respectively.

In 324, the ECS 10 can store the determined scheduling data associated with the newly registered message provider. In 326, the ECS 10 can generate a confirmation message indicating that the message provider 102 has been added to the ECS user's account. In 328 and 330, the ECS 10 can send a confirmation to one or both the user device 114 and the message provider 102 indicating the message provider has been successfully added to the user's account. The ECS 10 may also send a message to the user device 114 and/or the message provider 102 if the message provider 102 is not successfully added. For instance, the message provider may not be added if the ECS 10 is unable to determine that the user has a verifiable relationship with the message provider 102.

### Registration and Message Delivery Examples

Next a few examples of registering message providers with the ECS 10 and then subsequently delivering messages from the message provider are described in more detail as follows. An employer is a first example of a message provider that a user of the ECS 10 can register. Via the ECS 10 an employer can distribute messages including information related to earnings statements, pay advices, W-2's, benefit notices, employee discounts, employee coupons and other such documents (hereinafter collectively referred to as employee pay records) to employees. Further, the ECS 10 can be enabled to allow the employee to send messages to their employer, such as messages including W-4's, time reports, benefit notice response, etc.

In this embodiment, a payroll service provider or the accounting department of a business can sign up as a message provider at the ECS 10 before any users at the ECS have designated them as a message provider. Then, a list of employees who can receive employee pay records via the ECS 10 and means of contacting the employees can be sent to the ECS 10. For instance, a list can include employee e-mail addresses that can be used to contact the employees. Next, the ECS 10 can invite each employee on the list to sign up to receive employee pay records electronically delivered via the service. For instance, the ECS 10 can send an e-mail with a link to a web-site that allows the employees of the company to sign up. In one embodiment, the link can lead to a customized interface, such as an interface including information about the business that has signed-up for the delivery service.

In one embodiment, a batch of employee pay records for the employees who have signed up for the delivery service can be received at the ECS 10. The pay records can be received as raw data that is formatted into a document such as a pay-stub for delivery or can already be received in a format that is ready for delivery. Next, the ECS 10 can deliver the employee pay records to the accounts of those employees who have signed up for the service. The ECS 10 can then notify said employees that they have employee pay records ready for viewing.

Any employees who have not yet signed up for the service can be simply notified that they have the option of receiving their employee pay records via the clearinghouse service, and can be invited to sign up. For instance, this information can be printed on pay-stubs that are delivered using a method other than the ECS 10. When subsequent employee pay records are available for delivery, the cycle repeats—employees who have signed up receive their employee pay records via the ECS 10, and employees who have not yet signed up are invited to do so. In this way a payroll service provider or accounting department can save the cost of printing employee pay records for those employees who receive their employee pay records via the ECS 10. Further, said employees can be relieved of the burden of visiting a Web site provided by a payroll service provider or employer to manually retrieve employee pay records, instead being able to use the ECS 10 to retrieve and deliver their employee pay records and a wide variety of financial data in one centralized location. In some embodiments, the ECS can provide extended or even permanent storage of the documents for the benefit of the employee and employer.

In particular embodiments, a digital signature can be generated for the employee pay records when the ECS 10 retrieves and delivers them. The signature can be generated on an encrypted and/or unencrypted data set. The digital signature may be used to later authenticate the validity of a pay record. For instance, the employee can provide a copy of the pay record to a third-party, such as a loan originator. Then, the loan originator may request the ECS 10 to verify the authenticity of the copy. In one embodiment, the ECS 10 can be configured to perform this verification using the digital signature that was created when the pay record was retrieved. Besides generating a signature, the ECS 10 may send a notification to the employer that the pay record was delivered into the employees account at the ECS 10.

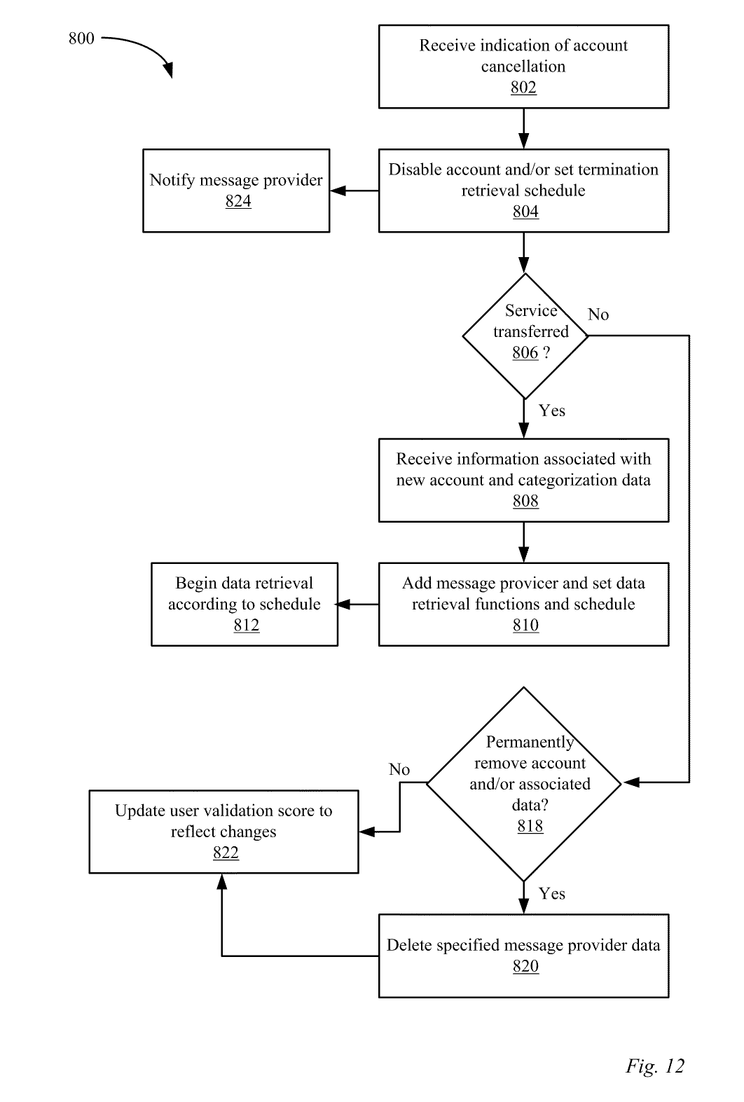

In another embodiment, the ECS functionality can be extended to include health care data—a term that can include but is not limited to, personal historical medical records, test results, treatment regimens, prescriptions, diets, doctors' advices, medical invoices and insurance invoices. In this case, the ECS 10 can retrieve and deliver health care data from a health care data provider, similar in function to the way data is retrieved from other message providers, such as financial data from a financial data provider. Health care data providers often have different protocols for authentication and data access, such as protocols specified in government regulations. These protocols can be implemented by the ECS, in compliance with federal and state laws and regulations. Next with respect to FIG. 12, a method of removing a message provider from the user's ECS 10 account is described.

### Removing a Message Provider and Terminating a Delivery Agreement

FIG. 12 is a block diagram of a method 800 in the ECS 10 involving removing a message provider from a user's account at the ECS 10. There are different cases where a user may choose to terminate a message provider relationship at the ECS 10. As an example, when the message provider provides a service to the user, the user may wish to terminate the relationship because the user no longer wants to receive the service provided by the message provider. In another example, the user may want to change a similar service provided by two different message providers, such as two different cell phone carriers. In yet another example, the user may want to close their account with the ECS 10 and have all of their relationship information associated with each message provider removed.

In 802, the user may cancel his or her account directly with the message provider and then inform ECS 10 via an ECS account interface. After receiving this message, the ECS 10 may disable the functions associated with the message provider or provide some schedule for terminating the functions associated with the message. For instance, the ECS 10 may retrieve an account statement one last time from the message provider and stop retrieving data on a regular basis, such as daily, from the message provider after a specific date. In 824, the ECS 10 may notify the message provider that the relationship between the ECS 10 and the message provider has changed. For instance, the ECS 10 may notify the message provider that the user no longer wishes to receive statements electronically from the message provider.

In one embodiment, the ECS 10 may be configured to allow a user to cancel a relationship with a message provider via the ECS 10. For instance, the ECS 10 may receive an indication from a user that they wish to terminate a relationship with the message provider. In response, the ECS 10 can modify the message delivery arrangement with the message provider such that the delivery of messages from the message provider will eventually stop. Further, the ECS 10 may notify the message provider of the user's wish to terminate the relationship. In response to the termination notice, the message provider can perform functions on their end to terminate the relationship, such as closing out an account associated with the user.

In 806, the ECS 10 may check whether the user is transferring the relationship associated with the message provider to another message provider. For instance, the user can be switching cell phone carriers or Internet access providers. In the instance, where the user does not wish to transfer the relationship, in 818, the ECS 10 can be configured to prompt the user in regards to removing data associated with the message provider, such as all or a portion of account data or other types of data previously received from the message provider. For instance, the user could request the ECS to remove all information associated with the message provider older than some date, such as 6 months or a year ago. In 820, the ECS 10 can delete the specified data associated with the message provider. After message provider is removed and optionally a new message provider is added to the ECS 10, the user validation score can change. In 822, the user validation score can be updated to reflect the user's changes to their message providers.

When a user wishes to transfer a relationship from one message provider to another message provider, the ECS can add a new message provider in manner similar to what was described above with respect to FIG. 11. For instance, in 808, the ECS 10 can receive information associated with the message provider, such as account information and information that allows a user's relationship with the message provider to be verified. In addition, the ECS 10 can receive categorization information associated with the message provider. In 810, the ECS 10 can add the message provider and set data retrieval functions, such as a schedule associated with data retrieval from the message provider. In 812, the ECS 10 may begin the determined functions with the message provider, such as retrieving messages according to the specific schedule.

### Message Retrieval Via the ECS

FIG. 13 is an interaction diagram between a user computing device 114, a message provider 102 and the ECS 10 including message retrieval from the message provider in accordance with the described embodiments. In 402, the ECS 10 can determine that message retrieval is needed from a particular message provider. In 404, the ECS 10 can determine retrieval parameters associated with the message retrieval. For instance, the message retrieval might involve retrieving account activity over a particular time period, such as the past day or the past week. In another example, the message retrieval might involve retrieving data associated with an account that allows a monthly account statement to be generated. Some of these retrieval parameters may be specified in a delivery agreement previously established between the ECS 10 and the message provider. The retrieval parameters may also include information needed to establish a secure connection with the message provider and information needed to obtain information from a message provider site, such as a script including a number of steps needed to retrieve the data from an external interface provided by the message provider.

In 406, the message data can be retrieved according to the determined retrieval parameters. For instance, a communication can be established between the ECS 10 and the message provider 102 and in 408, the message provider can send message data to the ECS 10. In 412, the ECS 10 may optionally store a portion of the message data in a raw or unprocessed format. For instance, the message data may include a document that can be encrypted for storage but is not otherwise altered. In 410, the ECS 10 may optionally process the message data. For instance, the ECS 10 may change the message data received in one format to another format for storage. In another example, the ECS 10 may create a document, such as a document including an account statement, based upon the received message data. In 412, the ECS 10 may store the processed message data. The processed message data can be store to an electronic vault associated with a user that is the intended recipient of the message. As described above, data can be stored to an electronic vault in an encrypted format.

In 422, the ECS 10 may update a user validation score in response to successfully retrieving data from the message provider (e.g., see FIG. 19). In 416, the ECS 10 may generate notifications that a message has been successfully retrieved from the message provider. The user device 114 and the message provider 102 can receive a message indicating that the message has been delivered in 418 and 420, respectively. A digital signature of the message can be generated and stored with the message in a user's electronic vault where the digital signature can be used to later verify an authenticity of the message if desired.

In particular embodiments, the ECS 10 can retrieve new messages from specified message providers as soon as is feasible after the messages are made available by the message providers. To accomplish this, ECS 10 can keep a record in its memory of future availability times for messages. These availability times may be published by the message providers. The ECS 10 can then initiate a retrieval cycle on a regular basis—possibly once a day or once an hour, but not limited thereto—by checking the availability times for message provider and determining, as needing retrieval, any message providers with available data. The ECS 10 can then proceed to retrieve all the available messages. In particular embodiments, the ECS 10 may begin with the messages that have been available the longest or according to some other priority scheme. When all available messages have been retrieved from a given message provider, an indicator can be stored to indicate that the scheduled message retrieval has been completed for the particular message provider. If any data cannot be retrieved for any reason, such as an unreachable server, despite repeated attempts, the ECS 10 may skip it, leaving the message provider marked as needing retrieval. Later, the ECS 10 may return to it at a later time to retry, possibly during the next retrieval cycle. If messages cannot be retrieved from a particular message provider for a specified period of time, the system can inform the user, system administrator and/or data provider of this fact.

An example of a message retrieval process that can be implemented at the ECS 10 can involve one or more of the following steps: (1) providing a database storing data availability times for a number of message providers; (2) initializing a data gathering process where data is retrieved from all or a portion of the message providers at a first time in the day (from each data provider, data can be gathered for multiple ECS 10 users); (3) during the initialization of the data gathering process, marking all or portion of the message providers as needing data retrieval (when data is gathered, the status of each data provider can be changed such that it is no longer marked as needing data retrieval); (4) for each of the data providers in the database, determining data is available at a particular time and whether the data has already been gathered for the message provider during some current time period; (5) when the data is available at particular time and has not already been gathered, gathering the data and storing an indicator that the data has been gathered for the particular message provider; (6) advancing to a next time (e.g., in one-hour intervals) and going to step 4 until all the messages have been retrieved from all or a portion of the message providers; (7) storing an indication of whether there were any message providers from which data could not be retrieved (the indication can include a reason the information was not gathered, such as an in-operational computer or a network problem); and (8) optionally, notifying any affected users that it was not possible to gather data from a particular data provider.

### Effecting a Payment Via the ECS

FIG. 14 is an interaction diagram between a user computing device 114, a recipient device 118, a financial institution server 108 and the ECS 10 involving a payment. In 602, via an interface provided by the ECS 10, the user can initiate a payment request via a message provider account registered at the ECS 10, such as a bank account. In one embodiment, the payment details may have been incorporated into an SSM generated at the ECS 10 from a message provider. In 604, the ECS 10 may attempt to authenticate the user requesting the payment. The authentication attempt may require the user to enter a password or some other identifying information. In 606, when the user has been authentication, the ECS 10 can retrieve account information for an account that is to be used for a funds transfer. In one embodiment, the account can be associated with the financial institution server 108. In 608, the ECS 10 can send a payment request to the server 108 requesting a transfer of funds from the account associated with the financial institution.

In 610, the financial institution can attempt to authorize the request. The request may not authorized for some reason, such as if there are insufficient funds. In 612, the server 612 can generate and send a failure response. In 614, the ECS 10 can receive the failure response and capture it. Then, in 616, the ECS 10 can store all or a portion of the data associated with the failure response. In 618, the ECS 100 can generate a failure notice and then send it to the user at device 114. In 620, the device 114 can receive and display the failure notice.

In 622, when the request for payment is authorized, the financial institution server 108 can process the payment request and send payment to the recipient device 118, which could be another financial institution server. In 624 and 628, respectively, the server 108 can generate a notification that the payment was processed and the recipient can generate a notification that the payment was received to the ECS 10. In 630 and 632, the ECS can receive the notification information, capture it and store it. In 634, the ECS 10 may generate one or more SSMs including a notification that the payment has been sent and/or received and place them in an encrypted format in one of the electronic vaults associated with the user account that initiated the payment at the ECS 10. In 636, the user may access the new SSMs in the account such that the messages are opened and displayed on device 114. Next, with respect to FIG. 15, interactions that can occur when a user wishes to gather a package of data for delivery to another party are described.

### Assembling and Delivering of a Data Package

FIG. 15 is an interaction diagram between a user computing device 114, a message provider 102, a recipient device 118 and the ECS 10 involving assembling a data package for delivery to the recipient device 118 in accordance with the described embodiments. In 702, via an interface generated on the user device 114, a user can initiate an assembly of a data package. In 704, prior to beginning the assembly process the user can be authenticated, such as via the reception of information associated with the account assumed to be only known by the user. The assembly process can involve the user specifying types of data for the ECS 10 to gather, such as bank statements for the last year and pay stubs for the last 3 months. In 708, the ECS 10 can generate a data gathering interface for assembling the data associated with the data package. The interface can be displayed on the user computing device in 710.

Via the data gathering interface in 710, the user can specify a number of components of the data package that are needed. The components of the data package specified by the user can be sent to the ECS 10. In 706, the ECS 10 can attempt to determine whether a specified component is available at the ECS 10. For instance, if the user has specified an account statement associated with a message provider to be included with the data package, then the ECS 10 can check whether the specified statement is stored at the ECS 10. When the specified data is not available, the ECS 10 can be configured to retrieve the data via interactions with the user and/or message providers. For instance, in 712, the ECS 10 can send a message to a message provider asking them to send specific data or may go out and interact with an outside interface supported by the message provider to retrieve the needed data. As another example, in 712, the ECS 10 can send a message to the user requesting the user to manually enter or upload specified components of the data package, such as uploading a file containing their pay stubs.

In 714 and 716, data associated with the data package can be retrieved from the message provider 102 and the user device 114, respectively. In 712, if the data received from the message provider and/or the user device is being newly added to the ECS 10, then the ECS 10 can prompt the user via device 114 to enter categorization information for the data. In 720, the retrieved data and its associated categorization data can be stored at the ECS 10 for later use by the user. For instance, the retrieved data can be stored in one of the user's electronic vaults. Further, the retrieved data can be added to the data package in 722.

When the ECS 10 determines requested data for the data package is available, in 718, the ECS 10 retrieves the data from the ECS data store and adds it, in 722, to the data package. The retrieval of the data can involve locating a file including the data in one of the user's electronic vaults, locating a decryption key for the file and then decrypting the file using the decryption key. In 722, the ECS 10 may process the data gathered for the data package. In one embodiment, the processing can involve encrypting the data package with a particular encryption scheme in which it is to be delivered. In 724, the processed data package can be stored. In 726, the ECS 10 may notify the user that their data package is ready for delivery or has been sent out. In one embodiment, the data package may be delivered into an electronic vault associated with another user account at the ECS 10.

When the data package is placed into the electronic vault of the other user account, it can be encrypted such that it can be subsequently decrypted by the account holder of the other user account. In one embodiment, as described above, the electronic vault can be a shared vault that is accessible to two or more different ECS users. Besides being delivered into an account at the ECS 10, the data package can be delivered by another method, such as encrypted email, fax, courier, postal service or submission via a Web services interface. In 118, the recipient device may access the delivered data package. In response to accessing the data package, a notification can be sent to the ECS 10, which can then notify the user, such as by generating a message in their account that the data package has been received and accessed in some manner by the recipient.

In some embodiments, users can share their stored data rather than packaging it up for delivery to another user. An ECS interface can be configured to allow the user to select which documents and data should be shared and to which users they should be made available. This function can allow users, for instance, to share financial records with lending companies, audit agencies and the like, or to share relevant transactions with other individuals, as in expense reporting in an organization. Data shared by a user can be displayed on the user's profile, but may only be visible to those users who have been granted access to it. The sharing privileges might come with time limits that automatically expire after some period and may have to be renewed by the user. This feature may prevent a user from sharing data and then forgetting that it is currently exposed.

As an example, when a user stores a data package to one of their vaults, an interface can be provided that allows the user to specify which documents can be accessed and the users with accounts at the ECS that can access the documents. The users allowed to access a particular document can vary from document to document. After access privileges have been determined for a number of documents, a notification can be sent to the users that have been designated as having access to the documents. The notification might include links to particular documents. When a notified user attempts to access a particular document, such as via selecting a link, the ECS 10 can locate the decryption key needed to decrypt the document and then provide a copy of the decrypted document or at least provide access to the contents of the decrypted document to the notified user. In some instances, an encrypted copy of the document can be stored to an electronic vault associated with the notified user.

### Example of Data Retrieval and Delivery

In this section, features of the ECS 10 including some aspects of the interface 984 between the FDC 980 and SDN 982 are described. The interface 984 can vary depending on which functions are attributed to each of the FDC 980 and SDN 984. Thus, the descriptions are provided for the purposes of illustration only.

Tasks performed by the ECS 10 can involve retrieving and storing messages including information associated with a business relationship, such as a user's financial data for a business relationship with a bank. In one embodiment, a secure and structured message (SSM) can be generated that involves creating an electronic document using the retrieved data, delivering it in a secure manner to the user and then securely storing the message. To further illustrate the roles of the ECS 10 in these processes, an interaction involving data retrieval and delivery between a bank, the FDC and the SDN is described. A bank is one example of a message provider that can interact with the ECS 10. Thus, the example of a bank is provided for illustrated purposes only and is not meant to be limiting.

FIG. 16 is a block diagram showing examples of communications involving an ECS 10 and a bank system 902 in accordance with the described embodiments. A user of the ECS 10 can set up an account within the bank system 902 where the account information can be stored as one of many financial accounts 904 stored within the bank system 902. After a user sets up an account with the bank, access to one or more outside interfaces can be provided by the bank that allows a user to remotely retrieve information and manipulate their account at the bank. The outside interfaces can be part of the OFX and other technical services 908 provided by the bank system 902. Open Financial Exchange (OFX) is a communication protocol for exchanging financial information that evolved from Microsoft's open financial connectivity and Intuit's open exchange file formats. Other protocols including custom and/or proprietary communication protocols can be utilized to transfer data and OFX is provided for the purposes of illustration only.

In one embodiment, a bank provided outside interface, such as a web-based user interface, can be provided that allows the user to view account activity, view account balances and perform transactions, such as paying bills. The outside interface can be configured to display information on a user's computing device and receive input commands via the device that can affect the information displayed on their device. Further, via the outside interface, a user may be able to manually to download information that can be utilized in another program, such as a money management program. In one embodiment, as described in more detail below, a data retrieval agent 920 can be instantiated by the ECS 10 that can be configured to automatically retrieve data for a particular user using this type of interface. The ECS 10 can utilize account information, such as a user's account identifier and password to access the account in the manner that a user would access their information. As described in more detail below, after retrieval, the retrieved data can be formatted into an SSM and store in the SSM data store 930.

In another embodiment, the bank may provide a separate outside interface as part of 908 for automated retrieval of information by a separate computer system, such as that of the ECS 10. Such an interface will operate in a fashion supported and defined by the bank, by way of a published, known protocol that can be supported by the ECS 10. The data that can be retrieved and the actions that can be performed via the outside interface can be described in an API description associated with the outside interface. Thus, the retrieval of information via the outside interface can be referred to as an API call to the interface. This outside interface may not support a sophisticated user interface for viewing the data. Instead, the outside interface may provide data in some type of format that can be downloaded to a file and can be transferred to another application for manipulation, such as an application executed at the ECS 10.

The ECS 10 can use the outside interface provided by the bank to retrieve information, such as financial data, for a user with an account at the ECS 10. Different secure connectivity protocols (e.g. FTP/S, SFTP and HTTP/S) can be used in the retrieval process. Further, the retrieved data can also be encrypted and signed when it is sent.

In one embodiment, the FDC 980 can format the retrieved information as a secure and structured message (SSM). Then, using the SDN 982, the SSM can be delivered into the user's account at the FDC 980. Via an interface compatible with the ECS 10, such as an ECS 10-supplied client application installed on an individual's computer, a browser on a home computer or a browser on a mobile device (e.g., see FIG. 17), a user can view and/or manipulate information stored in an SSM. In particular embodiments, the SSM can be 1) structured in various formats, such as formatted as a monthly bank statement or formatted as a data set that is compatible with a money management program, such as Quicken™ by Intuit (Mountain View, Calif.), 2) stored in different formats, such as PDF, HTML or other) and 3) can be created with different layouts (e.g., a first bank may prefer a first layout for their statement while a second bank may prefer a second layout for their statement). The parameters used in the layout can be specified in an electronic delivery agreement established between the ECS 10 and the bank 902 and may also be personalized according to user preferences stored in the user profile. An example of these processes is described with respect to FIG. 16 as follows in the context of retrieving information, such as financial data, from the bank 902.

In one embodiment, a configuration store 910 that includes a database and a file system can be provided with the FDC 980. The configuration store 910 can include parameters and information that allows the FDC 980 to perform tasks, such as automatic message retrieval. All or portions of the data in the configuration store can be stored in an encrypted format. Thus, the FDC 980 can be configured to encrypt data in the configuration store and then subsequently decrypt it when it is needed to perform an FDC 980 controlled task. Toward this end, the FDC 980 can include capabilities for storing and managing encryption keys that allow the data in the configuration store to be encrypted and decrypted. The encryption keys can be created based on input from a user, such as a level of encryption to use. The configuration store 910 can include different types of data, such as but is not limited to 1) user profiles, 2) electronic delivery agreements, 3) accounts list and configuration data and 4) scheduled retrieval tasks. Details regarding the different types of data are described with respect to the following paragraphs.

The user profiles 912 in the configuration store can include information that allows actions carried out by the ECS 10 to be customized according to user preferences. The selected user preferences can be applied to SSMs generated by the ECS 10. In one example, a user may be able to specify that the ECS 10 store their retrieved data from the bank in a particular format or a number of different formats. For instance, the ECS 10 may allow a user to select a format that is compatible with a particular money management program or other external program and the ECS 10 can save the data in this format when it is retrieved from the bank. The formatted data can be encapsulated in an SSM.

As another example, a user may be able to specify an encryption key management strategy that is to be used by the ECS 10 to encrypt their data. For instance, the user may be able to specify that the ECS 10 is to encrypt their data with a first key from an encryption key pair where the second key needed to decrypt the data is not stored at the FDC 980 but rather on a device controlled by a user, such as their home computer, or on a device controlled by a third-party different from the ECS 10 that is designated by the user. In this example, the user may have to provide their encryption key to allow the data stored at the ECS 10 to be decrypted and/or manipulated. In one embodiment, a user may choose to store SSMs on their home computer and a client application executed on the user's home computer may be configured to decrypt data stored on their home computer. An SSM generated by the ECS can be encrypted based upon the key management strategy selected by the user.

In one embodiment, the ECS 10 can be configured to allow a user to select different key management/encryption strategies for different users. For instance, a particular key management/encryption strategy can be selected for a first user and a second key management/encryption strategy for a second user where different encryption keys are used for the different users. The different key management/encryption management strategies can be based upon a mutual agreement established between two users or between the user and the message provider in regards to what key management strategy to employ. Information regarding the particular key management/encryption strategy to use between two users or a user and a message provider can be stored in 912.

In yet another example, the ECS 10 can be configured to allow a user to choose settings that expose some of their account information to outside entities, such as information regarding business relationships that they have formed. For instance, the user may wish to let other users of the ECS 10 or other message providers with whom they have a business relationship, such as a particular bank, and details of the relationship, such as how long they have been a customer of the bank. In a further example, the user may be able to specify data tags and a naming convention that allows their data to be categorized and/or filed away in a file system associated with the ECS 10. The categorization information can be stored as part their profile in 912.

The electronic agreements can store information related to the retrieval and delivery of messages for particular message providers, such as banks, or between two users of the ECS 10. In the instance of the message provider, the electronic delivery agreements may specify information, such as but not limited to which customers are eligible for data retrieval services by the FDC, format requirements for converting retrieved data into a statement, delivery requirements, such as a frequency, etc. As described in the example of a bank, the formatting information can be utilized when a statement is created from the information retrieved from the bank's outside interface 908 via an automatic retrieval of information using a retrieval agent 920 or via an API call to an API maintained by the bank.

The accounts list and configuration data 914 can be utilized by the ECS 10 to access outside accounts associated with individual users. This information can be used to access outside interfaces associated with particular message providers for which a user has an established business relationship. For example, as described above, a user can establish an account with a bank 902 where the bank provides a manual user interface and/or an API that provides remote access to the account information. The accounts list and configuration data can include information to allow the ECS 10 to access accounts, such as a user's bank account, without direct user intervention. For instance, the configuration data can include but is not limited to a URL associated with the interface, a user's account number and password and a message provider name. Further, the configuration data can include details about the user interfaces and/or the APIs associated with each message provider. This information can be generic to a number of accounts associated with the message provider and thus may be stored separately from the individual account data. The stored information can be used by the data retrieval agent 920 to properly interface with the outside interface maintained by the message provider. The electronic agreement can also be used to control how two users/participants interact within the ECS 10. When documents are sent or received, the agreement can dictate and enforce process. A user may specify that he allows document to be received from another as well as the level of security required. It can also control which keys to be used in the interchange as described above.

In one embodiment, the ECS 10 can be configurable to allow a user to specify different levels of account access to an account maintained by a third-party independent of the ECS 10. The account access can relate to information available via the account and functions that can be performed via the account. For instance, the user may be able to specify that the ECS 10 can retrieve data from a checking portion of the account but not the saving portion of the bank account specified by the user. In another example, the user can specify that the ECS 10 can retrieve data via the account but not make payment transfers via the outside interface. In yet another example, the user can specify that the ECS 10 can see all data associated with the account and perform all functions associated with the account, such as transfers of funds involving the account. In general, the user can specify levels of account access at the ECS 10 that is the same as or less than the account access available to the user.

In a particular embodiment, when a user registers an account maintained by a third-party outside of the ECS 10, a separate account can be created that is for ECS 10 access only. The separate account can be linked to the account maintained by the outside entity for the user to allow the separate account to be used as part of the retrieval and delivery relationship between the account provider and the ECS 10. The separate account can have a different account identifier and account access scheme than the account maintained by the third-party for the user. Further, the separate account can be instantiated with less or different privileges than the account that the third-party provides for the user.

Using the configuration data in 914, the ECS 10 can automatically log into and retrieve data associated with specific accounts maintained by a message provider, such as the bank 902. The retrieved data can be saved in the SSM data store. For instance, for a number of users at the ECS 10 with accounts at the bank in FIG. 16, each user can specify account information, such as an account identifier and a password that allows the specified account to be accessed via the bank's user interface. The information provided by each user can be saved in the configuration store. Using the saved information, the FDC can access each individuals account via the bank's outside interface according to some specified schedule.

The account information and process of setting up accounts that is associated with the configuration data is also related to deriving business related metrics (e.g., see FIG. 2). This relationship is described with respect to the following few paragraphs. When a user establishes an account with a message provider, such as bank 902, it can be assumed there is some process done by the bank to verify the identity of the user that opened the account. Since the passage of the Patriot Act, the veracity of such identity verification by banks and other SSM providers has increased. The bank 902 may be required to verify the identity of the user for various legal reasons, such as for tax purposes. Thus, to open the account the user may be required to provide one or more identifying instruments, such as a driver's license and associated identifying information such as social security number. As another example, when a user is hired for a job, an employer can be required for various purposes to verify an identity of a user and the user can also be required to provide identifying instruments, such as a driver's license, social security card and/or birth certificate, and associated identifying information, such as a driver's license number, social security number, address, birthday, etc.

After the initial verification of user's identity in the account registration process, message providers, such as banks, spend significant resources to ensure that only authorized users are accessing their accounts on an on-going basis. For instance, if a message provider suspects an unauthorized user is accessing an account or has gained unauthorized access to an account, measures, such as contacting a user via an e-mail or phone and suspending remote access to the user's account can be carried out. The account access can be suspended until an authorized user of the account is identified by the bank and then the authorized user indicates whether the account is being accessed in an authorized manner.

The efforts that message providers, such as banks, perform to verify the identity of their users and ensure that only authorized users are accessing their accounts can be leveraged by the ECS 10. When a user registers with the ECS 10 and either provides configuration data that is used to automatically access an account provided by the message provider or authorizes the FDC to retrieve their account data via some other means, such as via an API call, a process can be carried out to verify that the account associated with the configuration data is a valid account and the user granting the ECS 10 authority to access the account is authorized to do so. This process can involve one or more communications between 1) the message provider and the user (e.g., the user may confirm that they wish to receive the ECS's services, 2) the message provider and the FDC (e.g., the FDC may notify the message provider that the user wishes to sign-up for the services of the FDC or the message provider may confirm to the FDC that a particular account is valid) and 3) the FDC and the user (e.g., the user may confirm to the FDC that a particular relationship is valid and provide relationship information). The communications can involve the transfer of information in specified sequences. For instance, to confirm their wish to use the ECS 10, the bank can send an e-mail to an e-mail address or a text message to a number specified by the user with specific information, such as a unique access number or a unique web-link that the user may be required to use in a response to confirm their wish. The user can be asked challenge questions associated with the account to confirm they are the rightful account holder. In another example, an agent of the bank can call the customer and receive a verbal confirmation of their wish to use the ECS before allowing the ECS 10 to access their account.

Based upon the determination that the account is valid and the user is authorized to provide account access to the ECS 10 and based upon the efforts that a particular message provider, such as 902, for that account is known to implement to identify their users and insure only authorized users are accessing their accounts remotely, a metric, such as a score can be derived as a result of the successful completion of this described verification/validation process. The metric can be used to provide some indication that a user of the FDC is actually the person they claim to be. Further details of deriving metrics, such as an identity score, are described in the following section, “Business Relationship Derived Metrics.”

As another example, information about business relationships maintained at the ECS 10 can be derived from session data generated when the ECS 10 contacts the outside interfaces associated with different message providers, such as 902. In particular embodiments, metrics can be derived from the session data. For instance, based upon the session data, message providers in a particular category, such as a banking category, can be ranked according to the number of users at the ECS 10 that use each message provider. Further details of deriving metrics from session data are also described in the following section, “Business Relationship Derived Metrics.”

Returning to FIG. 16, the configuration store 910 can include information 916 that is used to schedule retrieval tasks. The information can include parameters, such as date ranges and a frequency, for making certain data requests. For instance, the first time, after a user registers an account associated with a particular message provider at the ECS 10, the ECS 10 may attempt to retrieve as much back data as possible and possibly create back SSM records (e.g., statements, invoices, etc. from the back data). Each back statement that is generated can be stored as a separate SSM in the SSM data store 930. Thus, after registering, via the ECS 10, the user may receive ECS 10 generated statements that cover a time period during which the statements were previously printed out and mailed to the user. Then, going forward, the statements may be delivered solely via the ECS 10 and paper copies may no longer be delivered to the user. For instance, the bank 902 may remove the user from a list of users that are to receive paper statements. The details of this process can be specified in an electronic delivery agreement 912 between the ECS 10 and the message provider, such as 902.

After the initial retrieval of data after registration, in one embodiment, the ECS can be configured to retrieve data associated with an account at some frequency, such as on a daily basis. The daily retrieval of data can be used to provide an up-to-date indication of activity associated with a particular account. Further, at some frequency, such as once a month, a month's worth data can be retrieved and used to create a statement for an account.

In another example, the ECS 10 can be configured to implement a retrieval of data based upon parameters supplied by a user. For instance, a user can accidently delete a statement from a particular message provider from a particular time period, such as their January statement. Using the ECS 10, the user can make a request for the ECS 10 to retrieve the data for the particular time period and then generate a duplicate statement. For instance, the user can request the ECS 10 to generate a duplicate statement for January 2009. The ECS 10 can attempt to retrieve the data and create the duplicate statement. In some instances, the needed data may no longer be available in which case the ECS 10 can notify the user that the task can't be completed. Information that allows a user data retrieval request to be scheduled and carried out can be included in the configuration store 910. For instance, as described above, the configuration store 910 can store information that allows the ECS 10 to navigate within a particular outside interface, such as a web-based interface, that is also available to the user.

The retrieval of data for the user accounts at the ECS 10 can be handled by the retrieval task scheduler 918. In one embodiment, the ECS 10 can generate a list of all the retrieval tasks that need to be performed for each message provider, such as bank. The retrieval task scheduler 918 can obtain parameters associated with each retrieval task, such as the message provider, account information and amount of data to retrieve from the configuration store 930. In step 932, using the data from the configuration store 910, the retrieval task scheduler 918 can then instantiate one or more data retrieval agents, such as 920, for retrieving the data specified associated with each of the retrieval tasks. Further, the retrieval task scheduler 918 can keep track of whether each of the retrieval tasks associated with each data retrieval agent has been carried out.

The retrieval task scheduler 918 can be configured to instantiate a number of data retrieval agents, such as 920, to work in a parallel. For instance, if data associated with 50 different accounts needs to be retrieved from a particular message provider, then the retrieval task scheduler can be configured to instantiate 50 different retrieval agents each configured to retrieve data with one of the accounts. As each retrieval agent is created, it can attempt to contact the outside interface for the message provider, such as the bank 902, and carry out the retrieval task according to the parameters providers by the retrieval task scheduler 918. Thus, multiple retrieval agents can be contacting and retrieving data from the outside interface at the same time. In one embodiment, to the bank 902, the data retrieval agent can appear as if the user associated with a particular account stored in 904 is accessing their account via the outside interface in 908. In another embodiment, the data retrieval agent 920 can provide identifying information when it communicates via an outside interface at a message provider 902, such as bank 902, to access a user's account that allows the message provider to distinguish that the ECS 10 is attempting to access the user's account as opposed to the user attempting to access their account.

In another embodiment, rather than instantiating one data retrieval agent for each retrieval task, a data retrieval agent, such as 920, can be instantiated to carry out a number of retrieval tasks. For instance, in the example above, a first retrieval agent can be instantiated to carry out retrieval tasks associated with the first 25 accounts while a second retrieval agent can be instantiated to carry out retrieval tasks associated with the remaining 25 accounts. Again, the first and second retrieval agents can be allowed to work concurrently, as if two separate users where trying to simultaneously access an outside interface of a message provider, such as a bank.

In one embodiment, the retrieval task scheduler 918 and/or the data retrieval agents, such as 920, can be configured to monitor activity at the outside interface associated with a message provider. The outside interface may be configured to only handle a certain number of users concurrently. If too many users attempt to use the outside interface simultaneously, the system providing the outside interface can be overtaxed. Thus, the number of data retrieval agents that are instantiated can be selected so that the system associated with the outside interface is not overwhelmed with simultaneous requests for data. Further, the data retrieval agents can be configured to throttle down their activity if it is detected that the system associated with the outside interface is slow because of too many concurrent requests for data. For instance, if too much request activity is detected at a particular outside interface, the data retrieval can be configured to go into a sleep mode for a time period and then try to contact the outside interface after the time period is expired.

In 934, the one or more data retrieval agents, such as 920, can attempt to contact and establish a secure connection to the bank's outside interface to make an API (Application Program Interface) call or can be used to automatically retrieve data from a bank's outside user interface. In this example, the bank's outside interface may support an OFX (Open Financial Exchange) message and other technical services 908. The details of the functions that the outside interface can provide can be described in an associated API description. In one embodiment, a connection can be made using a secure socket layer (SSL) or transport layer security (TLS) or possibly another security protocol. SSL and TLS provide protocols that allow client server applications to communicate across a network in a way designed to prevent eavesdropping or tampering.

When a TLS or SSL connection is established, the client and server can negotiate a Cipher Suite, exchanging Cipher Suite codes in the client hello and server hello messages, which specifies a combination of cryptographic algorithms to be used for the connection and establishes technical politeness between client and server. The cipher suite can be a named combination of authentication, encryption, and message authentication code (MAC) algorithms used to negotiate the security settings for a network connection using the Transport Layer Security (TLS) or Secure Sockets Layer (SSL) network protocol. The key exchange and authentication algorithms are typically public key algorithms, or as in TLS-PSK preshared keys could be used. The message authentication codes can be made up from cryptographic hash functions using the HMAC (Hash-based Message Authentication Code) construction for TLS, and a non-standard pseudorandom function for SSL.

In one embodiment, TLS authentication can be unilateral: only the server, such as server in the bank system 902, is authenticated (the data retrieval agent knows the server's identity), but not vice versa (the data retrieval remains unauthenticated or anonymous). TLS also supports the more secure bilateral connection mode (typically used in enterprise applications), in which both ends of the “conversation” can be assured with whom they are communicating (provided they diligently scrutinize the identity information in the other party's certificate). This is known as mutual authentication, or 2SSL.

In another embodiment, the data retrieval agent 920 and the outside interface provided by a message provider, such as the bank interface in 908, can mutually authenticate one another. Mutual authentication can require that the TLS client-side also hold a certificate (which is not usually the case in the end-user/browser scenario) or some other protocol can be used that can provide strong mutual authentication in the absence of certificates.

After a secure connection is established between the message providers outside interface (e.g., the bank's outside interface in 908) and the data retrieval agent, such as 920, the data retrieval agent can communicate one or more commands and/or parameters in an API call to the outside interface or the data retrieval agent can automatically retrieve data via the bank's user interface (e.g., the data retrieval agent can navigate through the interface as a user would navigate, such as by selecting various links and entering data in specific areas of the interface using a script). The API call can define the information that is wanted by the data retrieval agent 920. In one embodiment, the details parameters needed to construct the API call can be based upon information associated with the particular API stored in the configuration store 910.

The bank's outside interface can sit in a demilitarized zone (DMZ) 905 apart from the bank's main accounting system 904. The DMZ 905 can include security features, such as firewalls, that prevent attacks on the bank's main system. In 936, the bank's outside interface can send a request through the DMZ 905 to the bank's main system 904 (shown as bank financial accounts) to retrieve the requested data from the financial accounts. In 938, the requested data can be returned to the bank's outside interface and then transmitted, in 940, through the secure connection established in 934 and back to the data retrieval agent 920 at the FDC 980.

In 940, the data retrieved and/or sent from the bank's outside interface in 908 can be in an encrypted or non-encrypted format. If the data is retrieved and/or sent in an encrypted format, then using the necessary decryption key(s), the ECS 10 can begin decrypting the data as it is received in a streaming manner, i.e., the ECS 10 may not have to receive the entire data set before decryption can begin. For instance, decryption can be carried out on a data packet by data packet basis.

After the data retrieval agent retrieves the complete transmission of data from the bank's outside interface, it may attempt to verify that the requested data has been successfully received and notify the retrieval task scheduler 918 that the data has been successfully received. The retrieval task scheduler 918 can be configured to keep track of open and completed retrieval tasks. Thus, in response to receiving the message from the data retrieval agent indicating the data has been successfully received, the retrieval task scheduler may note that the scheduled retrieval task has been completed. This information can be stored in the configuration store 910.

In a particular embodiment, the session data generated when data is retrieved from outside entities, such as bank 902, that maintain an outside interface can be used to derive metrics. For instance, as described above, message providers in different categories can be ranked based upon the number of users of the ECS 10 that have a business relationship with each message provider. The gathering of data via these sessions can be referred to as Data Acquisition Session Management (DASM) and can involve the use of the data retrieval agents, such as 920.

To create each data acquisition session some set of parameters are needed. Typically, the parameters may include but are not limited to a username, a password, an account number and commands. The commands are selected to be compatible with each outside interface and may be interface specific. As described above, the outside interface can be a user interface, such as a web-based interface or may be an API. After a session is established, session data can be captured. As an example, session data that can be captured includes but is not limited to 1) commands issued, 2) a raw response (encrypted), 3) a number of bytes transferred, 4) a start and end time of the session (cumulative and per account), 5) a start and end time of the processing (cumulative and per account), 6) a status (success or otherwise), 7) a number of retries, 8) a specific server (if redundant servers are available) and 9) account specific metadata sent back from the server.

Derivation of metrics from captured from each data acquisition session can include but are not limited to a duration of the session per server, a number of retries, actual service that was connected to, a transfer rate, size of the data transfer and the duration of a specific accounts acquisition and processing. These metrics can be averaged over a number of user accounts and may be valuable for managing data acquisition at the ECS 10. Metrics related to which message providers have been contacted, which in some embodiments, can be linked to demographics of user's of the ECS 10 may be useful to entities outside of the ECS 10.

In 942, the retrieved data, in a streaming manner if desired, can be sent to the streaming translation component 924 for translation. In other embodiments, non-streaming methods can also be used where an entire file is assembled before it is translated. An advantage of using streaming translation and encryption is that only a portion of a data set is left unencrypted at any one time, which may be more secure than assembling an entire unencrypted data set before beginning encryption.

The streaming translation component can translate the retrieved data into one or more formats. The formatting can provide all or a portion of the structure of a secure and structured message (SSM) that will be stored in the SSM data store 930. For instance, the retrieved data can be transformed into a format that is compatible with a particular money management program. In another example, the retrieved data can be formatted into a document. In yet another example, the streaming translation component 924 can translate the same data set into two different formats, such as a format compatible with a money management program as well as a document. The streaming translation function can be configured to receive information from the configuration store 910 in regards to the initial format of the retrieved data, a number of different formatted data files to create and the formatting to be utilized for each formatted data file. In one embodiment, the ECS 10 can enable custom formatting parameters to be specified by a user. These parameters can be stored as part of the user's profile in 912. In particular embodiments, these parameters can vary from retrieval task to retrieval task.

In one embodiment, the ECS 10 can provide a push data agent 922 that can allow a message provider such as a bank to push data to the ECS 10. In another example, the ECS 10 may establish and support its own API for use by message providers who do not have their own APIs and/or manual user interfaces. This will permit message providers to utilize the ECS's API and thereby be able to deliver messages to the ECS by following the protocol defined in the ECS's API.

In yet another example, an agreed upon standard protocol can be used for the connectivity (e.g., SFTP, AS2, etc.) In addition, the payload packaging can be agreed upon (e.g. PGP/MIME). In AS2, the connectivity and packaging are both specified. Then, the actual payload format can be agreed upon by both sides and a data transfer between the ECS 10 and the message provider, such as 902, can be carried out.

The pushed data can be indicated for delivery to one or more users. For instance, the bank may wish to send a notification to a particular user, such as an overdraft notification. This notification can be received by the FDC 980 via the push data agent 922 and then delivered to a single user via the SDN 982. As another example, the bank 902 may wish to send a privacy notice or an advertisement for services that is intended for delivery to a group of customers with accounts at the ECS 10. Thus, the bank 902 can send via the push data agent the information that is to be delivered to the group of customers. For messages that are common to all of the users of the ECS 10 for a particular SSM provider (such as privacy notifications), the SSM provider, such as 902, may wish to transmit such a common message to the ECS 10 using a different method.

In another example, the push data agent 922 can be used by a message provider that does not support an outside interface, such as an outside interface that allows API calls. Using the push data agent, the message provider can push messages to the ECS 10. In particular embodiments, the messages can include pre-formatted information, such as a pre-formatted document or information that can be formatted into a document or some other format understood by the translation component. For example, a message provider, such as a doctor, may be able send an invoice to a particular user of the ECS 10 via 922.

In yet another example, the push data agent 922 can be used by a first user of the ECS 10 to send an SSM (or other type of message) to another user of the ECS 10. In some instances, temporary users of the ECS, after receiving authorization, may be allowed to send an SSM (or other type of message) to a user of the ECS using a push data agent 922. For example, a temporary account can be set-up for the temporary user that allows them to deliver a message to the user via the push data agent 922 for some time period or for some number of times. The parameters associated with the temporary account can be stored as an electronic delivery agreement in 912. In one embodiment, the ECS 10 can be configured to instantiate a push data agent 922 in response to a request from a user of the ECS 10. Using the push data agent, such as 922, the user may be able to upload data, such as but not limited to a receipt, a financial document or a data file associated with a money management program to the FDC. The ECS can then generate an SSM with the uploaded data and store it in the SSM data store. As an example the user may wish to upload an electronic copy of a paper statement that has been converted to a digital format, such as via a scanner.

As it is common that security procedures on user's computer may not allow messages to be delivered to the user's computer without an active action being taken on the part of the user, in one embodiment, the ECS 10 may have the capability of activating an indicator on the client application of the user that a SSM or other message is available at the ECS 10 and is ready for delivery to the user. A client application could determine that such a message is available by periodically polling the ECS 10 for the availability of such a message. In another embodiment, the client application can be configured to query the ECS 10 on a regular basis for available messages. Depending on the user preferences configured in the client application, the messages can be automatically downloaded or downloaded in response to a manual input by the user. The message can be stored securely and user authentication can be required before viewing of the message is allowed.

In one embodiment, a message pushed to the ECS 10, such as via 922, can be received in a bulk format that includes data associated with more than one user of the ECS 10. For instance, the bulk data can be sent in a single file where the file can include data associated with multiple users where the data varies from user to user. In one embodiment, the translation component 924 can be configured to parse the bulk data to determine the information that is associated with each user. In another embodiment, the parsing can be performed by another component at the ECS 10 and then delivered to the translation component 924. Then, the translation component 924 can format the parsed data into one or more SSMs that can be delivered to each user. In one embodiment, an outside interface can be configured to provide information in a bulk format to the data retrieval agent, such as 920. Again, the translation component 924 or another component at the ECS 10 can perform the parsing functions.

In 940a, the push data agent 922 can establish a secure connection with a push interface 906 associated with a message provider, such as the bank 902, which is configured to push data to the ECS 10. The secure connection can be established in response to a request from the push interface 906. The push interface 906 can be separate from the outside interface in 908 that allows remote customer access to their accounts 904. The push data agent 922 and the push interface 906 can be configured to mutually authenticate one another. Then, the push data agent 922 may begin to receive the pushed data.

In 942a, the push data agent 922 can send the received data to the streaming translation component 924. The translation component 924 can then be configured to perform additional manipulations of the pushed data. In one embodiment, the received data may not need additional formatting. For instance, a privacy notice or other communication could be received as a formatted document that is delivered as is to a user. In other embodiments, the received data can require additional formatting before it is sent to a user. For instance, the received data can be formatted into a document after it is received. As another example, a formatted document could be personalized in some way after it is received. For instance, a user's name could be added to a generic privacy notice. In another embodiment, a personalized document can be created and attached to pushed data and/or document before it is delivered. For instance, the streaming translation component 924 can be configured to generate a personalized letter that is attached to a generic privacy notice received by the push data agent. The personalized letter and the generic privacy notice could then be delivered to the user after it is sent to the secure packaging component.

In 944, the translation component can send data in a streaming manner to a secure packaging component 926. In the streaming embodiment, as a portion of the translation operation is completed on incoming data, it can be sent to the secure packaging for storage. In another embodiment, an entire translation operation can be completed before it is sent to the secure packaging. For instance, a received data set can be translated into a file formatted according to specified requirements. Then, the complete file can be sent to the secure packaging component 916. One advantage of the streaming option is that it can be considered more secure because only a portion of each data set remains unencrypted at any one time.

The secure packaging component 926 can be configured to encrypt the data received from the translation component before it is stored. Different methods can be used to encrypt the data. The method that is employed can depend on a selection by a user. For instance, the ECS 10 can be configured to allow the user to select to have their data encrypted with a key where the decryption key is not available to the ECS 10. As another example, the ECS 10 can be configured to allow the user to select to have their data encrypted with a key where the decryption key is stored in escrow by the ECS 10 and can only be utilized with the permission of the user, such as if the user loses their key. In yet another example, the ECS 10 can be configured to allow the user to select to have their data encrypted with a decryption key that is generally available to the ECS 10 and the user. In another example, a third-party service, separate from the ECS 10, can store a copy of a user's key. The ECS 10 can be configured to retrieve the key from the third-party service, in the event the user loses their key. The retrieval can be instantiated after approval from the user for the ECS 10 to proceed in this manner.

The encryption methods that are selected can be included as part of the user's profile 912 in the configuration store 910. Thus, the secure packaging 926 can be configured to receive information regarding encryption methods to use for a particular message from the configuration store 910. The encryption methods can vary from message to message depending on such parameters as which message provider or user has sent the message. In particular embodiments, portions of a data set can be encrypted with different encryption keys. For instance, meta-data associated with a data set can be encrypted with an ECS 10 system key whereas the data set may be encrypted with a key that can only be decrypted with a user's private key. The meta-data may include information that allows the ECS 10 to manage the data set, such as to file it and deliver it to the user. In other embodiments, the data can also be signed so that it can be later verified that the data has not been altered. For instance, the data can be signed with a one way hash function of some type.

The secure packaging component 916 can store a data set with information that allows it to be routed to a particular user including any conditions for the electronic delivery. For instance, one delivery option may send a notification message to a sender of a message when the file is delivered into a user's account. Another delivery option may send a notification message to a sender of a message when a file is opened by a user. Yet another delivery option may send notification message to a user when a message is received. A further delivery option may send a series of message to a user until a particular message is opened and viewed. The specified delivery parameters can be stored in 912.

In 946, the packaged data with the specified delivery options can be sent to the SSM data store 930. The SSM data store component 930 can include a number of message queues defined by information stored in a database. The messages in the SSM data store can be routed into categorized user mailboxes. Further details of routing data and retrieving data from the SSM data store are described with respect to FIG. 17 as follows.

Routing Data to and Retrieving Data from the Data Store

FIG. 17 is a block diagram showing user devices, such as 962, 964, 966, 968 and 970, accessing a secure and structured message (SSM) data store 930 at the ECS 10. The ECS 10 is shown including “P” users with “N” SSMs per users. For each user, the “N” SSMs can be stored to one or more electronic vaults accessible to the user. In one embodiment, the one or more electronic vaults in which the SSMs are stored may be accessible to only the user. In other embodiments, one or more the SSMs can be store in one or more shared electronic vaults that are accessible to multiple users. The number of vaults and the SSMs per vault can vary from user to user.

For each user, the SSMs can be from one or more different sources, i.e., different message providers. Also, each of the “N” SSMs could be from the same source, such as N different bank statements from the same bank or all N could be from different sources. “N” messages in each of the user message stores, 950a, 950b, 950c and 950d, are shown for users 1, 2, 3 and P, respectively. The number of SSMs per user and the sources of SSMs for each user can be different. Thus, the examples described are provided for the purposes of illustration and are not meant to be limiting.

A user may be able to access their information in the SSM data store 930 in a number of different ways. In one embodiment, the SSMs for a user can be stored on a computer designated by the user. As described above, when the SSMs are stored in vaults on a computer designated by the user, the vaults can also be mirrored at the ECS. The designated computer can be a desktop computer, such as 962, 964 or 966 or a mobile computer, such as laptop 958 or smart phone 970. A user interface (UI), such as 954, can be provided that allows the user to manipulate and view the SSMs stored on their designated computer. In one embodiment, the user interface can be via browser, such as 960 or 962.

In one embodiment, a client application including the user interface and encryption capabilities, such as 956 and 958, can be provided. The client application can be installed on the user's home computer, such as 966. Besides providing a user interface, the client application may be configured to encrypt and decrypt SSMs stored on the user's home computer and sync the SSM store on the user's computer with the ECS 10. The SSM data store, if desired, can be configured to retain a back-up copy of the user's SSMs as well as retrieve and back-up copies of any SSM or other data that the user may store into the data store of the client application.

In one embodiment, each time a new SSM is received by the SSM data store 930, the new SSM can be downloaded from the ECS 10 to the user's designated computer. Further, the ECS 10, as described above, may allow a user to send a message to the ECS 10 that is converted to an SSM and saved in the SSM data store 930. The SSM data store 930 may then send a copy of the SSM generated from the user's message back to the user's computer. As an example, in FIG. 17, a message 951 is shown being uploaded from device 966 and then uploaded, via client application 956, to the ECS 10 and saved in the SSM data store 930 as an SSM 952. The client application alone or in combination with the ECS 10 can convert the message 951 to a SSM 952. In particular embodiments, an interface, such as 956, can be provided on each user's computer that allows messages to be uploaded to the ECS 10.

In another embodiment, software for generating an SSM may reside on the user's designated computer. (An example of such an SSM might be a receipt for purchase of an item, or a copy of a warrantee for an item; the user could create PDF or other copies of such documents and store them in the client application on his computer.) Thus, the user's message or document can be converted to an SSM on the user's computer and then uploaded to the ECS 10 for storage in the SSM data store 930. Since the SSM is created on the user's computer, the SSM data store 930 does not have to push a created SSM back to the user's designated computer as described in the previous paragraph to sync the devices.

In a particular embodiment, the ECS 10 can be configured to allow a first user to send a message to a second user. For instance, user “3” via the ECS 10 can send SSM 952 to user “P.” The sent SSM 952 can be placed in user P's message store 950d. Then, via a user device, such as 968 including a UI, such as 958, the message 952 can be retrieved and viewed by user “P.” In particular embodiments, the sharing can involve moving the SSM 952 from one electronic vault to another electronic vault. As described above, to allow this movement, the ECS 10 can be configured to locate and apply necessary encryption and decryption keys as needed.

In another embodiment, a sync operation can be initiated automatically at some interval or in response to a request by the user. For instance, a version of user message store 950a can reside at the ECS 10 and on the device 962 where the ECS 10 and/or a client application executing on the device 962 can be configured to sync user message stores residing at 930 and 962 for the user. During the sync operation, the SSM data store 930 (typically upon the invitation of the client application) can send SSMs not residing on the user's computer to the user's computer. Further, messages stored on the user's computer but not yet uploaded to the ECS 10 can be uploaded, converted to an SSM and then stored in the SSM data store 930. The SSM newly created at the ECS 10 can then be pushed back to the user's computer. For instance, message 951 can be uploaded to user message store 950c in 930 as part of a sync operation and then SSM 952 can be pushed back to device 966 as part of the syncing process.

In another embodiment, SSMs may not be stored on one or more of the devices accessible to the user. In one example, a user may have multiple devices, such as a designated computer for storing their SSMs, such as 966 and then a portable device that does not store their SSMs, such as 970. When using the portable device, such as 970, an interface application, such as a web-browser executing on the portable device, can be utilized to access their SSMs stored on their designated computer, such as 966, (e.g., network connection can be established to their designated computer that allows remote access) or to access a copy of their SSMs stored in the SSM data store 930. When the user's designated computer and the ECS 10 are synced, the user may be able to access their SSMs via the ECS 10. In FIG. 17, the message 951 that was uploaded from the device 966 and stored as an SSM 952 (if not already in SSM format) in the SSM data store 952 is shown being subsequently accessed from the SSM data store 930 at the ECS 10 via an interface, such as 958 or 962, executing on a portable device carried by user 3.

In another example, the user may or may not choose not to maintain their SSMs on any of their devices, such as a home computer or a portable device. In this example, an interface, such as web-browser or a desktop client, can be provided on each of their devices that allow the SSMs stored in the SSM data store 930 to be remotely accessed. The interface can be configured to send messages to the ECS 10 that are converted remotely to SSMs for storage in the SSM data store 930 or can be configured to locally convert the messages to SSMs before they are uploaded to the ECS for storage in the SSM data store 930. In case the interface is the browser, in one embodiment, a signed java applet or a browser plug in can be used to help pre-process and upload (push) the files.

### Business Relationship Derived Metrics

Besides secure transfer of financial data to and from the ECS, another important function of the ECS is the capture of data characterizing the business relationships maintained via the ECS. The ECS can generate portals and conduits that allow information associated with business relationships to flow into and out of the FDC. The information flowing through the SDN portals and conduits can be monitored and captured. The captured information can used to derive metrics that are valuable to individuals and message providers alike.

As one example, a metric about an individual can be derived from captured information characterizing an individual's business relationships. This metric can be referred to as a User Validation Score (UVS). When an individual maintains a business relationship with a message provider, such as a bank or utility, certain parameters, such as a user's identity, length of the relationship, number of transactions associated with the relationship can be captured as transactions are carried out using the SDN. The captured information for a number of transactions can be used to measure and quantify the user's relationship relative to the message provider and thereby derive a metric of that relationship which the ECS can convert into a score about the user. The score can be based on the multiple relationships between the user and various message providers. For instance, a user with more established business relationships maintained over a longer period of time may be given a higher score than a user with fewer established business relationships maintained over a shorter period of time.

A key metric in the score of a user can be related to the actual verification of a preexisting relationship between that user and a message provider. The verification of such a relationship can be valuable as the SSM provider can be an independent third-party who is verifying its ongoing business relationship with the user and then reporting information characterizing the ongoing business relations to the ECS. For instance, an individual can provide a valid account number, identity and password for an account that is verified by a third-party message provider (a) through a direct communication between the message provider and the ECS; or (b) when the ECS retrieves data from the third-party message provider associated with the account. The fact that the information is verified by a third-party message provider can be used to assign a significant weight or value to the validation of that message provider-user relationship. The weight assigned to the information can be used to affect the score described in the previous paragraph.

As another example, metrics can be derived from business transaction data captured from groups of users of the ECS. For instance, a group of users over a time period can switch from one cell phone service carrier to another cell phone service carrier. This information can be captured at the ECS because the ECS, in response to a request from a user, can terminate the message provider relationship with a first cell phone service carrier, for example, and then establish a message provider relationship with a replacement cell phone service carrier. Information, such as an average length of a relationship with each of the cell phone service carrier for a group of individuals and the number of dropped or added accounts associated with each cell phone service carrier over some time period can be used to generate metrics for each cell phone service carrier as well as for cell phone service relationships in general. The metric could be geographically derived. For instance, the metric could be formed based on individuals grouped together in a nearby geographic area. Thus, the score could vary from geographic region to geographic region. For a cell phone service carrier, the geographic varying score could be a reflection of the quality of their infrastructure in various regions.

The group metric described above could apply to other types of businesses. For instance, auto repair services can be scored based upon length and a number of transactions captured from users of the ECS. From a scoring perspective, auto repair services that are determined to be associated with long-time customers providing repeat business might be scored higher than auto repair services that had many business relationships that ended after one transaction followed by an user of the ECS establishing a relationship with another auto repair service.

In one embodiment, the user of the ECS can be a business. The business can maintain business relationships with other business and individuals, which may be users of the ECS Like an individual, a business can receive messages, such as statements and invoices, from various message providers. The business's message providers indicate a third-party verification of the identity of the business. In addition, if the business has business relationships with users of the ECS, i.e., the business may be a message provider to other users of the ECS, then information regarding these established relationships can provide a verification of the identity of the business and that the business is operating according to its advertised purpose. If a business is not operating according to its advertised purpose, it is assumed that the users of the ECS would sever or alter their message provider relationships with the business.

Like other users of the ECS, a metric, such as a score, can be derived for businesses based upon their maintained relationships. Like an individual, the score can be based upon the third-party verifications that message providers, such as other businesses, perform. In addition, if the business can also be a message provider to other users of the ECS, the fact that other users of the ECS maintain a message provider relationship with the business provides additional third-party verifications of the business. This information can also be factored into a score.

One use of the metrics described above is that individuals or companies can use the score in decisions relating to whether to establish a new business relationship. For instance, a lending company might use an individual's ECS score as a factor in granting the individual a loan. Conversely, an individual might use the lending company's ECS score as a factor in deciding to seek a loan from the lending company. General methods of creating a score, which is one example of a business derived metric are described with respect to FIGS. 18 and 19.

Another use of the metrics can be for an individual user of the ECS (or an authorized outside individual or company) to evaluate the veracity and/or stability and/or identity of another user of the FDC. It is expected that it would be very difficult for a user to fraudulently achieve a high User Validation Score (UVS) (“High” indicating the user's identity is more likely to be correct). Due to the fact that most scoring is generated as a result of multiple, independent third party identity validations conducted by message providers, it may be difficult for a dishonest user to achieve multiple fraudulent such validations. Therefore a high UVS could be reasonably viewed by another ECS user as a useful and accurate validation of a user's identity. Such a UVS scoring system may be useful in detecting (a) individuals who are attempting to steal the identity of another; (b) sexual predators who are attempting to hide their true identity; and (c) other circumstances where identity verification is needed.

### Sample Method for Computing User Validation Score

With respect to FIGS. 18 and 19, two scoring methods are described. In a first method, described with respect to FIG. 18, a user is able to register third-party accounts at the ECS, such as when a user first signs-up for their account at the ECS. Based upon registration events including third-party verifications indicating that the user is authorized to access the third-party accounts, a UVS can be generated. Over time, a user may register additional accounts or close accounts at the ECS which can affect their score. A second method, described with respect to FIG. 19, can be based-upon operational events occurring at the FDC that may involve a third-party. For instance, the ECS may retrieve and create a statement from data in an account maintained by a third-party. A successful completion or non-completion of an operational event can be used as a scored event that is a component of a UVS. In a particular embodiment, the first and second methods can be combined to generate a combined UVS.

In general, the UVS can be calculated from a number of “scored events.” As examples, the scored events can be “registration events,” such as a successful registration and verification of a third-party account and/or “operational events,” such as a successful completion of the retrieval of data from a third-party account. The values associated with each scored event can be combined in some manner to produce a UVS. Further details of generating a UVS from scored events are described below with respect to FIGS. 18 and 19.

FIG. 18 is a block diagram of a method 1000 of determining a user validation score in accordance with the described embodiments. A first step 1002 in the score generation method based on registration events can be defining registration events performed by the ECS that are to be used in the score. These events can include but are not limited to 1) a registration of an account associated with a particular third-party message provider by receiving a verification from the message provider that the registration is valid and that an authorized user has registered, 2) an unsuccessful attempt to validate a user's registration request of an account maintained by a third-party message provider, 3) a request to close an account, 4) a validation by an employer that the person is a legal resident or citizen and 5) a validation that identification information provided by the user, such as a drivers license number or social security number, is consistent with other information provided by a user, such as a name on an account maintained by a third-party.

After a registration event set is selected, in 1004, a value can be associated with each registration event. The values that are assigned can be configured to generate scores in a particular range and then a description can be provided in regards to interpreting score values. Similar transactions can be assigned different values depending on what the score is to characterize. For example, if the intent of the score is intended to characterize the likelihood of user possessing their advertised identity, then a registration of an account that has been confirmed by a third-party message provider that has high identification requirements can be given a different score value than registration of an account with a third-party message provider that either does not do identity verification or does weak identity verification.

Next, in 1006, a user can sign-up for an account with the ECS and an initial score can be generated based upon the registration events. The registration events can include setting up and verifying accounts with various message providers and retrieving some amount of back data associated with each account. As noted above, a particular score can depend on a values assigned to a defined set of events. Thus, if one or more of the registration events are not in a defined set of events for a particular score, then the registration events may not contribute to the score.

In more detail, in 1008, the ECS can first receive account information associated with one or more third-party message providers from the user. In addition, the FDC can be configured to receive other identity indicators, such as a driver's license number, that can be used to access additional information in a third-party maintained database. Information retrieved from the third-party database can be compared to other information provided by the user for data consistency purposes.

Next, in 1010, each registration event can be validated in the context of the scoring method. First, in 1012, it can be determined whether the registration event is part of the scoring method. When the registration event is not part of the scoring method, then a next registration event can be considered. If the registration event is part of the scoring method, then one or more communications can take place between the ECS and a third-party message provider. Via the communications with the third-party message provider, in 1014, the ECS can receive information from the third-party message provider that indicates whether the account information provided by the user is associated with a valid account. In one embodiment, the account validation process with the third-party can involve the user providing answers to questions associated with the account that only an authorized user of the account should know.

In certain circumstances the message provider may not support a direct relationship with the ECS, and thereby the ECS is not able to validate user requests to have their relationships with the message provider registered with the ECS. The ECS may choose to accept the user based on the user providing sufficient personal information so that the ECS is able to retrieve that user's information from the message provider. For instance, it can be assumed that the account is valid when the ECS is able to successfully retrieve account information using the account access information provided by the user and the account is non-valid when the ECS is not able to successfully retrieve the data. Accounts that have not been directly validated by a message provider can be given less weight in a UVS than accounts that have been validated by a message provider.

Next, in 1016, a value can be associated with the registration event. The value can depend on whether a successful validation was completed or not completed in 1014. After the value is determined, in 1018, a new UVS can be calculated that includes the registration event. In 1020, the UVS including the registration event and information associated with the registration event can be stored to a score history file. If there are additional registration events to score, then in 1020 the validation process can be attempted for the next event. If there are not any more registration events, then in 1024, a current score can be generated and provided to the user.

Over time, a user may establish and dissolve message provider relationships with various businesses. When a user forms a new relationship, a registration event can occur that affects a UVS (User Validation Score) as described above. When a user dissolves a message provider relationship, this action can also affects a user's score.

The transactions and their assigned values used to generate a score can be stored in the ECS database. Using this data, a time history of a user's score can be generated. Further, the data can be used to provide time based weighting factors to each transaction. Using time based weighting factors, a particular transaction can be given an initial value that is increased or decreased over time depending on a time-based weighting factor. For instance, an account registration can be assigned an initial value and then based upon the time since registration, when the score is updated the initial value can be modified to produce as a higher or lower value as a function of time as desired. Such determinations can be made by the operators of the FDC based on their judgment as to the factors best measure and reflect the veracity, identity and stability of the users being scored. Next, a scoring method based on operation events is described with respect to FIG. 19.

FIG. 19 is a block diagram of a method 1100 of generating a user validation score (UVS). In 1102, a first step in the score generation method based on operational events can be defining operational events performed by the ECS that are to be used in the score. These events can include but are not limited to 1) a successful retrieval of data from a registered third-party account and 2) an unsuccessful attempt to retrieve data from a registered third-party account (this could be an indication that the account may have been closed or is being used in an unauthorized manner). After an operational event set is selected, in 1104, a value can be associated with each operational event. The values that are assigned can be configured to generate scores in a particular range and then a description can be provided in regards to interpreting score values. Similar transactions can be assigned different values depending on what the score is intended to characterize.

For example, if the intent of the score is to characterize the likelihood of a user possessing their advertised identity, then a retrieval of data from an account that is maintained by a message provider that has many procedures in place to ensure that only an authorized user is accessing an account can be given a different score value than retrieval of data from an account that is maintained by a message provider that does not have many procedures in place to ensure that only an authorized user is accessing an account.

Next, in 1106, operational events can be generated that are associated with the ECS functions. For each operational event, in 1108, the ECS can check whether the event contributes to a particular score according to its defined set of events. The FDC can be configured to generate multiple scores with different event sets. Thus, a particular event may contribute to multiple scores or may not be associated with any score. If the particular event is not associated with a particular score, in 1106, the FDC can consider the next event.

If the event is associated with a score, in 1110, the FDC can determine whether the operational event involving a third-party was successfully completed or not. Depending on whether the operational event is successfully completed or not, in 1112, a value can be associated with the event. Then, in 1114, a new score including the added event can be determined. The determination of the new score can involve applying weighting factors to each event. Finally, in 1116, the new score can be stored and the event added to the score history file.

In general, a UVS can be based on the aggregation of a number of events including registration and/or operational events. In one embodiment, the score can be modified on an event by event basis. Thus, a new score can be calculated based upon the old score and the change in value of the score resulting from one or more current events. In other embodiments, a new score can be calculated each time based upon an event history where the values assigned to each event can be changed each time the score is recalculated according to one or more weighting factors.

A time based weighting factor is one method for adjusting the value of an event each time a score is recalculated. Another weighting factor could be based on grouping similar events together. For instance, the first occurrence of an event in a group might be assigned a first value and then the next occurrence of a similar event could be assigned a second value different from the first. For instance, the registration of a first account with a message provider such as a bank might be assigned a first value but the registration of a second account with the same message provider may be assigned a different value. In more detail, a user might achieve a better UVS if they are independently identified by 3 different banks as opposed to be being validated 3 times by opening three different accounts at the same bank.

In particular embodiments, a UVS can be updated on an event by event basis. In other embodiments, the UVS can be updated periodically. For instance, a score can be updated on a real-time, hourly, weekly, bi-weekly, monthly basis, etc. Between UVS updates, a number of events can be stored and then the UVS according to the selected time interval can be updated in accordance with the events that have occurred since the last update.

A UVS can be affected by unsuccessful interactions with third-parties. In some instances, the unsuccessful interaction can be caused by a user incorrectly entering information. In one embodiment, the ECS can provide a mechanism for a user to review, challenge and possibly correct their score. For instance, the ECS can be configured to allow a user to remove the effects on their score resulting from bad data entry.

One example of the score mentioned above can be related to a verification of a user's identity. When a user registers for an online account, the user is free to provide identification information as they choose. The identification may or may not be consistent with their actual identity. Once a user is registered with the ECS, the ECS provides procedures whereby each user can then register their existing account relationships, such as relationships that the user has with various message providers.

Through a coordinated process, the user's request to register his accounts can get validated by the third party message provider associated with each account and then registered with the ECS as a serviced account. As users extend their use of the ECS service by registering additional accounts, each request may go through this validation process by the third party message providers. As described above, depending on the quality of the identity verification performed by a third party message provider, a value can be assigned to the verification that is included in a User Validation Score (UVS).

The ECS can record each such third party validation. Then, to generate a user validation score, a score value can be assigned to each third-party message provider validation and then added together. In one embodiment, the ECS does not validate any users. Instead, the validation of identity and business relationship is done by the user's message providers (and/or other ECS users) in the course of performing transactions associated with the ECS. The ECS can establish a value for each validation based on the ECS's evaluation of its value relative to other validations. As mentioned above, the relative value can depend on the effort that a particular third-party message provider dedicates to identifying their users. The ECS can be configured to adjust the value associated with a validation by each third party message provider from time-to-time as the ECS reevaluates the relative weight of each validation.

In particular embodiments, the score assigned to each validation by a third party message provider may be adjusted based on one or more of the following. Different values can be assigned to validations by different message provider types, such as banks, credit card issuers, mortgage lenders, consumer credit lenders (e.g., car finance companies), cell phone providers, utility companies, other financial services firms and employers. Further, within a particular message provider type, different message providers can be accorded different values by the ECS according to the thoroughness of their validation efforts. In addition, the score can be affected by information provided by other parties, such as employers and other users of the ECS system. As described above, an employer can be a message provider to users of the ECS.

As mentioned above, scores can be modified according to different weighting factors. The weighting factors combined with validation values can be used to generate the user validation score. In a first example, the value assigned to a particular validation can be modified by the duration of a relationship. A minimally short relationship may be assigned a multiplying factor “1”. As the length of the relationship increases, the multiplying factor can increase above “1”.

As another example, a quality of third-party message provider validation can be weighted. A message provider meeting minimum requirement can be assigned a multiplying factor of “1.” The ECS can be configured to assigns a higher value for certain message providers. Thus, the contribution to the score from the message provider's validation would be increased. As an example, a validation from a utility company that does a relatively high level due of diligence on their customer identity may be ranked higher than that of a utility that issues service to anyone. As another example, score values can be weighted according to whether message providers confirm legal U.S. residency or not.

In yet another example, exclusivity of the message provider can be considered. A minimum level of exclusivity being assigned a multiplying factor of “1”, and as the assigned level of exclusivity of the message provider increases, the multiplying factor would be increased (e.g., an American Express Gold card validation would be more valuable than one from a pre-paid credit card provider or an account with Merrill Lynch may be ranked higher than with Joe's Brokerage Company).

In yet another example the overall score total can be adjusted based on an evaluation of a user's overall portfolio of message provider validations, with scores being increased when multiple categories of message providers have been validated and scores lessened when certain message provider categories have not been validated. For example, two users with similar scores from financial services businesses may be ranked differently because one may have utility company validations while one does not.

FIG. 20 is a block diagram of a server 1212 and user computer 1232 in accordance with the described embodiments. The ECS 10 can be instantiated as a set of software programs, running on one or more computing devices and/or servers, such as 1212 and 1232. The devices in the system can be configured to communicate with one another via a network, such as network 1216. Thus, each device can include network interfaces, such as 1208 and 1226 that support one or more different network communication protocols.

Each device can include processor(s) executing software programs, volatile memory for storing executable code, non-volatile memory, which can be mass storage, for storing data, peripheral devices for inputting and outputting data from the device and one or more internal busses for allow data transfer between the devices. As examples, server 1212 includes processor 1202, volatile memory 1204, mass storage device 1206 and network interface 1208 and peripheral devices 1210 and user computing device 1232 includes processor 1220, volatile memory 1222, mass storage 1224, network interface 1226 and peripheral devices 1228. In one embodiment, the user computing device 1222 can be a portable device, such as tablet computer, laptop or smart phone.

The software programs can be configured to form many different functions. For the software programs can be configured to handle retrieval, storage, authentication, generation and distribution of messages, such as messages including financial documents and/or records. Other examples of functions that can be implemented in the software programs include but are not limited to (1) communicating with message providers via a communication network or other link; (2) locating and downloading the desired data, such as particular financial documents and/or records; (3) authenticating the downloaded data, such as financial documents and/or records in a manner sufficient to ensure their originality to third parties; (3) parsing downloaded documents and/or records, as necessary and feasible, to extract and normalize the information they contain; (4) categorizing the extracted data appropriately; (5) storing the data securely and in an organized fashion; (6) presenting a user interface to allow the user to retrieve, arrange, store, delete, associate, sort, filter, search and view data; (7) capturing data, such as financial documents and/or records in physical form for storage electronic within the system; (8) verifying the user's identity, the authenticity of data, such as financial documents and/or records, and the validity of scheduled transactions; (9) accepting and parsing user requests for data, such as financial documents and/or record data, including providing sorting, filtering and search options to the user; (10) presenting the requested data to the user; (11) creating physical copies of electronically stored data, such as via printing; (12) notifying the user when new messages, such as messages including financial documents and/or records, are available for download and/or viewing; (13) placing specific events, such as the availability of a particular financial document or record, or the due date for a bill, on a schedule; (14) presenting a calendar and scheduling system to the user to allow the user to see and schedule specific events; (15) presenting to the user an interface for the payment of bills and the transfer of money between accounts; (16) alerting and reminding the user of bills due, or other events, in a timely fashion; (17) suggesting optimized payment amounts based on such factors as the user's bills, income, assets and interest rates; (18) initiating and tracking the withdrawal of money from accounts specified by the user for payment to designated parties or transfer to other accounts specified by the user; (19) acquiring and storing confirmation of payment for any bills paid or amounts transferred, and associating it with the appropriate bills and other financial documents and/or records; (20) generating financial documents and/or records in templated formats, such as statements, using data retrieved in a raw format from message providers; (21) delivering generated or other financial documents and/or records to specified user accounts at the system (as well as to user without accounts at the system if desired by a particular message provider); (22) confirming receipt and viewing of specified messages by users of the system; (23) acquiring, categorizing and storing auxiliary data, in the form of scanned documents, notes entered by the user or other forms (categorization may involve manual input of meta data by a user); (24) associating portions of stored data with other portions of stored data in a manner meaningful to the user; (25) encrypting and decrypting stored and/or transmitted data; (26) backing up the user's data; (27) securely and irretrievably deleting user data; (28) detecting system vulnerability to attack or compromise, and executing effective countermeasures against such vulnerability; (29) generating, organizing, encrypting and storing the user's passwords for the user (the passwords can be associated with a number of accounts not maintained by the system, such as accounts that users might have with a financial data provider); (30) delivering targeted advertisements to the user based on general data about the user as well as the contents of the user's financial documents and/or records; (31) connecting to other software applications, such as Quicken™ or Microsoft Money™, and populating them with appropriate data from the stored financial documents and/or records, such as transaction data, bill due dates and payment confirmations (the system may also be capable of receiving data exported from a number of different financial software applications, such as Quicken or Quick Books), (32) generating user validation scores and other metrics from derived from business relationship data, (33) managing privacy settings and privacy options for a user associated with their interactions with various businesses and web-sites.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method in an electronic clearinghouse system (ECS) comprising:
receiving from a message provider an authorization for the ECS to electronically retrieve and deliver messages to users of the ECS that have a business relationship with the message provider;
receiving from the message provider a selection of electronic delivery options that affect how messages associated with the message provider are to be retrieved and delivered by the ECS;
generating for each of the users of the ECS 1) a vault for electronically storing data in an encrypted format including storing the messages from at least the message provider and 2) an account that allows access to the vault;
receiving from a remote device a request for retrieval and delivery of the messages from the message provider for a first user of the ECS;
generating and storing to a memory device at ECS an electronic delivery agreement between the first user, the message provider and the ECS wherein the electronic delivery agreement includes 1) information indicating the first user wishes the ECS to retrieve and deliver the messages from the message provider into the first user's vault at the ECS in accordance with the selection of electronic delivery options and 2) access information that allows the ECS to retrieve and deliver data from the message provider for the first user; and
retrieving, delivering and storing a message associated with the first user from the message provider into the vault of the first user.

2. The method of claim 1, further comprising: providing a notification to the message provider that the message has been delivered into the vault of the first user.

3. The method of claim 1, further comprising: determining the first user has viewed the message and sending a notification to the message provider indicating the first user has viewed the message.

4. The method of claim 1, wherein the access information includes account information that allows the ECS to utilize an outside interface provided by the message provider to retrieve data for the first user.

5. The method of claim 4, wherein the outside interface is configured to receive inputs that allow actions associated with an account for the first user maintained by the message provider to be performed by the ECS and the first user and wherein the access information includes information that restricts the actions that can be performed by the ECS via the outside interface as compared to the first user.

6. The method of claim 1, further comprising: retrieving account data for an account maintained by the message provider for the first user, placing the retrieved account data in a file and storing the file in a file system associated with the first user's vault.

7. The method of claim 6, wherein the account data is retrieved as a formatted account statement for the first user.

8. The method of claim 6, further comprising retrieving the account data as transactional data and formatting at the transactional data into an electronically viewable and printable account statement.

9. The method of claim 8, wherein the selection of the electronic delivery options includes information for how the ECS is to format the account statement.

10. The method of claim 8, wherein the formatting includes adding advertising into the account statement wherein the advertising is selected by the message provider, the ECS or combinations thereof.

11. The method of claim 6, further comprising: receiving categorization information for the file wherein the ECS is configured to provide searches of the file system based upon the received categorization information.

12. The method of claim 11, further comprising: automatically categorizing the file based upon one or more categorization parameters selected by the first user.

13. The method of claim 6, further comprising: receiving association information for the file wherein the association information associates the file with one or more other files and wherein the ECS is configured to retrieve each associated file alone or in combination with the other files to which it is associated.

14. The method of claim 13, wherein the file includes transactional data related to a purchase and wherein the one or more other files are associated with the purchase.

15. The method of claim 14, wherein the one or more other files include one or more of an electronic copy of a receipt associated with the purchase, a warranty associated with the purchase and a user manual associated with the purchase.

16. The method of claim 1, wherein the vault and the account are generated for the first user prior to receiving the request for retrieval and delivery of messages from the message provider.

17. The method of claim 1, wherein the vault and the account are generated for the first user in response to the request for retrieval and delivery of messages from the message provider.

18. The method of claim 1, further comprising: in response to receiving the request for retrieval and delivery of messages from the message provider, determining based upon the selection of electronic delivery options by the message provider whether the first user is eligible for the retrieval and delivery and messages from the message provider.

19. The method of claim 1, further comprising:
receiving a request for retrieval and delivery of messages from the message provider for a plurality of different users of the ECS and
for each of the different users, generating and storing to a memory device at ECS an electronic delivery agreement between each user, the message provider and the ECS wherein the electronic delivery agreement includes 1) information indicating the that each user wishes the ECS to retrieve and deliver messages from the message provider into each user's vault at the ECS in accordance with the selection of electronic delivery options and 2) access information that allows the ECS to retrieve and deliver data from the message provider for each user.

20. The method of claim 1, further comprising:
receiving a request for retrieval and delivery of messages from a second message provider for the first user of the ECS;
generating and storing to a memory device at ECS an electronic delivery agreement between the first user, the second message provider and the ECS wherein the electronic delivery agreement includes 1) information indicating the first user wishes the ECS to retrieve and deliver messages from the second message provider into the first user's vault at the ECS in accordance with a selection of electronic delivery options by the second message provider and 2) access information that allows the ECS to retrieve and deliver data from the second message provider for the first user; and
retrieving, delivering and storing a message associated with the first user and the second message provider into the vault of the first user.

21. The method of claim 1, further comprising:
receiving from a plurality of different message provider an authorization for the ECS to electronically retrieve and deliver messages to users of the ECS that have business relationships with each of the plurality of different message providers;
receiving from each of the plurality of different message providers a selection of electronic delivery options that affect how messages associated with each of the plurality of different message providers are to be retrieved and delivered by the ECS.

22. The method of claim 1, further comprising: prior to storing the message retrieved from the message provider into the first user's vault, retrieving a public encryption key for the first user from a database of public encryption keys maintained at the ECS associated with the users of the ECS and encrypting the message with the first user's public encryption key.

23. The method of claim 22, wherein a private key different from the first user's public encryption key is needed to decrypt the message encrypted with the first user's public key and wherein the private key is not stored at the ECS.

24. The method of claim 22, wherein a private key different from the first user's public encryption is needed to decrypt the message encrypted with the first user's public key and wherein the private key is stored at the ECS and wherein the ECS is configured to decrypt the message with the private key only after receiving a verifiable authorization from the first user or an authorized representative of the first user.

25. The method of claim 1, further comprising: receiving a request to determine the authenticity of the message retrieved from the message provider and stored into the vault of the first user and determining that the message stored in the first user's vault is comparable to the message retrieved by ECS from the message provider.

26. The method of claim 1, further comprising: syncing the first user's vault maintained by the ECS with a second vault maintained on a remote device controlled.

27. The method of claim 26, wherein the syncing comprises receiving contents of the second vault from the remote device, comparing the contents of the first user's vault with the contents of the second vault and transferring data between the first user's vault maintained at the ECS and the second so that the contents of each of the vaults are matched.

28. The method of claim 1, further comprising: periodically communicating with the message provider to determine whether new messages are available for the first user.

29. The method of claim 28, further comprising: receiving a request from the remote device to terminate the electronic delivery agreement between the first user, the message provider and the ECS and terminating the periodically communicating with the message provider to determine whether the new messages are available.

30. The method of claim 28, wherein the electronic delivery agreement further includes limit information that can be used to suspend or terminate the electronic delivery agreement and based upon the limit information, determining the electronic delivery agreement is to be suspended or terminated.

31. The method of claim 1, further comprising: receiving from the message provider information indicating the message provider has verified an identity of the first user and based upon the information received from the message provider, generating a score and providing a scale for the score wherein a relative placement of the generated score on the scale can be used to assess whether the first user actually possesses the identity that they have registered at the ECS.

32. A method in an electronic payroll clearinghouse system (ECS) comprising:
receiving from an employee information provider an authorization for the ECS to electronically retrieve and deliver messages including employee payroll and benefit information to users of the ECS;
receiving from the employee information provider a selection of electronic delivery options that affect how messages including the payroll and benefit information are to be retrieved and delivered by the ECS;
generating for each of the users of the ECS 1) a vault for electronically storing data in an encrypted format including storing the payroll and benefit messages from at least the employee information provider and 2) an account that allows access to the vault;
receiving from a remote device a request for retrieval and delivery of the payroll and benefit messages from the employee information provider for a first user of the ECS;
generating and storing to a memory device at ECS an electronic delivery agreement between the first user, the employee information provider and the ECS wherein the electronic delivery agreement includes 1) information indicating the first user wishes the ECS to retrieve and deliver the payroll and benefit messages from the employee information provider into the first user's vault at the ECS in accordance with the selection of electronic delivery options and 2) access information that allows the ECS to retrieve and deliver data from the employee information provider for the first user; and
retrieving, delivering and storing a payroll and benefit message associated with the first user from the employee information provider into the vault of the first user.

33. The method of claim 32, wherein the payroll and benefit message includes a W-2 form or a W-4 form associated with employment of the first user with an employee.

34. A method in an electronic health care data clearinghouse system (ECS) comprising:
receiving from a health care information provider an authorization for the ECS to electronically retrieve and deliver messages including health care information to users of the ECS;
receiving from the health care provider a selection of electronic delivery options that affect how messages including the health care data are to be retrieved and delivered by the ECS;
generating for each of the users of the ECS 1) a vault for electronically storing data in an encrypted format including storing the healthcare information messages from at least the health care information provider and 2) an account that allows access to the vault;
receiving from a remote device a request for retrieval and delivery of the health care information messages from the employee information provider for a first user of the ECS;
generating and storing to a memory device at ECS an electronic delivery agreement between the first user, the health care information provider and the ECS wherein the electronic delivery agreement includes 1) information indicating the first user wishes the ECS to retrieve and deliver healthcare information messages from the healthcare information provider into the first user's vault at the ECS in accordance with the selection of electronic delivery options and 2) access information that allows the ECS to retrieve and deliver data from the health care information provider for the first user; and
retrieving, delivering and storing a health care information message associated with the first user from the employee information provider into the vault of the first user.

35. The method of claim 34, wherein the health care information message includes medical history information associated with the first user.

36. A method performed by an electronic clearinghouse system (ECS), comprising:
establishing a first relationship between a first user and an information provider to allow information from the information provider to be delivered to a first vault associated with the first user;
establishing a second relationship between a second user and the information provider to allow information from the information provider to be delivered to a second vault associated with the second user;
receiving a plurality of sets of information from the information provider;
determining that a first set of information is intended for the first user and a second set of information is intended for the second user;
encrypting the first set of information with a first encryption key to derive a first set of encrypted information and storing the first set of encrypted information in the first vault; and
encrypting the second set of information with a second and different encryption key to derive a second set of encrypted information and storing the second set of encrypted information in the second vault.

37. The method of claim 36, further comprising:
providing notification to the information provider that the first set of information has been delivered to the first user and that the second set of information has been delivered to the second user.

38. The method of claim 36, further comprising:
determining that the first user has viewed the first set of information; and
providing notification to the information provider that the first user has viewed the first set of information.

39. The method of claim 36, wherein the first and second sets of information comprise payroll/benefits information for the first and second users, respectively.

40. The method of claim 36, wherein the first and second sets of information comprise healthcare information for the first and second users, respectively.

41. The method of claim 36, wherein encrypting the first set of information comprises:
generating, based at least in part upon the first set of information, a formatted document, wherein the formatted document is formatted in accordance with a set of parameters specified by the information provider; and
encrypting the formatted document with the first encryption key to derive the first set of encrypted information.

42. The method of claim 41, wherein generating the formatted document comprises:
adding information specific to the first user to the formatted document so that the formatted document is customized for the first user.

43. The method of claim 41, wherein generating the formatted document comprises:
adding an advertisement to the formatted document, wherein the advertisement is selected by the information provider, the ECS, or both.

44. The method of claim 44, wherein the advertisement is selected specifically for the first user based upon one or more characteristics specific to the first user.

45. The method of claim 41, wherein encrypting the first set of information further comprises:
electronically signing the formatted document with a digital signature associated with the information provider to provide confirmation that the formatted document is authentic.

46. The method of claim 36, wherein encrypting the first set of information comprises:
electronically signing the first set of information with a digital signature associated with the information provider to provide confirmation that the first set of information is authentic.

47. The method of claim 36, further comprising:
synchronizing the first vault maintained by the ECS with a user vault maintained by a user device controlled by the first user, wherein the user device is remote from the ECS.

48. The method of claim 47, wherein synchronizing comprises:
comparing contents of the first vault with contents of the user vault; and
copying and transferring information as necessary between the first vault and the user vault to make the contents of the first vault and the user vault consistent with each other.

49. The method of claim 36, wherein storing the first set of encrypted information in the first vault comprises:
determining a category with which to associate the first set of information; and
storing the first set of encrypted information in a file system associated with the first vault based, at least in part, upon the category.

50. The method of claim 49, wherein determining a category with which to associate the first set of information comprises:
accessing a set of categorization parameters specified by the first user; and
determining the category with which to associate the first set of information based, at least in part, upon the set of categorization parameters.
